(19) United States
(12) Patent Application Publication
(10) Pub. No.: US 2011/0085204 A1
(43) Pub. Date: Apr. 14, 2011

(54) CAPTURED IMAGE PROCESSING SYSTEM, IMAGE CAPTURE METHOD, AND RECORDING MEDIUM

(76) Inventors: Kazuyuki HAMADA, Osaka (JP); Makoto Hayasaki, Osaka (JP)

(21) Appl. No.: 12/900,835

(22) Filed: Oct. 8, 2010

(30) Foreign Application Priority Data
Oct. 9, 2009 (JP) 2009-235733
Mar. 25, 2010 (JP) 2010-070514

(51) Int. Cl. G06F 3/12

(52) U.S. Cl. 358/1.15

(57) ABSTRACT

A portable terminal apparatus includes an encoding section for encoding captured image data by use of a reference data table, and the portable terminal apparatus outputs, to an image output apparatus, the captured image data encoded, to which a common code corresponding to the reference data table and an output machine ID set by an entry by a user are attached. Meanwhile, the image output apparatus, in a case where the output machine ID received from the portable terminal apparatus matches its own output machine ID, decodes the encoded captured image data by use of an inverse transformation table corresponding to the common code, and outputs this decoded captured image data. As a result, it is possible to ensure confidentiality of image data that is obtained by capturing an image with the portable terminal apparatus. Furthermore, even if a problem such as failure or the like occurs to an image output apparatus that is designated to output an image, it is possible to output the image from another image output apparatus.

This Nonprovisional application claims priority under 35 U.S.C. §119(a) on Patent Application No. 2009-235733 filed in Japan on Oct. 9, 2009 and on Patent Application No. 2010-070514 filed in Japan on Mar. 25, 2010, the entire contents of which are hereby incorporated by reference.

### TECHNICAL FIELD

The present invention relates to a captured image processing system which outputs an image captured by a portable terminal apparatus, by use of an image output apparatus.

### BACKGROUND ART

With the development of Internet technology, chances are increasing to capture images by use of a portable terminal apparatus such as a mobile phone, and to store such captured images. Not only landscapes and people, but also explanation diagrams and descriptions displayed in various shows, and furthermore slides displayed in an academic conference or the like are now being more regarded a target for image capture. A captured image is printed out generally by transferring image data of the captured image from the portable terminal apparatus to an image output apparatus that has a printing function, such as a multifunction printer, then printing out the captured image from the image output apparatus.

Patent Literature 1 discloses a technique which allows a user to transmit digital image data to a server through a network, which digital image data is collected by use of a digital camera or a portable terminal apparatus such as a PDA or mobile personal computer having a built-in camera. In this technique, the server edits received digital image data so that the digital image data is compatible to a given document format, and pastes this edited digital image data to a given region in the document format as an audio code image or text image. Thereafter, this document is, for example, stored in a recording medium as a report for a specific purpose, printed out as a paper document, or transmitted to a specific site through a network.

However, the technique of Patent Literature 1 does not make the image data have confidentiality; in a case where the image data is mistakenly transmitted to an unintended image output apparatus, the image data could possibly be outputted from the unintended image output apparatus. Accordingly, demands has arisen to ensure confidentiality of image data obtained by capturing an image by use of a mobile phone or digital camera, to allow just the printing out of the image data from a designated image output apparatus. An example of a method that satisfies this demand is a method disclosed in Patent Literature 2. Namely, an encryption key is prepared in accordance with a serial number of the image output apparatus, which serial number is information unique to the designated image output apparatus. This encryption key is stored in a memory such as a hard disc of the image output apparatus, and is entered into the mobile phone or digital camera. Subsequently, captured image data is encrypted by use of the encryption key, and this encrypted captured image data is transmitted to the image output apparatus. The image output apparatus then decrypts the received encrypted captured image data by use of the encryption key stored in the image output apparatus.

### CITATION LIST

### Patent Literature

Patent Literature 1
Japanese Patent Application Publication, Tokukai, No. 2002-41502 A (Publication Date: Feb. 8, 2002)

Patent Literature 2
Japanese Patent Application Publication, Tokukai, No. 2005-6177 A (Publication Date: Jan. 6, 2005)

### SUMMARY OF INVENTION

### Technical Problem

However, as described in Patent Literature 2, if the image data can only be outputted by the designated image output apparatus, the image data cannot be printed out in a case where a problem occurs to the designated image output apparatus, such as that the image output apparatus is not working or that the image output apparatus has run out of toner.

The present invention is accomplished to solve the foregoing problem, and its object is to provide a captured image processing system, an image output method, a program, and a recording medium, each of which (i) ensures confidentiality of image data that is obtained by capturing an image by use of the portable terminal apparatus, while (ii) allowing, in a case where some kind of problem such as failure or the like occurs to an image output apparatus designated to output the image data, output of the image data from an image output apparatus different from the designated image output apparatus.

### Solution to Problem

In order to attain the object, a captured image processing system of the present invention is a captured image processing system including (i) a portable terminal apparatus including image capture means and (ii) a plurality of image output apparatuses, the portable terminal apparatus and the image output apparatuses being communicable with each other, the portable terminal apparatus including: first storage means; an encoding section; and an image data transmission section, each of the plurality of image output apparatuses including: second storage means; an image data receiving section; a determination section; a decoding section; and an output section, the first storage means being for storing at least one piece of encoding information for encoding image data, the second storage means being for storing (a) decoding information for decoding the image data encoded by use of the encoding information and (b) first identification information for identifying the image output apparatus to which the second storage means is provided, each of the at least one piece of encoding information being associated with a corresponding piece of decoding information so as to form a pair, the pair being identifiable by second identification information that is assigned to the pair in advance, the first storage means storing the at least one piece of encoding information in such a manner that each piece of encoding information is associated with a corresponding piece of the second identification information that identifies the pair including the piece of encoding information, and the second storage means storing the decoding information in such a manner that each piece of decoding information is associated with a corresponding piece of the second identification information that identifies the pair including the piece of decoding information, the encoding section encoding captured image data by use of a piece of encoding information among the at least one piece of encoding information stored in the first storage means, the captured image data being obtained by capturing an image by the image capture means, the image data transmission section transmitting, to an image output apparatus designated by a user, the captured image data encoded by the encoding section to which a piece of the second identification information and first identification information are attached, the piece of the second identification information corresponding to the piece of encoding information being used by the encoding section to encode the captured image data, and the first identification information being set by entry of a user, the image data receiving section receiving, from the portable terminal apparatus, the captured image data to which the first identification information set by the entry of the user and the second identification information are attached, the determination section determining whether or not the first identification information received by the image data receiving section matches the first identification information stored in the second storage means, in a case where the determination section determines that the first identification information received by the image data receiving section matches the first identification information stored in the second storage means, the decoding section reading out from the second storage means a piece of the decoding information that corresponds to the second identification information received by the image data receiving section, and decoding, by use of the decoding information read out, the captured image data received by the image data receiving section, and the output section outputting the captured image data decoded by the decoding section, or outputting an image indicated by the decoded captured image data.

### ADVANTAGEOUS EFFECTS OF INVENTION

With the present invention, it is possible to (i) ensure confidentiality of image data that is obtained by capturing an image by use of a portable terminal apparatus, while (ii) allowing, in a case where some kind of problem such as failure or the like occurs to an image output apparatus designated to output the image data, output of the image data from an image output apparatus different from the designated image output apparatus.

### BRIEF DESCRIPTION OF DRAWINGS

FIG. 1 is a block diagram illustrating an arrangement of a portable terminal apparatus according to one embodiment of the present invention.

FIG. 2 is a view illustrating an overall arrangement of a captured image processing system according to one embodiment of the present invention.

FIG. 3 is a view illustrating how information communication is carried out between a portable terminal apparatus and an image output apparatus.

FIG. 4 is a view illustrating an exchange of information between a portable terminal apparatus and an image output apparatus.

FIG. 5 is a view illustrating an arrangement of a pass code.

FIG. 6 is a view of one example of a pass code.

FIG. 7 is a view illustrating another example of a pass code.

FIG. 8 illustrates captured image data aligned in order of normal pixel configuration.

FIG. 9 is a view illustrating details of a shuffling process.

FIG. 10 is a view illustrating how captured image data is encoded in a case where a size of the captured image data is greater than that of a reference data table.

FIG. 11 is a block diagram illustrating an arrangement of an image output apparatus in accordance with one embodiment of the present invention.

FIG. 12 is a block diagram illustrating an arrangement of an image processing section provided in an image output apparatus according to one embodiment of the present invention.

FIG. 13 illustrates an example of a look-up table prepared at a time when color balance of an image is to be adjusted.

FIG. 14 is a flow chart illustrating procedures carried out in a portable terminal apparatus.

FIG. 15 is a flow chart illustrating an entire view of procedures carried out in an image output apparatus.

FIG. 16 is a view illustrating a process of selecting a reference data table.

FIG. 17 is a view illustrating one example of a shuffling method b.

FIG. 18 is a view illustrating another example of the shuffling method b.

FIG. 19 is a view illustrating an arrangement of a common sub-code.

FIG. 20 is a view illustrating an example of detection of a skew of an image.

FIG. 21 shows angles of a skew θ and their respective tangents which angles and tangents are obtained in the example of detection of the skew which example is illustrated in FIG. 20.

FIG. 22 is a view illustrating an example of detection of a geometric distortion of an image.

FIG. 23 is a view illustrating an example of an edge detection process carried out with respect to an image capture object in an image.

FIG. 24 is a view illustrating an example of detection of an edge of an image in a raster direction.

FIG. 25 is a view illustrating an example of a first order differential filter used in an example of detection of a degree of offset between images.

FIG. 26 is a block diagram illustrating a modification of an image processing section included in an image output apparatus.

FIG. 27 is a view illustrating an example of a correction for lens distortion of an image.

FIG. 28 is a view illustrating an example of a correction for geometric distortion and skew of an image.

FIG. 29 is a view illustrating an example of determination of a reconstructed pixel value of an image.

FIG. 30 is a flow chart illustrating another processing flow of a high resolution correction.

FIG. 31 illustrates reference pixels and interpolated pixels in high resolution image data.

FIG. 32(a) is a view illustrating a method for calculating pixel values of the interpolated pixels in a case where an edge direction is an upper left-lower right direction.

FIG. 32(b) is a view illustrating a method for calculating the pixel values of the interpolated pixels in a case where the edge direction is a left-right direction.

FIG. 32(c) is a view illustrating a method for calculating the pixel values of the interpolated pixels in a case where the edge direction is an upper right-lower left direction.

FIG. 32(d) is a view illustrating a method for calculating the pixel values of the interpolated pixels in a case where the edge direction is an upper-lower direction.

FIG. 33 is a view illustrating a table acquisition pattern b.

FIG. 34 is a view illustrating a table acquisition pattern c.

FIG. 35 is a view illustrating a table acquisition pattern d.

FIG. 36 is a view illustrating a table acquisition pattern f.

FIG. 37 is a view illustrating one example of a table acquisition pattern h.

FIG. 38 is a view illustrating another example of the table acquisition pattern h.

FIG. 39 is a view illustrating a modification of a common sub-code.

FIG. 40 is a view illustrating one example of a modified embodiment using a public key and a secret key.

FIG. 41 is a view illustrating another example of a modified embodiment using a public key and a secret key.

### DESCRIPTION OF EMBODIMENTS

An embodiment of the present invention is described below in detail.

(1) Overall Arrangement of Captured Image Processing System

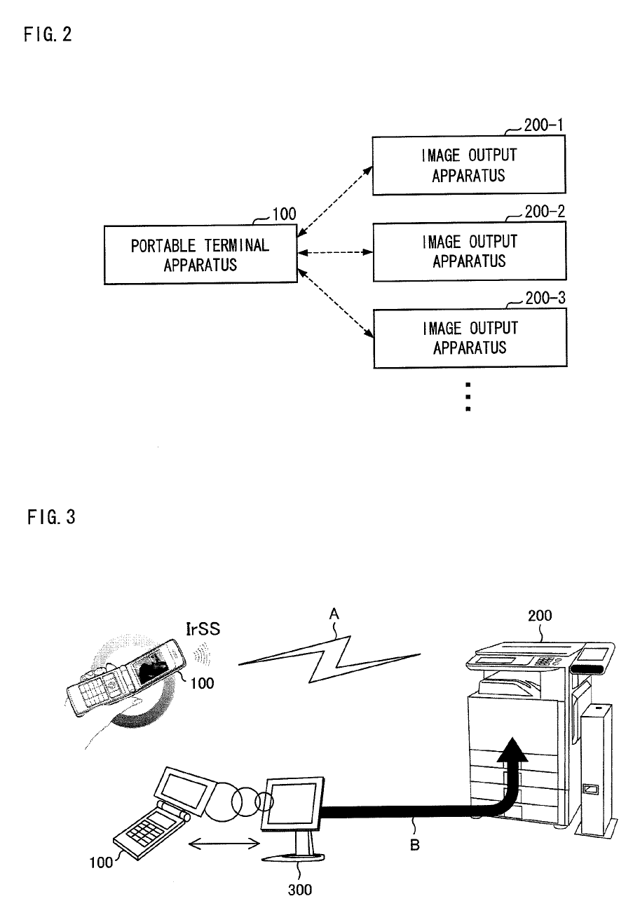

FIG. 2 is a view illustrating an overall arrangement of a captured image processing system of the present invention. The captured image processing system includes (i) a portable terminal apparatus 100 including image capture means such as a camera-equipped mobile phone or a digital camera and (ii) a plurality of image output apparatuses 200 (200-1, 200-2, . . . ) such as a multifunction printer or a printer (an image forming apparatus) (see FIG. 2).

The portable terminal apparatus 100 is carried with a user. The user can cause the portable terminal apparatus 100 to carry out image capture with respect to an object in various scenes. Further, the portable terminal apparatus 100 has an image output mode function, which function is an image capture mode that allows a user to obtain a captured image from the image output apparatus 200.

The portable terminal apparatus 100, which can communicate with the image output apparatus 200, transmits data of the captured image (hereinafter referred to as captured image data) which is obtained by capturing an image in an image output mode, to the image output apparatus 200.

The image output apparatus 200 carries out an output process to the captured image data received from the portable terminal apparatus 100.

The portable terminal apparatus 100 can be communicated with the image output apparatus 200 as below: (i) the captured image data is transferred from the portable terminal apparatus 100 to the image output apparatus 200 via a wireless communication system which is in conformity with any one of the infrared communication standards such as IrSimple (see a sign A illustrated in FIG. 3); or (ii) the captured image data is transmitted from the portable terminal apparatus 100 temporarily to a relay apparatus 300 via a non-contact wireless communication system such as Felica (registered trademark) (see a sign B illustrated in FIG. 3) and then transferred from the relay apparatus 300 to the image output apparatus 200 via a wireless communication system such as Bluetooth (registered trademark). In the present embodiment, the user is to come in front of the image output apparatus 200 and operate the portable terminal apparatus 100 to cause transmission of data to the image output apparatus 200 from the portable terminal apparatus 100 by use of a short-distance wireless communication such as infrared communication. Note that not only the foregoing communication systems but also a system employing a publicly-known method is applicable to the communication between the portable terminal apparatus 100 and the image output apparatus 200.

Moreover, the captured image processing system according to the present embodiment is arranged as described below, to prevent output of an image from an unintended image output apparatus 200 even in a case where the user mistakenly transmits the captured image data to the unintended image output apparatus 200.

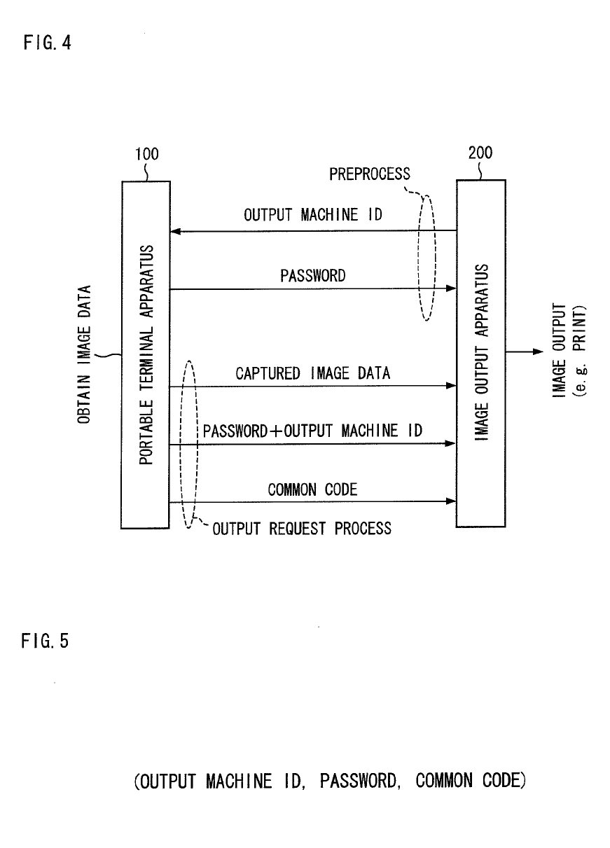

FIG. 4 is a view illustrating how information is communicated between the portable terminal apparatus 100 and the image output apparatus 200. As a preprocess for carrying out image output, the portable terminal apparatus 100 obtains, in advance, an output machine ID (first identification information) of the image output apparatus 200 from which the user desires to output the captured image obtained by capturing an image by use of the portable terminal apparatus 100 (see FIG. 4). The output machine ID is used for identifying the image output apparatus 200, and is, for example, a serial number of the image output apparatus 200.

Moreover, the portable terminal apparatus 100 stores, in advance, encoding information (reference data table later described) for encoding (encrypting) the captured image data, and the image output apparatus 200 stores, in advance, decoding information (inverse transformation table later described) for decoding the captured image data encoded by the encoding information. Furthermore, a common code (second identification information) is set in advance, which common code is used for specifying the encoding information and the decoding information.

Thereafter, as a process for requesting image output (output request process), the portable terminal apparatus 100 transmits to the image output apparatus 200 the captured image data encoded by use of the encoding information, together with the common code and the output machine ID. Subsequently, the image output apparatus 200, in a case where the output machine ID is identical to its own output machine ID, decodes the captured image data by use of the decoding information specified by the common code, and outputs the image.

Hence, in a case where the captured image data is mistakenly transmitted to an unintended image output apparatus 200, in other words, to an image output apparatus 200 which its output machine ID is not acquired in advance by the portable terminal apparatus 100, no image output is carried out by the unintended image output apparatus 200. Moreover, even in a case where the captured image data is intercepted during the communication process, the captured image data is encoded, so therefore it is difficult to distinguish its normal image. Consequently, confidentiality of the captured image data is ensured. Moreover, by obtaining an output machine ID from a plurality of image output apparatuses 200 in advance, it is possible to easily cause carrying out of image output by use of another image output apparatus 200 upon image output in a case where one of the plurality of image output apparatuses 200 is not capable of carrying out the output operation due to failure or the like.

As a preprocess, the portable terminal apparatus 100 may register a password with respect to the image output apparatus 200 in advance, as illustrated in FIG. 4. In this case, the portable terminal apparatus 100 transmits to the image output apparatus 200 the captured image data to which the password is attached, together with the output machine ID and the common code. The image output apparatus 200 in response decodes the captured image data by use of the decoding information specified by the common code, and outputs this decoded captured image data only if (i) the output machine ID attached to the image data is identical to its own output machine ID and (ii) the password attached to the image data is identical to the password registered in advance. This improves security of the image.

In the following description, the portable terminal apparatus 100 transmits the captured image data having (i) the output machine ID obtained from the image output apparatus 200 in advance, (ii) the password set between the image output apparatus 200 and the portable terminal apparatus 100 in advance, and (iii) the common code. As illustrated in FIG. 5, the output machine ID, the password, and the common code together is called a “pass code”.

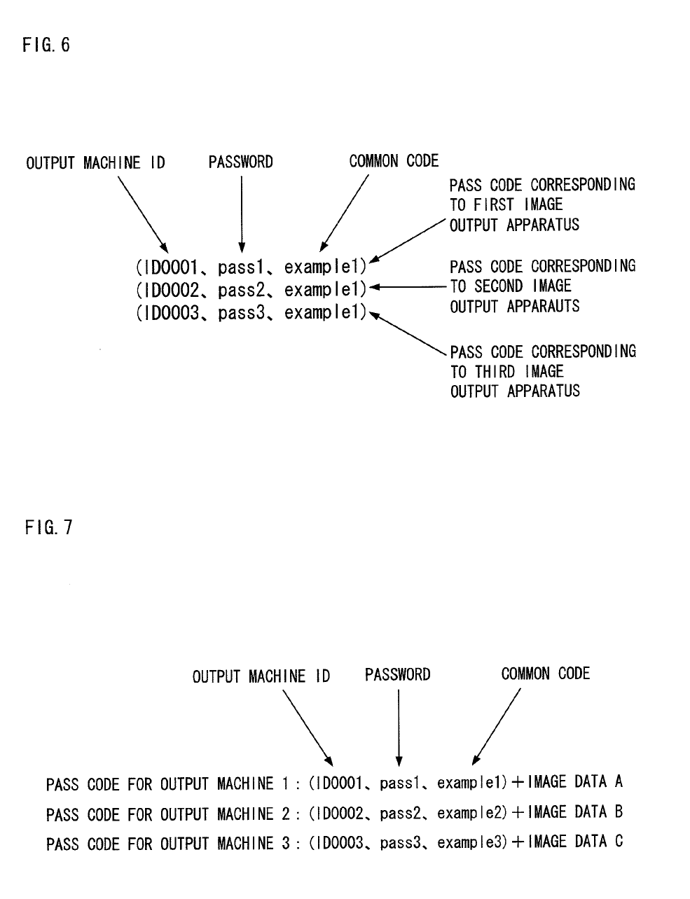

FIG. 6 is a view illustrating one example of the pass code. FIG. 6 illustrates one example of the pass code in a case where a same common code is set for three image output apparatuses 200 having output machine IDs of “ID0001”, “ID0002”, and “ID0003”, respectively. This example is arranged in such a manner that image output is designated to be carried out by use of an image output apparatus 200-1 that has the output machine ID of “ID0001”, however in a case where the image output apparatus 200-1 cannot operate due to failure or the like at a time when the captured image data is transmitted to the image output apparatus 200-1, the user can easily obtain the output image by transmitting the captured image data to an image output apparatus 200-2 that has the output machine ID of “ID0002”.

Moreover, FIG. 7 is a view illustrating another example of the pass code. FIG. 7 is one example of the pass code in a case where a different common code and a different password are set for each of the three image output apparatuses 200. In this example, image data A can be outputted only by the image output apparatus 200-1 that has the output machine ID of “ID0001”. Even in a case where the captured image data is mistakenly transmitted to the other image output apparatus 200-2 or 200-3, the image data A is not outputted from the image output apparatuses 200-2 and 200-3.

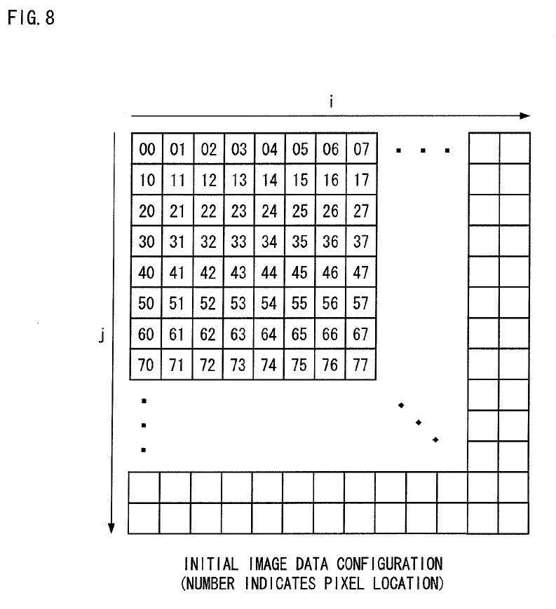

The following description deals briefly with encoding (encryption) that is used in the present embodiment. First described is data configuration of captured image data which has not been subjected to encryption yet. FIG. 8 illustrates a piece of captured image data obtained by capturing an image by use of the portable terminal apparatus 100, which captured image data has not been subjected to encryption yet. The captured image data is made up of density data (pixel value) in each pixel location, which density data is in a range of 0 to 255. As illustrated in FIG. 8, the captured image data prior to the encryption is positioned in such a manner that the density data of the pixels are provided as a configuration in order of normal pixel locations. The numbers shown in FIG. 8 denote coordinates of the normal pixel locations. Moreover, the density data is provided for each of the R, G, and B colors. Therefore, the captured image data is made up of density data having a data configuration similarly to FIG. 8, with respect to each of planes of R, G, and B.

As the encryption process, the present embodiment carries out a shuffling process which changes configuration order of pixel locations, with respect to the captured image data aligned in the order of normal pixel locations illustrated in FIG. 8.

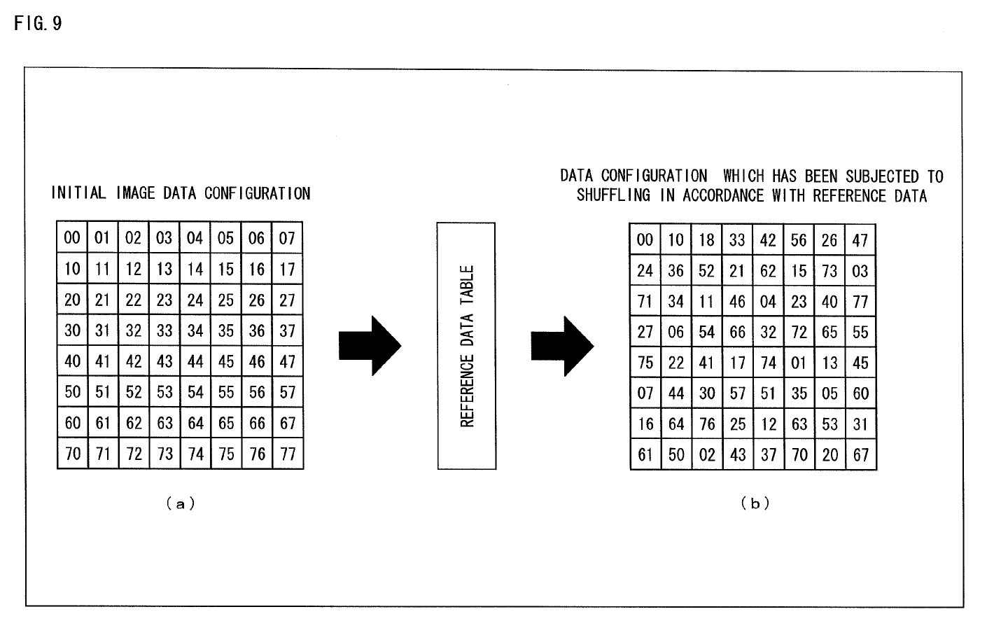

For example, as illustrated in FIG. 9, the pixel locations of the captured image data in which pixels are located as a configuration in order of normal pixel locations is permutated by use of a reference data table as the encoding information. In the example illustrated in FIG. 9, a same shuffling method is used for each of the R, G, and B color components. The numbers illustrated in the captured image data in FIG. 9 indicate their respective normal pixel locations.

In the embodiment, the reference data table which serves as the encoding information includes information indicating how the pixel locations in the captured image that has not been subjected to encoding yet corresponds to the pixel locations in the captured image data that has been subjected to encoding. For example, in a case where the reference data table includes information that the pixel locations are changed from (i=0, j=0) to (i=0, j=0), from (i=1, j=0) to (i=5, j=4), and from (i=2, j=0) to (i=2, j=7), the data configuration illustrated in (a) of FIG. 9 is changeable to the data configuration illustrated in (b) of FIG. 9.

The example illustrated in FIG. 9 illustrates an example of a case where the captured image data is formed of 8×8 pixels. By expanding this idea, it is also possible to apply the same method to image data formed of 10000×10000 pixels; there is no limit in the number of pixels that are transformed.

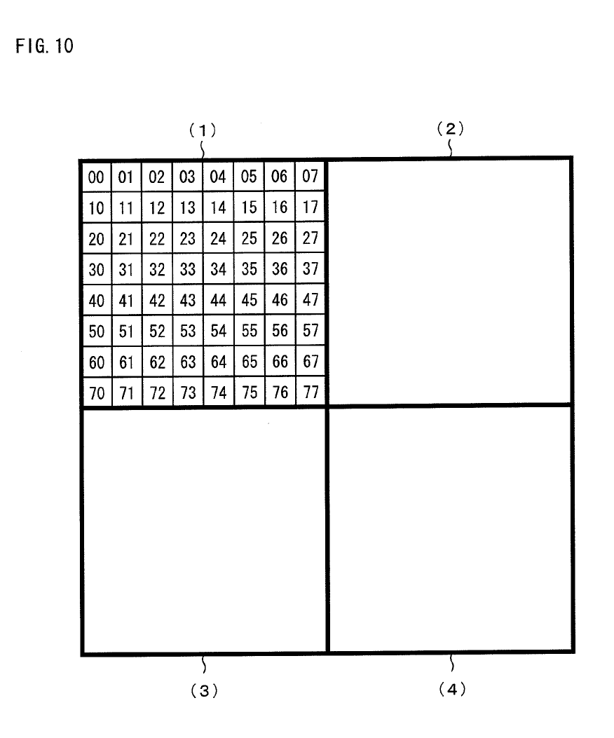

For example, the entire captured image data can be shuffled at once by use of a reference data table having a size identical to that of the image data. Alternatively, in a case where the captured image data is of a larger size than the size of the reference data table, the captured image data can be divided into a plurality of blocks that have the size of the reference data table, and the shuffling process can be carried out to each of the plurality of blocks by use of the reference data table. More specifically, as illustrated in FIG. 10, in a case where the reference data table is of a size of 8×8, captured image data having a size of 16×16 is divided into four blocks (1) to (4) each having a size of 8×8, and the shuffling process is carried out to each of the blocks by use of the reference data table having the same size as the blocks.

Subsequently, the portable terminal apparatus 100 transmits, to the image output apparatus 200, the captured image data which has been subjected to the shuffling process by use of the reference data table. The image output apparatus 200 then decodes the captured image data received from the portable terminal apparatus 100 by use of an inverse transformation table which is the decoding information, and carries out image output of this decoded captured image data.

In the embodiment, the inverse transformation table is a table for placing the pixel locations of the captured image data that have been shuffled by use of the reference data table back to the normal pixel locations. The inverse transformation table includes information indicative of how the pixel locations in the captured image data which has not been subjected to decoding yet correspond to the pixel locations in the captured image data which has been subjected to the decoding. For example, an inverse transformation table corresponding to the reference data table illustrated in FIG. 9 includes information to change the pixel locations from (i=0, j=0) to (i=0, j=0), from (i=5, j=4) to (i=1, j=0), and from (i=2, j=7) to (i=2, j=0).

In order to carry out the encryption and decryption as described above, the portable terminal apparatus 100 stores, in advance, the reference data table as the encoding information, and the image output apparatus 200 stores, in advance, the inverse transformation table corresponding to the reference data table as the decoding information. The common code described above is a table number indicative of a pair of a reference data table and an inverse transformation table (i.e., a pair of one reference data table and its corresponding inverse transformation table), which common code allows specification of the reference data table and the inverse transformation table.

The following description specifically explains the portable terminal apparatus 100 and the image output apparatus 200, which make up the captured image processing system of the present embodiment.

(2) Arrangement of Portable Terminal Apparatus

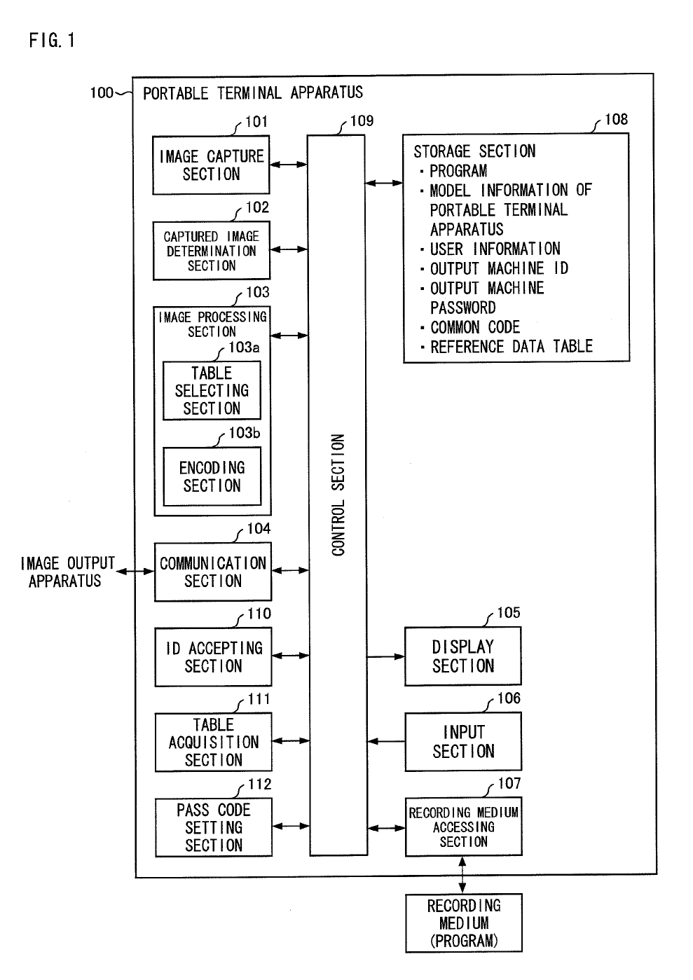

First described is the portable terminal apparatus 100, with reference to FIG. 1. FIG. 1 is a block diagram illustrating an arrangement of the portable terminal apparatus 100. As illustrated in FIG. 1, the portable terminal apparatus 100 includes an ID accepting section 110, a table acquisition section 111, a pass code setting section 112, an image capture section (image capture means) 101, a captured image determination section 102, an image processing section 103, a communication section (image data transmission section) 104, a display section 105, an input section 106, a recording medium accessing section 107, a storage section (first storage means) 108, and a control section (image data transmission section) 109.

The ID accepting section 110 communicates with the image output apparatus 200 through the communication section 104, and obtains an output machine ID (first identification information) for identifying the image output apparatus 200. When the ID accepting section 110 obtains the output machine ID, the ID accepting section 110 transmits to the image output apparatus 200 a password entered into the input section 106. Thereafter, the ID accepting section 110 stores in the storage section 108 the obtained output machine ID and the password transmitted to the image output apparatus 200.

The table acquisition section 111 acquires the aforementioned reference data table that is used for carrying out the shuffling process with respect to the captured image data. In association with the ID accepting section 110 obtaining the output machine ID, the table acquisition section 111 obtains a plurality of reference data tables and common codes (in the embodiment, table numbers) (second identification information) for identifying the reference data tables, each of which are stored in the image output apparatus 200. The obtained common codes and plurality of reference data tables are stored in the storage section 108 in such a manner that the common codes correspond to respective reference data tables.

As described later, each of the plurality of image output apparatuses 200 included in the captured image processing system of the present embodiment stores identical reference data tables and common codes. Accordingly, the table acquisition section 111 carries out the acquisition process of the reference data tables just in a case where the storage section 108 stores no reference data tables. That is to say, the acquisition process of the reference data tables is carried out just at a time when the ID accepting section 110 initially obtains the output machine IDs.

The pass code setting section 112 sets, with respect to the captured image data obtained by capturing an image in the image output mode, a pass code made up of an output machine ID, a password, and a common code, as illustrated in FIG. 5. The pass code setting section 112 stores, in the storage section 108, the pass code set in such a manner that the pass code corresponds to a respective piece of captured image data.

The pass code setting section 112 causes the display section 105 to display a screen for entering the output machine ID, password, and common code, and sets a pass code in accordance with an entry entered into the input section 106. At this time, the pass code setting section 112 may cause the display section 105 to display a list of output machine IDs that are stored in the storage section 108, to have one of the displayed output machine IDs in the list be selected in accordance with an entry of a user. Moreover, the pass code setting section 112 causes the display section 105 to display a list of the common codes stored in the storage section 108, to have one of the displayed common codes in the list be selected in accordance with an entry of the user. Moreover, as for the password, the pass code setting section 112 may cause the display section 105 to display a list of passwords stored in the storage section 108, to have one of the passwords in the list be selected in accordance with an entry of the user. Alternatively, the pass code setting section 112 may cause the display section 105 to display an instruction to directly enter characters or symbols that make up a password, in order to set the password in accordance with an entry of the user.

Subsequently, the pass code setting section 112 prepares a pass code made up of the output machine ID, the password, and the common code, each of which is set in accordance with the entry of the user.

The pass code setting section 112 can carry out the pass code setting process at any time as long as it is carried out before the captured image data is transmitted to the image output apparatus 200. That is to say, the pass code may be set (a) at a time when the image capture is carried out or (b) after the image capture is carried out and immediately before the captured image data is transmitted to the image output apparatus 200.

The image capture section 101 carries out image capture with respect to an image capture object by use of a CCD/CMOS sensor, and outputs captured image data obtained by carrying out the image capture.

While the image output mode is being selected, the captured image determination section 102 determines whether or not a captured image data outputted from the image capture section 101 meets process execution requirements, which requirement is for determining whether or not the captured image data is suitable for image output. The captured image determination section 102 supplies a determined result to the control section 109. Processes carried out by the captured image determination section 102 are described later in detail.

The image processing section 103 carries out an A/D conversion process with respect to the data of the image captured by the image capture section 101, and also carries out the aforementioned shuffling process.

As illustrated in FIG. 1, the image processing section 103 includes a table selecting section 103a and an encoding section 103b.

The table selecting section 103a reads out, from the storage section 108, a reference data table corresponding to the common code in the pass code set by the pass code setting section 112.

The encoding section 103b carries out a shuffling process to the captured image data by use of the reference data table read out by the table selecting section 103a. Thereafter, the encoding section 103b causes the storage section 108 to store the captured image data which has been subjected to encoding (the shuffling process). In the embodiment, if the size of the reference data table is smaller than that of the captured image data, the captured image data is divided into a plurality of blocks that have the same size as the reference data table, as illustrated in FIG. 10. The shuffling process is carried out to each of the plurality of blocks, by use of the reference data table.

The encoding section 103b carries out the shuffling process by use of a same reference data table, to each of planes of R, G, and B of the captured image data.

The communication section 104 has functions of serial/parallel transfer and wireless data communication which are in conformity with USB 1.1 or USB 2.0 Standard. The communication section 104 transmits, to the image output apparatus 200, captured image data to which image processing including the shuffling process is carried out by the image processing section 103, which captured image data is obtained by capturing an image by the image capture section 101. Note, however, that the communication section 104 transmits only the captured image data that is determined by the captured image determination section 102 as meeting the process execution requirements. Moreover, the communication section 104 specifies, in accordance with an entry into the input section 106, one (1) pass code among the pass codes stored in the storage section 108, and outputs to the image output apparatus 200 the captured image data to which the specified pass code is attached.

The display section 105 is realized by a liquid crystal display device, for example. The input section 106, which has a plurality of buttons, serves as a section from which the user enters data.

The recording medium accessing section 107 reads out a program for carrying out the processes in the portable terminal apparatus 100 from a recording medium in which the program is recorded.

The storage section 108 serves as a section in which (i) the program for carrying out the processes in the portable terminal apparatus 100, (ii) information on a model of the portable terminal apparatus, (iii) user information, and (iv) data required for carrying out the processes are stored. Note that the user information refers to information for identifying the user of the portable terminal apparatus, such as a user ID and a password. Moreover, data required for carrying out the processes is (i) the pass code and (ii) information that associates the common code with the reference data table. The storage section 108 stores the captured image data obtained by capturing an image in the image output mode.

The control section 109 carries out control with respect to the sections of the portable terminal apparatus 100.

More specifically, after receiving an entry into the input section 106 of an instruction to obtain the output machine ID, the control section 109 controls the communication section 104 so that communication is commenced with the image output apparatus 200 from which the output machine ID is to be obtained. Thereafter, the control section 109 causes the ID accepting section 110 to carry out the acquisition process of the output machine ID. At this time, the control section 109 causes the display section 105 to display a screen urging the user to enter a password. Thereafter, the control section 109 causes transmission of an entered password to the image output apparatus 200 and simultaneously controls the ID accepting section 110 to cause the storage section 108 to store the entered password.

Further, in the case where the instruction to select the image output mode is entered from the input section 106, the control section 109 causes the display section 105 to display a window which urges the user to enter, from the input section 106, (i) an instruction to select a kind of the output process (such as the printing process, the filing process, the e-mail transmission process, or the like) and (ii) a setting requirement for carrying out a selected output process (a printing requirement such as the number of sheets to be printed, an address of a server at which data is to be filed, an address of a destination at which an e-mail is transmitted, or the like). Subsequently, the control section 109 receives output process information indicative of the kind of the output process and the setting requirement for carrying out the output process.

Subsequently, the control section 109 assigns a file name and attaches output process information to the captured image data which is determined by the captured image determination section 102 that the captured image data meets the process execution requirements, and further causes the storage section 108 to temporally store this captured image data.

Furthermore, in a case where an instruction to select the image output mode is entered from the input section 106, the control section 109 causes the display section 105 to display a screen that urges the user to enter a selection instruction of a pass code, and further causes the table selecting section 103a to carry out a selection process of the reference data table in accordance with an entry by the user. Thereafter, the control section 109 controls the encoding section 103b so that the shuffling process is carried out with respect to the captured image data for which the image output mode is selected.

Thereafter, in accordance with a transmission instruction entry received through the input section 106, the control section 109 controls the communication section 104 so that the captured image data which has been subjected to the shuffling process is transmitted to the image output apparatus 200 together with its file name, output process information, and pass code selected in accordance with the entry by the user.

(3) Processes Carried Out by Captured Image Determination Section

The following description specifically explains a determination process carried out by the captured image determination section 102 of the portable terminal apparatus 100. The captured image determination section 102 determines whether or not the captured image data meets given process execution requirements in points such as luminance, contrast, color balance, and blur (an intense camera shake).

As for luminance, for example, in a case where overexposure occurs (the captured image is too bright) or underexposure occurs (the captured image is too dark), image capture may be required to be carried out again. In view of this, the captured image determination section 102 finds, for example, maximum and minimum ones of pixel values obtained in the image data. In a case where the maximum value is not more than a given threshold (e.g., 100 in case of 8 bits), the captured image determination section 102 determines that underexposure occurs, and then supplies, to the control section 109, a determined result. In contrast, in a case where the minimum value is not less than a given threshold (e.g., 150 in case of 8 bits), the captured image determination section 102 determines that overexposure occurs, and then supplies, to the control section 109, a determined result. Then, in response to the determined result that underexposure or overexposure occurs, the control section 109 controls the display section 105 to display the determined result and an instruction urging image capture to be carried out again. Alternatively, the control section 109 changes the setting of the image capture section 101 so that the image capture section 101 has longer exposure time in the case of underexposure. In contrast, the control section 109 changes the setting of the image capture section 101 so that the image capture section 101 has shorter exposure time in the case of overexposure. Thereafter, the control section 109 can notify the user of the instruction urging image capture to be carried out again.

As for contrast, in a case where a difference between the maximum and minimum values of the pixel values obtained in the image data is not more than a given threshold, the captured image determination section 102 determines that the captured image has a poor contrast. Then, in response to a determined result that the captured image has a poor contrast, the control section 109 controls the display section 105 to display the determined result and an instruction urging image capture to be carried out again.

Note that the captured image determination section 102 can carry out the determination of luminance and contrast with respect to each of color channels, or can use an average value (R+G+B/3) or a luminance value (0.299×R+0.587×G+0.114×B: conforming to NTSC).

As for color balance, it is possible to detect an occurrence of an excessive imbalance in a given color channel by comparing average values or maximum/minimum values of the respective color channels (R, G, and B). In view of this, the captured image determination section 102 determines that the captured image has a poor color balance, for example, in a case where (i) average values (Ra, Ga, and Ba) of the pixel values of the respective color channels which pixel values are obtained in the captured image data and have values in the vicinity of a maximum luminance value (in a range of maximum luminance to (maximum luminance—5)) are calculated, and (ii) a difference between the maximum value and the minimum value of average values (Ra, Ga, and Ba) of the respective color channels is not less than a corresponding given value [Max (Ra, Ga, and Ba)−Min (Ra, Ga, and Ba)>0.1×Max (Ra, Ga, and Ba)]. Then, in response to the determined result that the captured image has a poor color balance, the control section 109 causes the display section 105 to display the determined result and an instruction urging image capture to be carried out again.

As for blur (an intense camera shake: a so-called motion blur), an edge of the captured image is less acute when the blur occurs. In view of this, the captured image determination section 102 prepares an edge intensity image by use of the edge extraction filter, and prepares a histogram so as to calculate a standard deviation of the histogram (a square root of the variance). In a case where the standard deviation is not more than a given threshold (e.g., 5), the captured image determination section 102 determines that a blur occurs in the captured image. Then, in response to a determined result of the determination that a blur occurs in the captured image, the control section 109 causes the display section 105 to display the determined result and an instruction urging image capture to be carried out again.

(4) Arrangement of Image Output Apparatus

An arrangement of the image output apparatus 200 is described below. In the present embodiment, the image output apparatus 200 is a multifunction printer which has functions of a scanner, a printer, a copying machine, and the like.

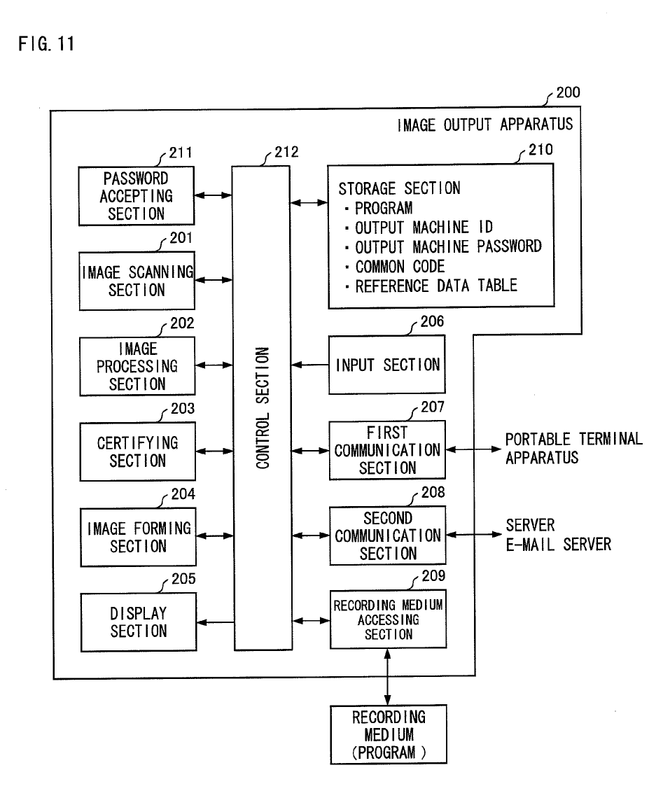

FIG. 11 is a block diagram illustrating the arrangement of the image output apparatus 200. The image output apparatus 200 includes an image scanning section 201, a password accepting section 211, an image processing section 202, a certifying section (determination section) 203, an image forming section (output section) 204, a display section 205, an input section 206, a first communication section (image data receiving section) 207, a second communication section (output section) 208, a recording medium accessing section 209, a storage section 210 (second storage means), and a control section (output section) 212.

The image scanning section 201 scans a document and has a scanner section including a CCD (Charge Coupled Device) which converts light reflected from the document to an electric signal (an analogue image signal) which has been subjected to R, G, and B color separations. Then, the image scanning section 201 supplies this electric signal.

The password accepting section 211, after receiving a transmission request of the output machine ID from the portable terminal apparatus 100, transmits to the portable terminal apparatus 100 an output machine ID (first identification information) stored in the storage section 210, which output machine ID identifies its own apparatus (image output apparatus 200). Moreover, the password accepting section 211 causes the storage section 210 to store the password received from the portable terminal apparatus 100. Furthermore, the password accepting section 211, upon receiving a request from the portable terminal apparatus 100 to transmit a reference data table, replies back by transmitting to the portable terminal apparatus 100 all of the reference data tables stored in the storage section 210 with which the common codes (second identification information) indicative of table numbers of respective reference data tables are associated.

The image processing section 202 carries out given image processing with respect to image data. According to the present embodiment, the image processing section 202 carries out the decoding process with respect to the captured image data transmitted from the portable terminal apparatus 100. The image processing carried out by the image processing section 202 with respect to the captured image data will be described later in detail.

The certifying section 203 carries out certification of the output machine ID and password included in the pass code attached to the captured image data, when the output process is carried out with respect to the captured image data received from the portable terminal apparatus 100. In detail, the certifying section 203 determines that certification is successful in a case where an output machine ID and password received from the portable terminal apparatus 100 matches the output machine ID and password stored in the storage section 210. The certifying section 203 transmits a certified result to the control section 212.

The image forming section 204 forms an image on recording paper such as paper by use of an electrophotographic printing method, an ink-jet method, or the like. Namely, the image forming section 204 carries out the printing process which is one of the output processes.

The display section 205 is realized by a liquid crystal display device, for example. The input section 206 is provided for entering data by, for example, touching a touch panel or pressing a button included in the liquid crystal display device.

The first communication section 207 has functions of the serial/parallel transfer and the wireless data communication which are carried out in conformity with the USB 1.1 or USB 2.0 Standard. The first communication section 207 receives, from the portable terminal apparatus 100, the captured image data to which the file name, the information on the model of the portable terminal apparatus 100, the user information, and the output process information are added.

The second communication section 208 has the following functions (a) through (c): (a) data communication employing a wireless technology which is in conformity with any one of LAN standards IEEE 802.11a, IEEE 802.11b, and IEEE 802.11g, (b) data communication with a network, via a LAN cable, having a communications interface function employing Ethernet (registered trademark), and (c) data communication employing a wireless technology which is in conformity with any one of communication systems such as IEEE 802.15.1 (so-called Bluetooth (registered trademark) which is the wireless communication standard, the infrared communication standard such as IrSimple, and Felica (registered trademark).

The second communication section 208 carries out, as the output process, (i) the filing process for causing the captured image data to be stored in the server or (ii) the e-mail transmission process for transmitting the e-mail to which the captured image data is attached.

The recording medium accessing section 209 reads out a program from a recording medium in which the program is recorded.

The storage section 210 serves as a section in which (i) a program for causing the sections of the image output apparatus 200 to carry out their respective processes and (ii) various information are stored. The storage section 210 stores, as the various information, the output machine ID for identifying its own image output apparatus 200, the password accepted by the password accepting section 211, and code-table corresponding information.

In the embodiment, the code-table corresponding information is information which associates (i) the common code (in the present embodiment, a table number), (ii) the reference data table identified by the common code, and (iii) the inverse transformation table for restoring the image data which has been subjected to the shuffling process by use of the reference data table back to the original image data. The storage section 210 stores (a) a plurality of types of reference data tables that are prepared in advance and (b) inverse transformation tables corresponding to the reference data tables, respectively.

Moreover, in the present embodiment, each of the image output apparatuses 200 included in the captured image processing system has the storage section 210, and each of the storage sections 210 stores identical code-table corresponding information in advance. Therefore, when the plurality of image output apparatuses 200 accept a same common code, the image output apparatuses 200 specify an identical reference data table and an identical inverse transformation table.

The control section 212 carries out control with respect to the sections included in the image output apparatus 200. In detail, when the first communication section 207 receives the captured image data and pass code from the portable terminal apparatus 100, the control section 212 supplies the captured image data and the common code to the image processing section 202 so as to control the image processing section 202 to carry out the image processing. In addition, the control section 212 supplies, to the certifying section 203, the output apparatus ID and password included in the pass code attached to the captured image data, so as to control the certifying section 203 to carry out a certification process.

When receiving a certified result that the certification has been successfully carried out, the control section 212 controls the corresponding process to be carried out in accordance with the output process information received from the portable terminal apparatus 100, with respect to the captured image data to which the given image processing has been carried out by the image processing section 202. Namely, in a case where the output process information is indicative of the printing process, the control section 212 controls the image forming section 204 to carry out the printing in accordance with the captured image data which has been subjected to the image processing by the image processing section 202. Alternatively, in a case where the output process information is indicative of the filing process or the e-mail transmission process, the control section 212 controls the second communication section 208 to carry out the filing process or the e-mail transmission process in accordance with the captured image data which has been subjected to the image processing by the image processing section 202.

(5) How to Prepare Reference Data Table

The following description explains how to prepare the reference data table that is stored in the storage section 210.

Data of a blue-noise mask used in halftone processing of image processing is applicable as elements of the reference data table. An example of a usable method of preparing the data of the blue-noise mask is a method disclosed in Literature ‘Proc. SPIE, 1913, 332-343 (1993), R. Ulichney “The void-and-cluster method for dither array generation”’ which is introduced in Japanese Patent Application Publication, Tokukai, No. 2002-44445 A. In the Japanese Patent Application Publication, Tokukai, No. 2002-44445 A, the blue-noise prepared by the method disclosed in the Literature is described to have a problem that the blue-noise has local roughness caused by random dots, and that the blue-noise has random patterns repetitively provided periodically at a time of half toning. It is described in the Literature that these problems cause easy appearance of a global roughness appearing repeatedly at matrix size intervals, thereby causing deterioration in image quality. However, with the present embodiment, the object is to locate pixels in a random manner, so this problem does not become an issue.

The elements of the reference data table can also be prepared by use of a general random noise.

The reference data table prepared as such is stored in advance in the storage section 210 of each of the image output apparatuses 200.

(6) Image Processing Carried Out by Image Processing Section

The image processing carried out by the image processing section 202 is described below in detail. Note that the description below discusses details of the image processing carried out with respect to the captured image data received from the portable terminal apparatus 100, though the image processing section 202 also carries out the image processing with respect to the image data scanned by the image scanning section 201.

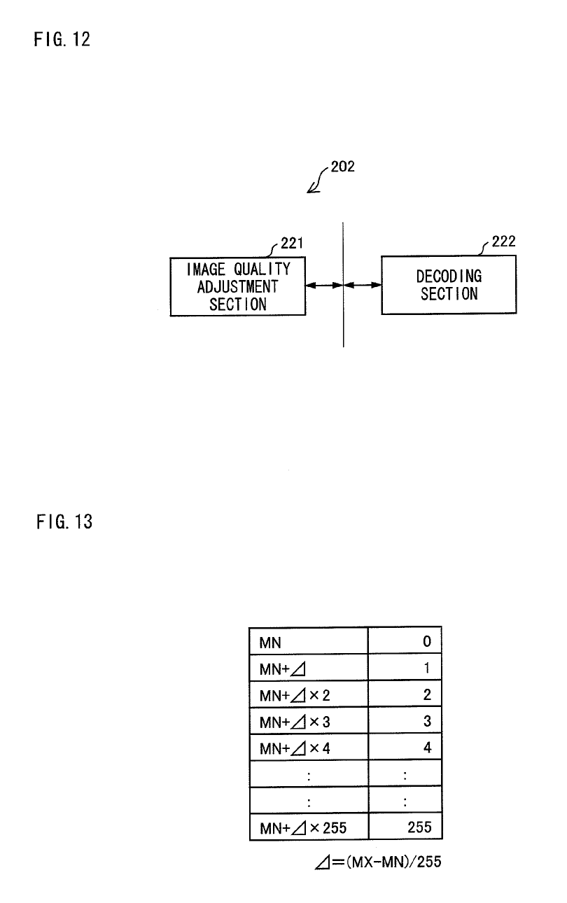

FIG. 12 is a block diagram illustrating an inner arrangement of the image processing section 202. As illustrated in FIG. 1, the image processing section 202 includes an image quality adjustment section 221 and a decoding section 222. Specific processing details of each of the sections are described one by one in the following description.

(6-1) Decoding Section

The decoding section 222 carries out a decoding process with respect to the captured image data which has been subjected to the shuffling process.

The decoding section 222 reads out, from the storage section 210, an inverse transformation table that corresponds to the common code in the pass code attached to the captured image data. Further, the decoding section 222, similarly to the shuffling process, changes pixel locations of the captured image data by use of the inverse transformation table read out from the storage section 210. In a case where the common code is a normal common code, the decoding section 222 can prepare captured image data which has the pixel locations aligned in a normal order.

(6-2) Image Quality Adjustment Section

The image quality adjustment section 221 carries out correction of color balance and contrast of the captured image data. The image quality adjustment section 221 (i) finds maximum and minimum values of the captured image data decoded by the decoding section 222 for each of the color channels, (ii) prepares look-up tables which cause the color channels to have uniform maximum and minimum values, and (iii) applies the look-up tables to the respective color channels. FIG. 13 shows an example of the look-up tables. As shown in FIG. 13, in a case where (i) a given channel has a maximum value of MX and a minimum value of MN and (ii) the data has 8 bits, a look-up table can be prepared that causes an increase from MN in increments of (MX−MN)/255. Thereafter, the image quality adjustment section 221 transforms the pixel values in accordance with the prepared table. This as a result corrects the color balance.

The image quality adjustment section 221 carries out the contrast correction in a similar manner to the color balance correction. Note that the look-up tables applied to the respective color channels can be identical in a case where it is unnecessary to change a color balance to a specific one.

Note that an alternative publicly-known technique can be applied to the color balance and contrast corrections.

(7) Setting Process of Pass Code

Next described is a setting process of the pass code. As described above, in order to set a pass code, it is required that the portable terminal apparatus 100 acquires the output machine ID and the reference data table in advance. Moreover, the portable terminal apparatus 100 requires having a password transmitted to the image output apparatus 200 and having the password be registered in advance.

First described is the acquisition of the output machine ID. A user of the portable terminal apparatus 100 establishes communication between (i) the portable terminal apparatus 100 and (ii) the image output apparatus 200 from which the user wishes to output the captured image data. More specifically, by operating the portable terminal apparatus 100, the user establishes a communication between the portable terminal apparatus 100 and the image output apparatus 200 through a wireless communication or Internet connection. Alternatively, as disclosed in Japanese Patent Application Publication, Tokukai, No. 2009-100191 A, in a case where the communication section 104 of the portable terminal apparatus 100 has a distinguishing mark such as an IC tag or an RFID, and the first communication section 207 of the image output apparatus 200 has a distinguishing mark read/write device that can establish short-distance wireless communication with such a distinguishing mark, the communication between the portable terminal apparatus 100 and the image output apparatus 200 can be established by bringing the portable terminal apparatus 100 towards the distinguishing mark read/write device.

Once the line of communication is established, the ID accepting section 110 of the portable terminal apparatus 100 transmits a “session ID transmission message” to the image output apparatus 200. This session ID transmission message is made up of “message ID, session ID”; hence, by sending this message, a prepared session ID is passed onto the image output apparatus 200. Note that the image output apparatus 200 is set in a state (standby state) that the image output apparatus 200 can receive the session ID transmission message at all times.

Next, at the point in time where the session ID is received from the portable terminal apparatus 100, the password accepting section 211 of the image output apparatus 200 transmits a “registration request message”. In the embodiment, the registration request message is made up of “message ID, session ID, output machine ID”. Hence, the session ID and output machine ID are transmitted to the portable terminal apparatus 100 by transmitting this registration request message. As a result, the output machine ID acquisition section obtains the output machine ID from the image output apparatus 200 as such. Note that, an IP address of a multifunction printer or a value calculated from an IP address by use of hash function or the like (e.g., a value calculated by an algorithm generally used in encryption and the like such as SHA-256) can be used as the “output machine ID”.

The following description deals with procedures for registering a password. As described above, while the connection is established between the portable terminal apparatus 100 and the image output apparatus 200, the ID accepting section 110 of the portable terminal apparatus 100 transmits a password that is entered into the input section 106, to the image output apparatus 200. Meanwhile, the password accepting section 211 of the image output apparatus 200 stores the received password in the storage section 210. This completes the registration process of the password.

The password enables verification that the transfer of the captured image data to the specific image output apparatus 200 is trustworthy. Therefore, the password is changeable per image output apparatus 200. Namely, in a case where the user wishes to output captured image data by using a different image output apparatus 200 per piece of captured image data, password registration is to be carried out in advance for each of the plurality of image output apparatuses 200. At this time, a different password is to be registered per image output apparatus 200.

Moreover, in a case where no reference data table is stored in the storage section 108, the table acquisition section 111 of the portable terminal apparatus 100 transmits a transmission request for the reference data table to the image output apparatus 200, while the communication between the portable terminal apparatus 100 and the image output apparatus 200 is established to acquire the output machine ID and to carry out the password registration process. Subsequently, the password accepting section 211 of the image output apparatus 200 transmits back all of reference data tables stored in the storage section 210 to the portable terminal apparatus 100, which reference data tables are associated with common codes, respectively, which common codes are indicative of table numbers of corresponding reference data tables. As a result, the portable terminal apparatus 100 acquires the reference data tables.

Once the portable terminal apparatus 100 acquires the output machine IDs and the reference data tables, the pass code setting section 112 sets a pass code in accordance with an entry of a user.

The pass code setting section 112 can set a same pass code with respect to a plurality of pieces of captured image data. In this case, the pass code setting section 112 causes the display section 105 to display a list of the captured image data, and urges the user to enter which of the plurality of pieces of captured image data is to be set to have the same pass code. Thereafter, the pass code setting section 112 sets a pass code in accordance with the entry of the user, with respect to the selected plurality of captured image data.

Alternatively, the pass code setting section 112 can set the pass code before the image capture section 101 captures an image. The pass code setting section 112 then can assign the pass code set in advance to the captured image data obtained by image capture with the image capture section 101.

Moreover, the pass code setting section 112 can set a different pass code per piece of captured image data. Namely, the captured image data can be consecutively displayed on the display section 105, and the pass code setting section 112 can cause display of a screen that urges the user to enter a pass code each time the captured image data is displayed. Alternatively, the pass code setting section 112 can cause display of a screen that urges the user to enter a pass code, every time the image capture section 101 carries out image capture in the image output mode.

(8) Procedures of Image Processing Carried Out in Captured Image Processing System

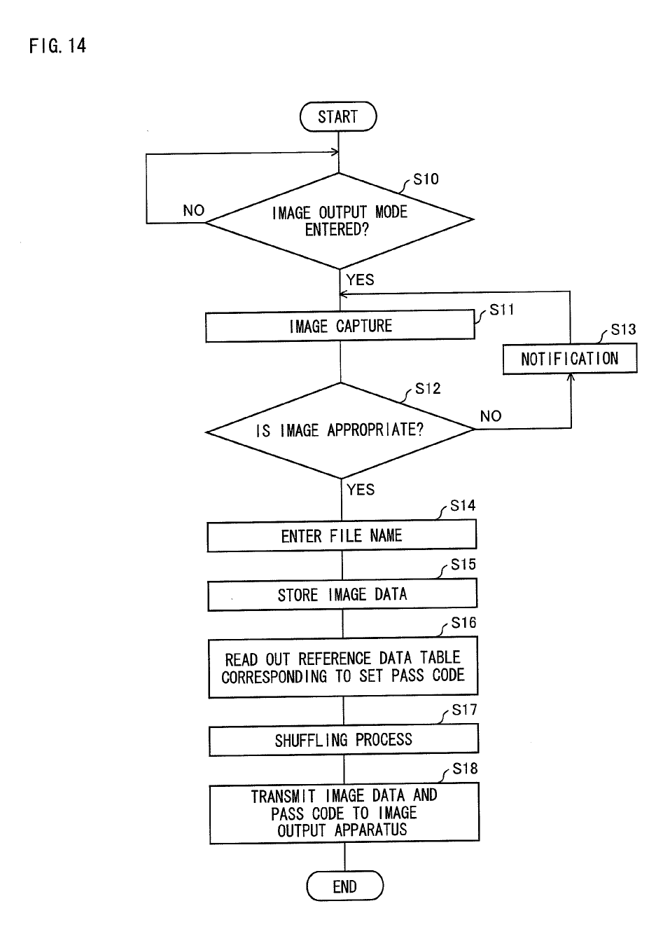

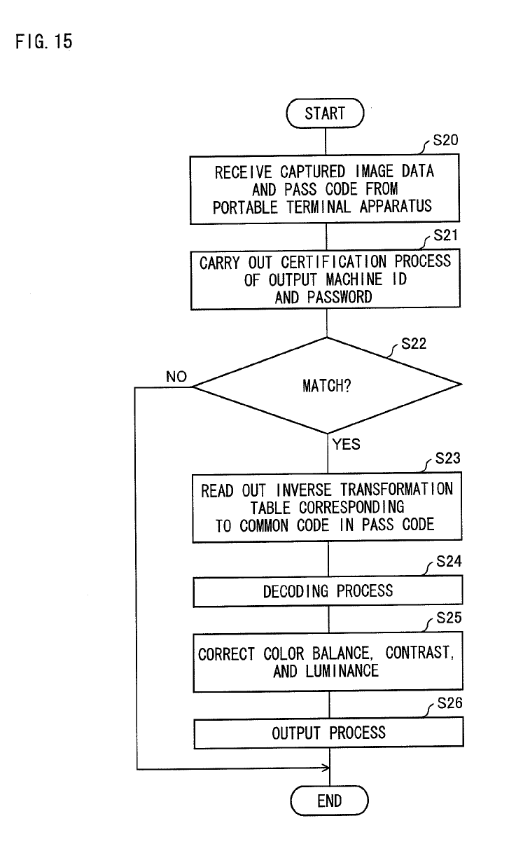

A flow of processes carried out in the captured image processing system according to the present embodiment is described below. Note that FIG. 14 illustrates a processing flow in the portable terminal apparatus 100, and FIG. 15 illustrates a processing flow in the image output apparatus 200.

First described are procedures of the portable terminal apparatus 100, with reference to FIG. 14. The portable terminal apparatus 100 checks whether or not an instruction to carry out image capture in the image output mode is entered (S10). In a case where the portable terminal apparatus 100 accepts the entry of selecting the image output mode, the control section 109 controls the display section 105 to display a screen urging an entry of (i) types of the output process and (ii) setting conditions of output processes, and obtains output process information from the input section 106.

When detecting a shutter click, the image capture section 101 carries out image capture (S11).

Next, the image processing section 103 carries out at least the A/D conversion process with respect to data of a captured image. Then, the captured image determination section 102 determines whether or not the captured image data which has been subjected to the A/D conversion process meets the process execution requirements (S12), as described in the foregoing (3).

In a case where the captured image determination section 102 determines that the process execution requirements are not met (NO in S12), the control section 109 controls the display section 105 to display a message urging image capture to be carried out again, so that the user is notified of the message (S13). In a case where even an image which has been captured again does not meet the determination items as mentioned above, the portable terminal apparatus 100 repeatedly carries out steps S11 through S13.

In contrast, in a case where the captured image determination section 102 determines that the process execution requirements are met (YES in S12), the control section 109 assigns file names to the respective plurality of pieces of captured image data which meet the process execution requirements (S14). Note that the control section 109 can automatically assign different file names for each plurality of pieces of captured image data, (e.g., serial numbers which vary in accordance with image capture date and time) or can assign file names that are entered from the input section 106. Thereafter, the control section 109 causes the storage section 108 to store the captured image data which is assigned with the file name (S15).

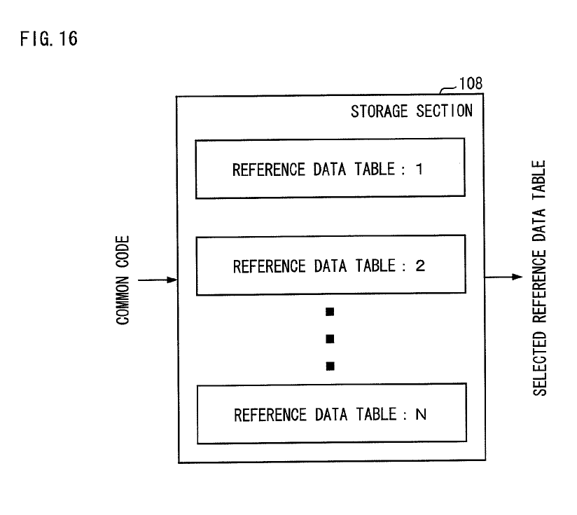

Next, the control section 109 causes transmission of the common code in the set pass code, to the table selecting section 103a. The table selecting section 103a reads out, from the storage section 108, a reference data table corresponding to the common code (S16). FIG. 16 is a view illustrating a selection process of the reference data table. As illustrated in FIG. 16, reference data tables are stored in the storage section 108 in such a manner that the reference data tables are associated with table numbers, respectively. The table selecting section 103a thus selects the reference data table that corresponds to the table number indicated by the common code.

The encoding section 103b then carries out a shuffling process by use of the reference data table read out by the table selecting section 103a, to the captured image data stored in the storage section 108 at S15. This captured image data which has been subjected to the shuffling process is stored in the storage section 108 in such a manner that the captured image data is associated with a pass code and a respective output process information (S17).

After receiving an entry into the input section 106 to instruct transmission of the captured image data, the control section 109 controls the communication section 104 so that the captured image data which has been subjected to the shuffling process by the encoding section 103b is transmitted to the image output apparatus 200 together with the output process information and the pass code (S18). In the present embodiment, the portable terminal apparatus 100 and the image output apparatus 200 communicate with each other by use of a short-distance wireless communication. Hence, the user carrying the portable terminal apparatus 100 comes in the vicinity of the image output apparatus 200, and then enters the transmission instruction.

Next described is processes carried out in the image output apparatus 200, with reference to FIG. 15. First, the first communication section 207 of the image output apparatus 200 receives, from the portable terminal apparatus 100, the captured image data, pass code, and output process information (S20).

The certifying section 203 carries out certification of the output machine ID and password included in the received pass code (S21). More specifically, the certifying section 203 determines whether or not the output machine ID and password included in the pass code matches the output machine ID and password stored in the storage section 210. In a case where the output machine IDs and passwords match each other, the certifying section 203 determines that the certification is successful.

In a case where the certification is successful (Yes in S22), the decoding section 222 of the image processing section 202 reads out an inverse transformation table corresponding to the common code included in the pass code, from the code-table corresponding information stored in the storage section 210 (S23). Thereafter, the decoding section 222 carries out a transformation process (decoding process) of pixel locations of the received captured image data, by use of the inverse transformation table read out (S24). This obtains captured image data in which pixel locations are aligned in normal order.

Thereafter, the image quality adjustment section 221 carries out for example correction of color balance and contrast to the decoded captured image data, as described in the foregoing (5-2) (S25).

Subsequently, the control section 212 controls the image output apparatus 200 to carry out the output process of the captured image data which has been subjected to the process at S25, in accordance with the output process information received from the portable terminal apparatus 100 (S26).

For example, in a case where the output process information is indicative of the printing process, the control section 212 controls the image forming section 204 to carry out the printing of an image indicated by the captured image data which has been subjected to the process of S25. Alternatively, in a case where the output process information is indicative of the filing process or the e-mail transmission process, the control section 212 controls the second communication section 208 to carry out the filing process or the e-mail transmission process in accordance with the captured image data which has been subjected to the process of S25. Thereafter, the process is terminated.

As described above, according to the present embodiment, an output machine ID of one or a plurality of image output apparatus 200 from which the user wishes to carry out output is acquired in advance. Moreover, the plurality of image output apparatuses 200 store same inverse transformation tables, and the portable terminal apparatus 100 has reference data tables corresponding to the inverse transformation tables. Thereafter, the portable terminal apparatus 100 carries out a shuffling process to the captured image data by use of a respective one of the reference data tables. Subsequently, the portable terminal apparatus 100 transmits, to the image output apparatus 200, the captured image data which has been subjected to the shuffling process, together with (i) the common code that is a table number specifying the respective reference data table and inverse transformation table and (ii) the output machine ID.

On the other hand, just in a case where the received output machine ID matches its own output machine ID, the image output apparatus 200 decodes the received captured image data by use of the common code, and outputs the image.

Hence, even in a case where the user mistakenly transmits the captured image data to a different image output apparatus 200, the image output apparatus 200 will not succeed in certifying the output machine ID. As a result, no image output is carried out. Meanwhile, in a case where the image output apparatus 200 from which the user desires to output the image cannot operate due to failure or the like, the image can still be outputted by transmitting the captured image data together with the output machine ID and the common code, to another image output apparatus 200 of which its output machine ID is acquired beforehand.

(9) Modifications

The captured image processing system of the present invention is not limited to the description of the embodiment above, but can be variously modified. An example of a modified embodiment is described below.

(9-1) Shuffling Method

In the foregoing description, a method of the shuffling process carried out by the encoding section 103b is a method that uses a single reference data table for all of color components R, G, and B (shuffling method a). However, how the shuffling process is carried out is not limited to the shuffling method a. The shuffling process can also be carried out by the following shuffling methods b to e.

Shuffling Method b: a same reference data table is used for all of color components of R, G, and B, and block order is also changed.

Shuffling Method c: a same reference data table is used for all of color components of R, G, and B, and a different reference data table is used per block.

Shuffling Method d: a different reference data table is used per color components of R, G, and B.

Shuffling Method e: a different reference data table is used per color components of R, G, and B, and a different reference data table is used per block.

The following description specifically explains each of these methods. The following description explains the encoding process. The decoding process is carried out in a similar manner as the encoding process, though by use of the inverse transformation table.

(Shuffling Method b)

The shuffling method b first divides the captured image data into a plurality of blocks each having an identical size to the reference data table. Thereafter, the shuffling process is carried out to the pixel locations in each block to change the pixel locations by use of the reference data table. Furthermore, a shuffling process to change block positions is carried out in units of blocks, with use of the same reference data table.

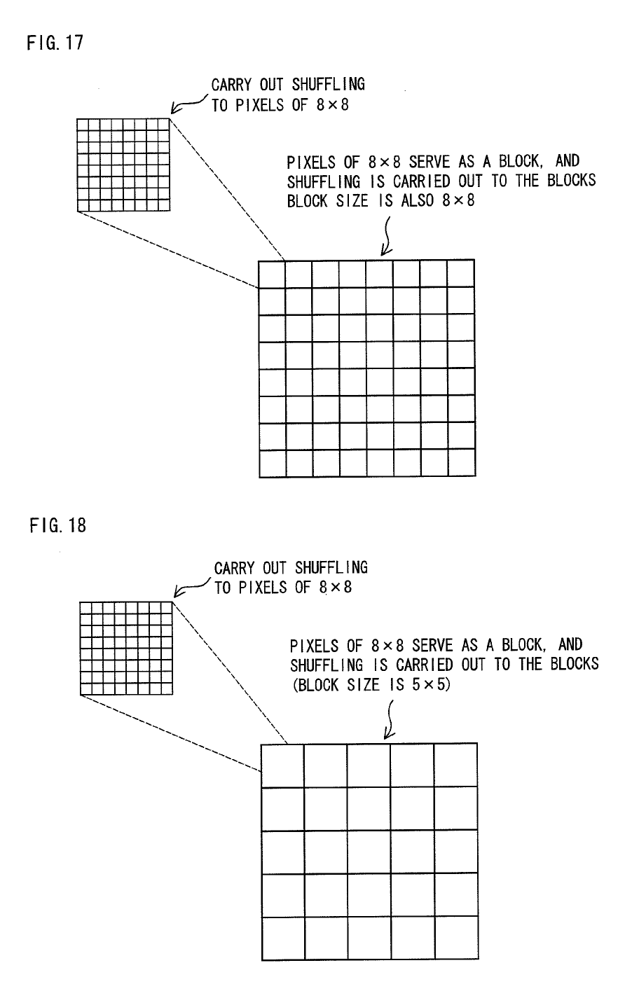

FIG. 17 is a view illustrating the shuffling method b. As illustrated in FIG. 17, the captured image data is divided into 8×8 blocks, where one block is a pixel group of 8×8 pixels. In each of the blocks, locations of the pixels that make up the block are changed with use of the same reference data table having a size of 8×8. Furthermore, location of the blocks that make up the block group of 8×8 blocks is changed with use of the reference data table having the size of 8×8. Since the shuffling is carried out in units of pixels in each of the blocks and further in units of blocks, it is possible to enhance the confidentiality of the captured image data.

In the embodiment, as illustrated in FIG. 17, a same reference data table is usable in a case where the number of rows and columns of blocks that make up the captured image data and the number of rows and columns of pixels that make up each of the blocks are identical to each other (e.g., 8×8).

In comparison, in a case where the number of rows and columns of blocks that make up the captured image data (5×5) and the number of rows and columns of pixels that make up each of the blocks (8×8) are different from each other as illustrated in FIG. 18, a reference data table having a size of 8×8 is used for the shuffling process in units of pixels, and a reference data table having a size of 5×5 is used for the shuffling process in units of blocks.

Note that with the shuffling method b, shuffling of the color components of R, G, and B is carried out in the same method.

(Shuffling Method c)

In the shuffling method a, the shuffling is to be carried out to each of the blocks by use of a same reference data table in a case where the captured image data is divided into a plurality of blocks having an identical size as the reference data table (see FIG. 10). In comparison, the shuffling method c separates the plurality of blocks into a plurality of groups; a different reference data table is assigned per group, and the shuffling is carried out to the blocks by use of its respective reference data table that is assigned to the group that the block belongs to. For example, shuffling can be carried out to blocks (1) and (4) in FIG. 10 by use of a reference data table of a common code 1 while shuffling is carried out to blocks (2) and (3) in FIG. 10 by use of a reference data table of a common code 2. Alternatively, shuffling can be carried out to the blocks (1) to (4) in FIG. 10 by use of reference data tables of common codes 1 to 4, respectively.

In the shuffling method c, shuffling of the color components of R, G, and B is carried out in the same method.

(Shuffling Method d)

The shuffling method d is similar to the shuffling method a in such a manner that shuffling is carried out in units of pixels with respect to the color components of R, G, and B, by use of a single reference data table. However, with the shuffling method d, a different reference data table is used for each of the color components of R, G, and B.

(Shuffling Method e)

Shuffling method e combines the shuffling methods c and d. Namely, a plurality of blocks are separated into a plurality of groups; a different reference data table is assigned per group, and the shuffling is carried out to the blocks by use of its respective reference data table assigned to the group that the block belongs to. Further, a different reference data table is used per color component of R, G, and B.

The following description explains a common sub-code. In a case where the shuffling method a is applied, the reference data table and the inverse transformation table are specified by a common code indicative of a table number of one reference data table. This enables the encoding and decoding of the captured image data. However, with the shuffling methods b to e, there are cases where a plurality of reference data tables are used, and thus is not possible to specify the plurality of tables just by the common code. Consequently, in the shuffling methods b to e, a common sub-code is used in addition to or instead of the common code.

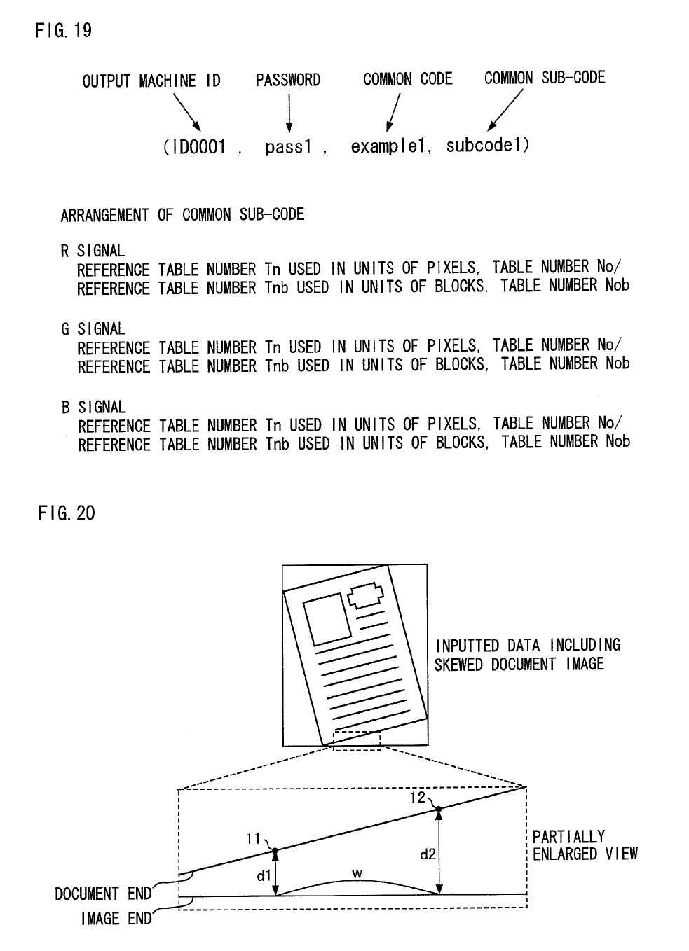

FIG. 19 is a view illustrating an arrangement of a pass code using a common sub-code, and is a view showing an arrangement of a common sub-code. As illustrated in FIG. 19, in a case where the common sub-code is used, the pass code setting section 112 sets a pass code including an output machine ID, a password, a common code, and a common sub-code.

Further, as illustrated in FIG. 19, the common sub-code includes, per each of planes of R, G, and B, a number Tn of a reference data table to be used for the shuffling in units of pixels and its table number No, and a number Tnb of the reference data table to be used for the shuffling in units of blocks and its table number Nob.

Described below is how the common sub-code is set in each of the shuffling methods a to e.

In the case of the shuffling method a, the common sub-code is set, for all of R, G, and B, as: Tn=1, No=m (m=1 to N), Tnb=0, and Nob=0. In the shuffling method a, the common code is indicative of No, so therefore the common sub-code may be left as a blank.

In the case of the shuffling method b, the common sub-code is set to have same values in all of R, G, and B. In the case where a same reference data table is used for the shuffling in units of pixels and the shuffling in units of blocks, the common sub-code is set as Tn=1, No=m (m=1 to N), Tnb=1, and Nob=m. In comparison, in the case where a different reference data table is to be used for the shuffling in units of pixels and the shuffling in the units of blocks as illustrated in FIG. 18, the common sub-code is set as Tn=1, No=m (m=1 to N), Tnb=1, and Nob=k (k=1 to N).

Also in the case of the shuffling method c, same values of the common sub-code is set in all of the R, G, and B. The common sub-code is set as, for example, Tn=2, No=p,q (p,q=1 to N), Tnb=0, and Nob=0.

In the case of the shuffling method d, the common sub-code is set to have different values between R, G, and B. For example, the common sub-code is set in the R signal as Tn=1, No=a (a=1 to N), Tnb=0, and Nob=0; the common sub-code is set in the G signal as Tn=1, No=b (b=1 to N), Tnb=0, and Nob=0; the common sub-code is set in the B signal as Tn=1, No=c (c=1 to N), Tnb=0, and Nob=0.

In the case of the shuffling method e also, the common sub-code is set to have different values between R, G, and B. For example, the common sub-code is set in the R signal as Tn=2, No=a,b (a,b=1 to N), Tnb=0, and Nob=0; the common sub-code is set in the G signal as Tn=2, No=b,c (b,c=1 to N), Tnb=0, and Nob=0; and the common sub-code is set in the B signal as Tn=21, No=c,a (c,a=1 to N), Tnb=0, and Nob=0.

In the case where a plurality of reference data tables are used, as in the shuffling methods b to e, the pass code setting section 112 may set the common sub-code in accordance with an entry of the user. Alternatively, the pass code setting section 112 may use a table number randomly selected from a range of 1 to N. For example, the pass code setting section 112 can prepare a random number at a set timing, and a table number from the range of 1 to N may be selected based on the prepared random number.

Moreover, in the case of the shuffling methods c and e, a different reference data table is used per block. Consequently, the pass code setting section 112 includes block information in the common sub-code, which block information indicates which reference data table of which table number is used in which block.

Random numbers may be used as the block information. For example, in a case where there are two values of table numbers No, the pass code setting section 112 carries out a setting so that (i) a random number is prepared with respect to one of the two values of No, (ii) shuffling is carried out to a block(s) corresponding to the prepared random number by use of the reference data table corresponding to the one of the two values of No, and (iii) shuffling of remaining blocks are carried out by use of the reference data table corresponding to the other one of the two values of No. Note that a blue-noise can be used instead of the random number.

Moreover, one reference data table can be used as the block information. For example, in a case where there are two values of the table number No, the pass code setting section 112 designates a reference data table that has a same number of rows and columns as those of the blocks. In the reference data table, a block in a position which has been subjected to shuffling, which block is positioned in an even row prior to the shuffling, is shuffled by use of a reference data table corresponding to one of the two table numbers No, and the remaining blocks are shuffled by use of a reference data table corresponding to the other one of the two table numbers No.

Moreover, the encoding section 103b is capable of carrying out the shuffling process in any of the shuffling methods a to e, and the shuffling process can be carried out by a shuffling method selected by a user. In this case, the pass code setting section 112 includes, in the pass code, a method code (third identification information) for identifying the shuffling method.

The shuffling methods a to e are different in confidentiality of encoded captured image data. The shuffling methods c and e have the highest confidentiality, the shuffling methods b and d have the next highest confidentiality, and the shuffling method a has the lowest confidentiality. Accordingly, the pass code setting section 112 can urge the user to enter a required level of confidentiality, and can select an appropriate shuffling method in accordance with the entered confidentiality level. Alternatively, the pass code setting section 112 can urge the user to enter which shuffling method a to e to select, and the pass code setting section 112 selects the shuffling method in accordance with the entry by the user. The pass code setting section 112 includes a method code (third identification information) that corresponds to the selected shuffling method in the pass code.

The encoding section 103b and decoding section 222 of the portable terminal apparatus 100 specifies the shuffling method in accordance with the method code (third identification information) included in the pass code, and encodes and decodes the captured image data by use of the common sub-code.

(9-2) Method of Acquiring Reference Data Table

In the foregoing description, a plurality of image output apparatuses 200 store identical code-table corresponding information in advance. When the portable terminal apparatus 100 initially obtains any one of output machine IDs of the image output apparatuses 200, all of reference data tables and their common codes are acquired from the image output apparatus 200, and a reference data table to be used in the shuffling process is selected from all of the reference data tables acquired from the image output apparatus 200 (acquisition pattern a).

However, the method of acquiring the reference data table is not limited to this method. The reference data table can be acquired by the following acquisition patterns b to i.

(Acquisition Pattern b)

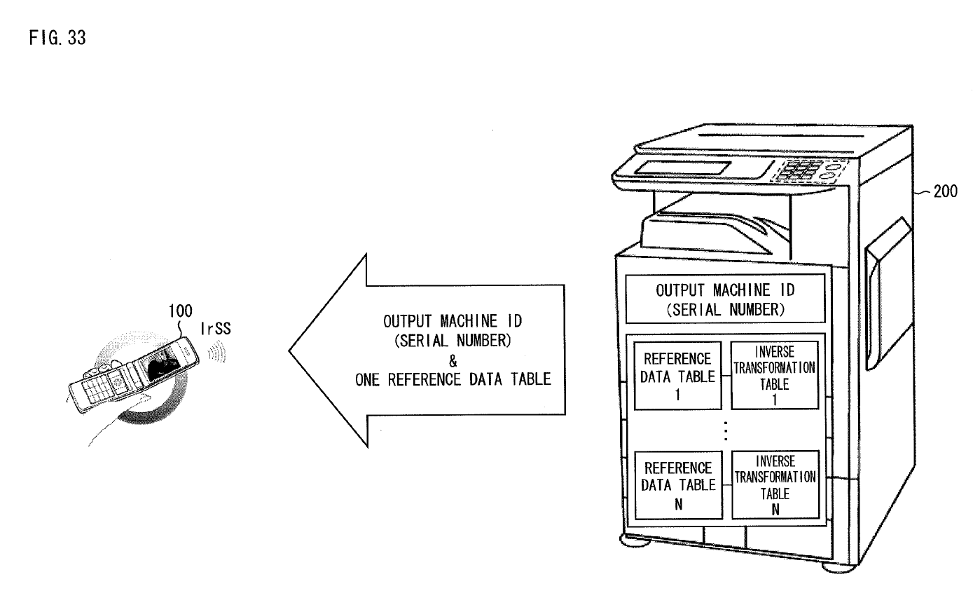

The acquisition pattern b differs from the acquisition pattern a in that not all of the reference data tables and their common codes are acquired from the image output apparatus 200, but just an amount (one or a plurality) of the reference data table(s) and its (their) common code(s) for the table acquisition section 111 of the portable terminal apparatus 100 required for carrying out the shuffling process is acquired. FIG. 33 is a view illustrating the acquisition pattern b.

Similarly to the acquisition pattern a, this acquisition pattern also has the plurality of image output apparatuses 200 store identical code-table corresponding information in advance. Consequently, even if one of the plurality of image output apparatuses 200 of which their output machine ID is acquired beforehand is broken, image output is easily carried out by setting a pass code including the same common code, with respect to another image output apparatus 200.

Moreover, with this acquisition pattern, there is no need for the portable terminal apparatus 100 to store an unnecessary number of reference data tables. Hence, capacity of the storage section 108 is more available in the portable terminal apparatus 100.

(Acquisition Pattern c)

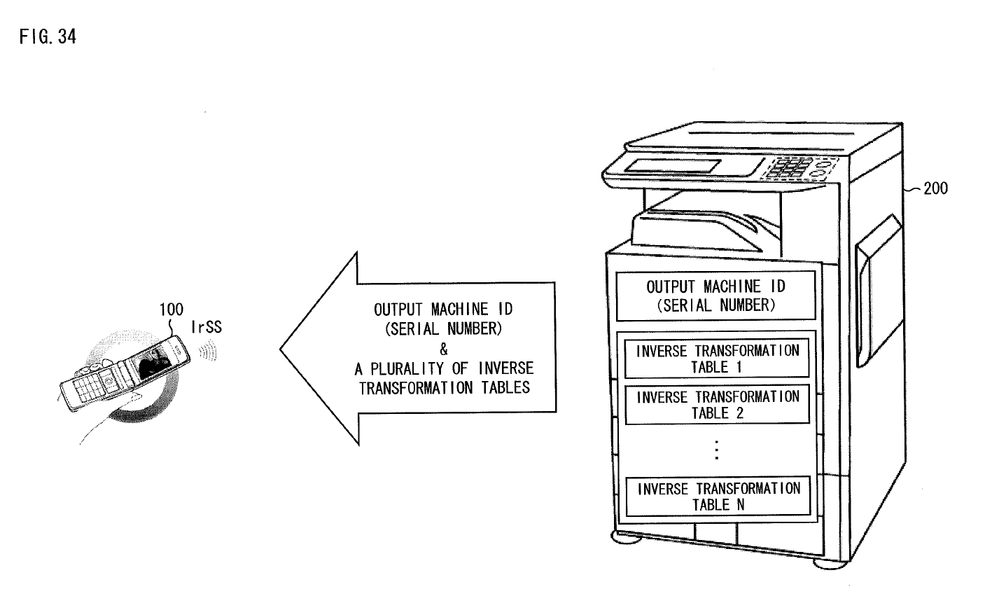

With the acquisition pattern c, the storage section 210 of the image output apparatus 200 stores information that associates the common code and the inverse transformation table identified by the common code, as the code-table corresponding information. Meanwhile, the storage section 210 stores no reference data table. In the acquisition pattern c, the table acquisition section 111 of the portable terminal apparatus 100 transmits to the image output apparatus 200 a transmission request for all of inverse transformation tables stored in the image output apparatus 200. Thereafter, as illustrated in FIG. 34, upon receiving this transmission request, the password accepting section 211 of the image output apparatus 200 transmits back to the portable terminal apparatus 100 all of the inverse transformation tables stored in the storage section 210, and also the common codes associated with the inverse transformation tables.

In the acquisition pattern c, the portable terminal apparatus 100 prepares a reference data table corresponding to the inverse transformation table, based on the acquired inverse transformation table. The prepared reference data table is to be stored in the storage section 108 in such a manner that the reference data table is associated with the common code.

(Acquisition Pattern d)

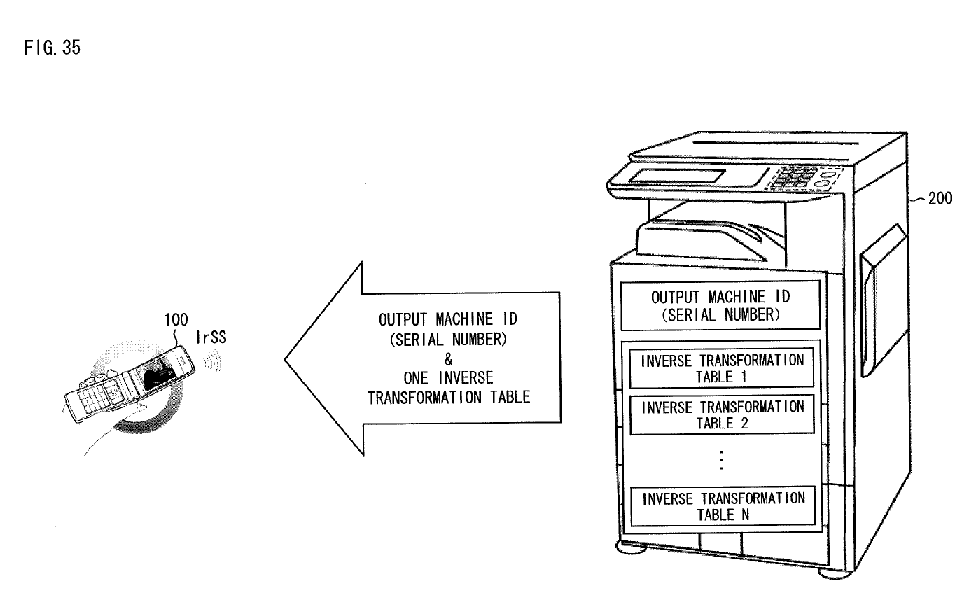

The acquisition pattern d is a modified pattern of the acquisition pattern c. In the acquisition pattern c, the password accepting section 211 of the image output apparatus 200 transmits back to the portable terminal apparatus 100 all of the inverse transformation tables stored in the storage section 210 and the common codes associated to the inverse transformation information. In comparison, as illustrated in FIG. 35, in the acquisition pattern d, the password accepting section 211 transmits back, to the portable terminal apparatus 100, just a number (one or a plurality) of inverse transformation tables with which their common codes are associated, which number is the number required for carrying out the shuffling process in the portable terminal apparatus 100. Thereafter, the portable terminal apparatus 100 prepares a reference data table corresponding to the inverse transformation table, based on the acquired inverse transformation table. This prepared reference data table is stored in the storage section 108 so as to correspond to a respective common code.

With this acquisition pattern, the portable terminal apparatus 100 has no need to store an unnecessary amount of reference data tables. As a result, more capacity is made available in the storage section 108 of the portable terminal apparatus 100.

(Acquisition Pattern e)

Similarly with the acquisition pattern a, the acquisition pattern e has a plurality of image output apparatuses 200 store identical pieces of code-table corresponding information. However, in this acquisition pattern, a server apparatus, which is a separate machine to the image output apparatus 200, also stores the identical code-table corresponding information in advance. The table acquisition section 111 of the portable terminal apparatus 100 accesses the server apparatus to acquire the reference data tables and their common codes. For example, the portable terminal apparatus 100 obtains an address of a server apparatus at a time when an output machine ID is obtained from the image output apparatus 200, and the server apparatus is accessed with reference to the address.

With this acquisition pattern, all of the reference data tables can be acquired as in the acquisition pattern a. In this case, the reference data table can be arbitrarily changed per piece of captured image data. Therefore, even if one reference data table is deciphered due to interception of one captured image data, it is not possible to properly decode other captured image data.

Moreover, as in the acquisition pattern b, just a number (one or a plurality) of reference data tables and their common codes required for carrying out the shuffling process may be acquired.

(Acquisition Pattern f)

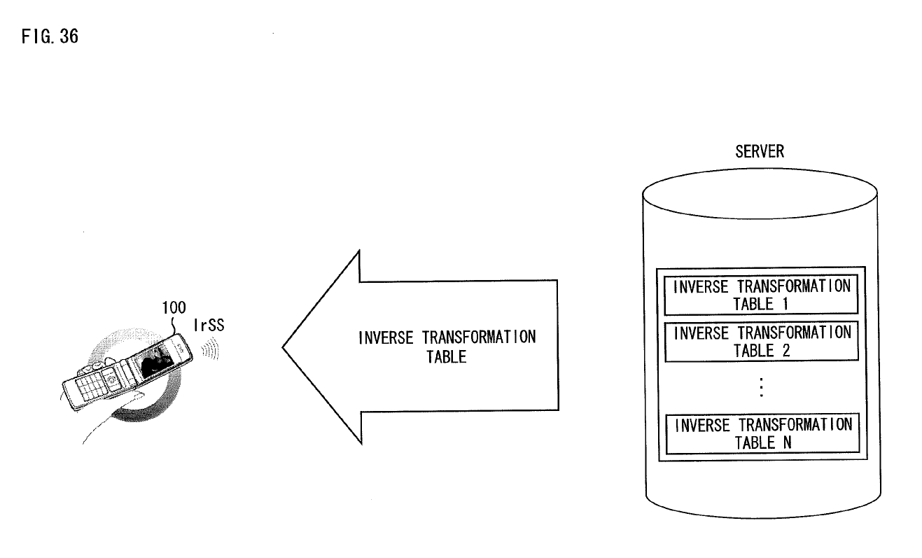

Similarly to the acquisition pattern c, in the acquisition pattern f, a plurality of image output apparatuses 200 store, in advance, the code-table corresponding information which associates the inverse transformation tables with respective common codes. However, in this acquisition pattern, a server apparatus, which is a separate machine from the image output apparatus 200, also stores the identical code-table corresponding information in advance. As illustrated in FIG. 36, the table acquisition section 111 of the portable terminal apparatus 100 accesses the server apparatus, to acquire the inverse transformation table and its common code. For example, the portable terminal apparatus 100 obtains an address of a server apparatus at a time when the portable terminal apparatus 100 obtains the output machine ID from the image output apparatus 200, and then the portable terminal apparatus 100 accesses the server apparatus with reference to the address. Thereafter, the portable terminal apparatus 100, based on the acquired inverse transformation table, prepares a reference data table that corresponds to the inverse transformation table. This prepared reference data table is stored in the storage section 108 so that the reference data table is stored corresponding to its respective common code.

With this acquisition pattern, all of the inverse transformation tables can be acquired as in the acquisition pattern c. In this case, it is possible to arbitrarily change the reference data table per piece of captured image data. Therefore, even if a reference data table is deciphered due to interception of one piece of captured image data, it is not possible to properly decode other pieces of captured image data.

Alternatively, as in the acquisition pattern d, just a number (one or a plurality) of reference data table(s) and its respective common code(s) required for carrying out the shuffling process can be acquired.

(Acquisition Pattern g)

In this acquisition pattern, the code-table corresponding information is not stored in the plurality of image output apparatuses 200 in advance. However, a server apparatus from which the plurality of image output apparatuses 200 and the portable terminal apparatus 100 are accessible through the Internet connection or the like stores (i) a plurality of reference data tables, (ii) inverse transformation tables corresponding the reference data tables, respectively and (iii) common codes that identify a pair of a reference data table and inverse transformation table.

The pass code setting section 112 of the portable terminal apparatus 100 accesses the server apparatus, and sets a pass code that includes a common code selected in accordance with an entry by a user among the common codes stored in the server apparatus. The table selecting section 103a acquires a reference data table corresponding to the common code set by the pass code setting section 112, and the encoding section 103b carries out the shuffling process by use of this acquired reference data table.

On the other hand, the image output apparatus 200 that receives the captured image data assigned with the pass code accesses the server apparatus, and acquires an inverse transformation table corresponding to the common code in the pass code. Thereafter, the decoding section 222 carries out decoding by use of the inverse transformation table acquired from the server apparatus.

According to the acquisition pattern g, the image output apparatus 200 and the portable terminal apparatus 100 just require acquiring, from the server apparatus, tables required for carrying out the encoding and decoding; there is no need for the image output apparatus 200 and the portable terminal apparatus 100 to store the reference data table or the inverse transformation table at all times. As a result, capacity of the storage section 210 can be usefully utilized.

(Acquisition Pattern h)

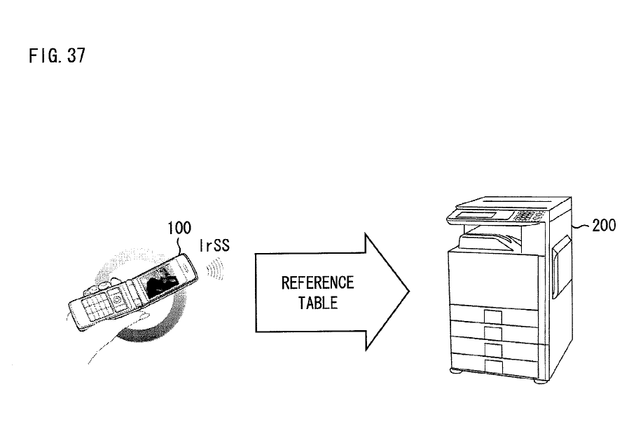

With the acquisition pattern h, the portable terminal apparatus 100 includes a table preparation section for randomly preparing a reference data table in the method described in the foregoing (5). The table acquisition section 111 of the portable terminal apparatus 100 (i) acquires a reference data table prepared by the table preparation section, (ii) assigns, as a common code, a table number that allows specification of the reference data table and (iii) stores in the storage section 108 the reference data table assigned with the common code. As illustrated in FIG. 37, when obtaining the output machine ID of the image output apparatus 200, the ID accepting section 110 transmits to the image output apparatus 200 the reference data table and its common code stored in the storage section 108, to cause registration.

Meanwhile, the image output apparatus 200, once receiving the reference data table and the common code from the portable terminal apparatus 100, prepares an inverse transformation table that corresponds to the reference data table. The prepared inverse transformation table is stored in the storage section 210 in such a manner that the inverse transformation table is associated with the common code.

Alternatively, the table preparation section may also prepare, together with the reference data table, an inverse transformation table corresponding to the reference data table. In this case, the ID accepting section 110 transmits the inverse transformation table and the common code to the image output apparatus 200, to cause registration of the inverse transformation table and the common code.

The table acquisition section 111 can obtain a reference data table and a common code corresponding to the reference data table not from the table preparation section but from a server apparatus as in the acquisition pattern e, and then transmit the obtained reference data table and the common code to the image output apparatus 200. In this case, the image output apparatus 200 (i) prepares an inverse transformation table corresponding to the reference data table, and (ii) stores the prepared inverse transformation table in the storage section 210 in such a manner that the inverse transformation table is associated with the common code.

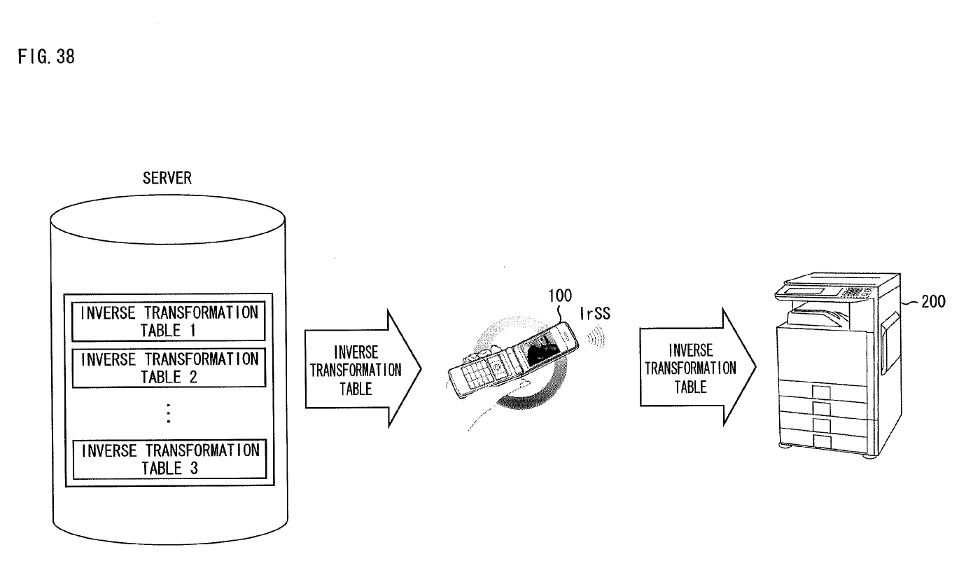

Alternatively, as illustrated in FIG. 38, the table acquisition section 111 can acquire an inverse transformation table and a common code corresponding to the inverse transformation table from the server apparatus as in the acquisition pattern f, and then transmit the acquired inverse transformation table and the common code to the image output apparatus 200. In this case, the portable terminal apparatus 100 prepares a reference data table corresponding to the inverse transformation table, based on the inverse transformation table acquired from the server apparatus. The prepared reference data table is stored in the storage section 108 in such a manner that the reference data table is associated with the common code.

(Acquisition Pattern i)

In the acquisition pattern h, the portable terminal apparatus 100 includes the table preparation section. However, the table preparation section can be provided in a computer apparatus communicable with the portable terminal apparatus 100. In this case, the table acquisition section 111 of the portable terminal apparatus 100 can acquire a table prepared by the table preparation section in the computer apparatus.

The acquisition patterns h and i use a reference data table and an inverse transformation table prepared uniquely by the user, so therefore no table is shared with another user. This enhances the confidentiality.

The acquisition patterns a to f are not limited to the case where the code-table corresponding information is stored in the image output apparatus 200 at the time of distributing the image output apparatus 200. For example, the reference data table and the inverse transformation table can be prepared in accordance with the foregoing (5) by the computer apparatus communicable with the image output apparatus 200, and also the computer apparatus may prepare code-table corresponding information by adding a unique common code to each of pairs of a reference data table and a respective inverse transformation table. Thereafter, the code-table corresponding information prepared by the computer apparatus can be stored in the image output apparatus 200. Alternatively, the computer device may be arranged to edit code-table corresponding information that is stored in the image output apparatus 200.

As a result, for example even in a case where a company has each of its sections use a same image output apparatus 200, it is possible to set different code-table corresponding information per section. As a result, it is possible to prevent image output from an image output apparatus 200 of a different section by mistake.

(9-3) Common Code

The foregoing description uses, as the common code, a table number that specifies a pair of the reference data table and the inverse transformation table. In this case, by checking the common code, it is possible to recognize with which reference data table the shuffling process has been carried out. Accordingly, it is preferable that the common code has the following arrangement, in order to enhance the confidentiality of the captured image data.

Namely, the portable terminal apparatus 100 includes a code corresponding information preparation section for preparing code corresponding information which associates (i) table numbers of reference data tables stored in the storage section 108 and (ii) a user entry code which is a code determined in accordance with an entry by a user. The code corresponding information preparation section stores the prepared code corresponding information in the storage section 108 while simultaneously transmitting the prepared code corresponding information to the image output apparatus 200. The image output apparatus 200 stores the received code corresponding information in the storage section 210.

The pass code setting section 112 of the portable terminal apparatus 100 sets the user entry code as the common code. Thereafter, the table selecting section 103a specifies a table number corresponding to the common code (user entry code) set by the pass code setting section 112 from the code corresponding information stored in the storage section 108. Furthermore, the table selecting section 103a reads out a reference data table of the specified table number from the storage section 108.

On the other hand, the image output apparatus 200 similarly specifies a table number corresponding to the common code (user entry code) included in the pass code, from the code corresponding information stored in the storage section 210. Thereafter, the decoding section 222 carries out decoding based on the inverse transformation table corresponding to the specified table number.

This makes it impossible to recognize, just by looking at the common code, which reference data table is used to carry out the shuffling process.

Although the user entry code is used as the common code, another code can be used as the common code. For example, the code corresponding information preparation section can prepare code corresponding information which associates (i) the table number(s) of a required number of reference data tables required for carrying out the shuffling process with (ii) an item number of the portable terminal apparatus 100 or a SIM card number. In this case, the pass code setting section 112 always sets the item number of the portable terminal apparatus 100 or the SIM card number as the common code.

(9-4) Password

In the foregoing description, a password is registered to the image output apparatus 200 when the output machine ID is obtained from the image output apparatus 200. However, the timing for registering the password is not limited to this. For example, the registration is sufficiently carried out as long as the password is registered after the output machine ID is acquired and before the image capture is carried out. For instance, a communication between the portable terminal apparatus 100 and the image output apparatus 200 can be established at a venue where the image capture is to be carried out or in an office before heading off to the venue, and the ID accepting section 110 may be caused to transmit a set password to the image output apparatus 200 in accordance with an entry of a user. The password accepting section 211 of the image output apparatus 200 then stores the received password in the storage section 210. This makes it possible to change the password for each of the image capture venue.

Moreover, in the foregoing description, the password is set in accordance with the entry of the user. In this case, a password is set per user, thereby enhancing the security. However, a fixed password may be used per image output apparatus 200. In this case, each of the image output apparatuses 200 stores a password in advance, together with the output machine ID. The ID accepting section 110 in this case acquires the fixed password together with the output machine ID, from the image output apparatus 200.

Alternatively, the ID accepting section 110 can acquire just the output machine ID, and the password may be informed to the user by a different method. For example, an administrator of the image output apparatus 200 can notify the user of the password separately by e-mail or the like. In this case, the pass code setting section 112 sets a password in accordance with an entry by a user.

(9-5) Deletion of Pass Code

The pass code set by the pass code setting section 112 and stored in the storage section 108 can be deleted from the storage section 108 after completion of transmitting the captured image data.

For example, the control section 109 can delete the pass code transmitted from the storage section 108 at a point in which the transmission process of the captured image data and pass code has completed.

Alternatively, the pass code can be deleted at a point in time when the image output process of the image output apparatus 200 is completed. More specifically, the control section 212 of the image output apparatus 200 causes, at a point in time when the image output process is completed, the display section 205 to display a screen urging entry of information indicating whether or not the image output process has been carried out without any problem. Thereafter, once information that the image output process has been carried out without any problem is entered into the input section 206, the control section 212 controls the first communication section 207 so that this information is transmitted to the portable terminal apparatus 100. For example, the first communication section 207 has the information be included in the body of an e-mail addressed to an e-mail address of the portable terminal apparatus 100 registered beforehand, and transmits the e-mail to the portable terminal apparatus 100. Thereafter, after receiving from the image output apparatus 200 that the image output process has been carried out without any problem, the control section 109 of the portable terminal apparatus 100 can delete the pass code transmitted from the storage section 108.

(9-6) Encoding Method

In the foregoing description, the encoding section 103b carries out the shuffling process as the encoding process. However, the encoding section 103b can encode (encrypt) the captured image data by a different method. For example, the encoding section 103b can carry out encryption by use of a common key, or can carry out encryption by use of a public key. The following description explains a specific modification.

(9-6-1) Example Using Common Key

First described is a general encryption method that uses a common key. With this encryption method, a common key used commonly between the transmitter and receiver is determined in advance. Various methods are available as encryption methods that use the common key. One example is described using a method of “sliding by three characters”. In a case where data (plaintext) to be originally conveyed is a text string of “ABC”, an encoding process is carried out to prepare a text string of “DEF”, which slides the original data by three characters in alphabetical order. Thereafter, such prepared data is transmitted. The receiver restores the original data “ABC” by carrying out a process of sliding the received data “DEF” back by three characters, as a decoding process. In this case, the part of “three characters” correspond to the key, an algorithm of the encryption process is “to slide the text string by three characters in alphabetical order”, and an algorithm of the decoding process is “to slide the text string by three characters going backwards in alphabetical order”. As a result, although the original text string to be conveyed is “ABC”, the text string is transmitted in a state “DEF” in which the text string are slid by three characters in alphabetical order. Therefore, even in a case where a third party is successful in intercepting the data, the text string intercepted is “DEF”, and unless the third party knows the algorithm of the decoding process, it is impossible to obtain the correct text string of “ABC”. Meanwhile, a proper receiver is capable of obtaining the original text string “ABC” by use of the common key (information of “three characters”) and the algorithm of “to slide the characters by three characters backwards in alphabetical order”.

The following description deals with a specific example using a common key for encoding the captured image data.

In the present specific example, the portable terminal apparatus 100 and the image output apparatus 200 store a common key “3” as a common code, in advance. Moreover, the storage section 108 of the portable terminal apparatus 100 stores encoding information indicative of adding three (3), in such a manner that the encoding information is associated with the common key “3”. Meanwhile, the storage section 210 of the image output apparatus 200 stores decoding information indicative of subtracting three (3), in such a manner that the decoding information is associated with the common key “3”.

The encoding section 103b, in accordance with the encoding information, carries out an encoding process of adding “3” to density values of pixels (hereinafter referred to as pixel value) of the captured image data. Namely, pixel values in a range of 0 to 252 are replaced with numbers in a range of 3 to 255 by adding “3” to the pixel value; if the inputted image data is 253, the pixel value is replaced by 0, if the inputted image data is 254 then the pixel value is replaced by 1, and if the inputted image data is 255 then the pixel value is replaced by 2, where each of pixel values are made up of 8-bit data and is represented by numbers in a range of 0 to 255. This allows the encoding section 103b to carry out the encoding process. For example, in a case where values of “R, G, B” of a pixel are “2, 200, 255”, respectively, the encoding section 103b converts the “R, G, B” values to “5, 203, 2”, respectively. Such a process is carried out to all pixels. Thereafter, the communication section 104 transmits the captured image data which has been subjected to the encoding process for all pixels, together with the common key “3” and the output machine ID.

On the other hand, in the image output apparatus 200, the certifying section 203 carries out a certification process of the output machine ID. In the case where the certification is successful, the decoding section 222 specifies the decoding information that corresponds to the common key “3”. Thereafter, the decoding section 222 carries out the decoding process of the captured image data, by use of the decoding information. More specifically, in a case where the “R, G, B” values of a pixel is “5, 203, 2”, respectively, the decoding section 222 can restore the pixel value “2, 200, 255” by subtracting “3” from the pixel value.

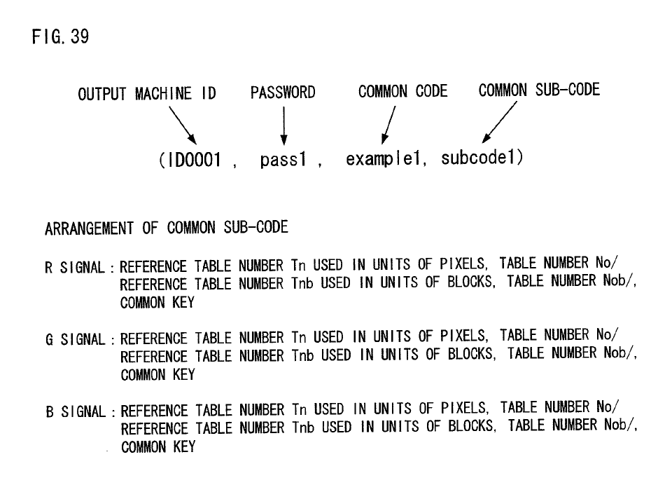

The method using the common key and the shuffling method can be used in combination. For example, the pixel value can be encoded by use of the common key and also by the shuffling method. As the shuffling method, any one of the shuffling methods a to e in (9-1) may be used. In this case, a pass code as shown in FIG. 39 is used. That is to say, the common sub-code includes, per plane of R, G, and B, the number Tn of reference data tables to be used in the shuffling in units of pixels and its table numbers No, the number Tnb of reference data tables to be used in the shuffling in units of blocks and its table numbers Nob, and a common key. The Tn, No, Tnb, Nob, and common key are set per plane of R, G, and B.

In the embodiment, Tn, No, Tnb, and Nob are information that identify the shuffling method, which shuffling method is one method of encoding, and the common key is information for identifying an encryption system by use of the common key, which system is one method of encoding. A common sub-code including the two information that identify the two encoding methods can be said as information (fourth identification information) for identifying a plurality of methods of encoding that the encoding section 103b has carried out.

Note that since the pixel value is encoded by use of the common key, it is possible to omit the shuffling process in units of pixel. In other words, after the pixel value is encoded by use of the common key, shuffling process is carried out in units of blocks. In this case, the Tn and No can be set as blank values.

Moreover, encoding process can be carried out as follows: any one of the signals of R, G, and B (e.g., R signal) is subjected to just the encoding process using the common key; another signal (e.g., G signal) is subjected to just the shuffling process; and yet another signal (e.g., B signal) is subjected to a process combining the shuffling process and the encoding process using the common key. As such, how the encoding process is carried out can be changed per plane of the R, G, and B.

(9-6-2) Example Using Public Key

In a case where encoding (encryption) is carried out by use of a public key, the transmitter encrypts the data by use of the public key, and the receiver decodes the data by use of a secret key corresponding to the public key. That is to say, the data encrypted by use of the public key is decodable just by a secret key that corresponds to the public key. An example of a specific encryption method is the generally known RSA (Rivest Shamir Adelman).

The following description explains a specific example of encoding by use of the public key for encoding the captured image data.

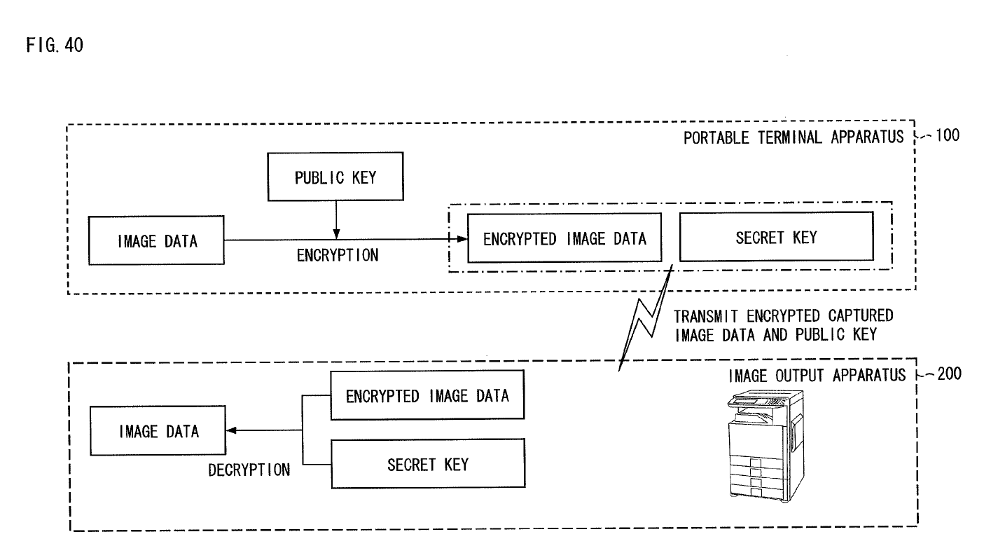

In the present specific example, as illustrated in FIG. 40, the portable terminal apparatus 100 stores the public key as encoding information. On the other hand, the image output apparatus 200 stores the public key stored in the portable terminal apparatus 100 and a secret key (decoding information) corresponding to the public key in such a manner that the public key and the secret key correspond to each other. The portable terminal apparatus 100 stores the public key in the storage section 108 by obtaining the public key from the image output apparatus 200 in advance.

The encoding section 103b encrypts the captured image data by use of the public key. Thereafter, the communication section 104 transmits the encoded captured image data, the public key, and the output machine ID, to the image output apparatus 200.

On the other hand, in the image output apparatus 200 that receives the captured image data, the public key, and the output machine ID, the certifying section 203 carries out the certification process of the output machine ID, and in the case where the certification is successful, a secret key corresponding to the public key received by the decoding section 222 is read out from the storage section 210. Thereafter, the decoding section 222 carries out a decoding process of the captured image data by use of the secret key read out. In this specific example, the public key is transmitted as a common code for specifying the secret key.

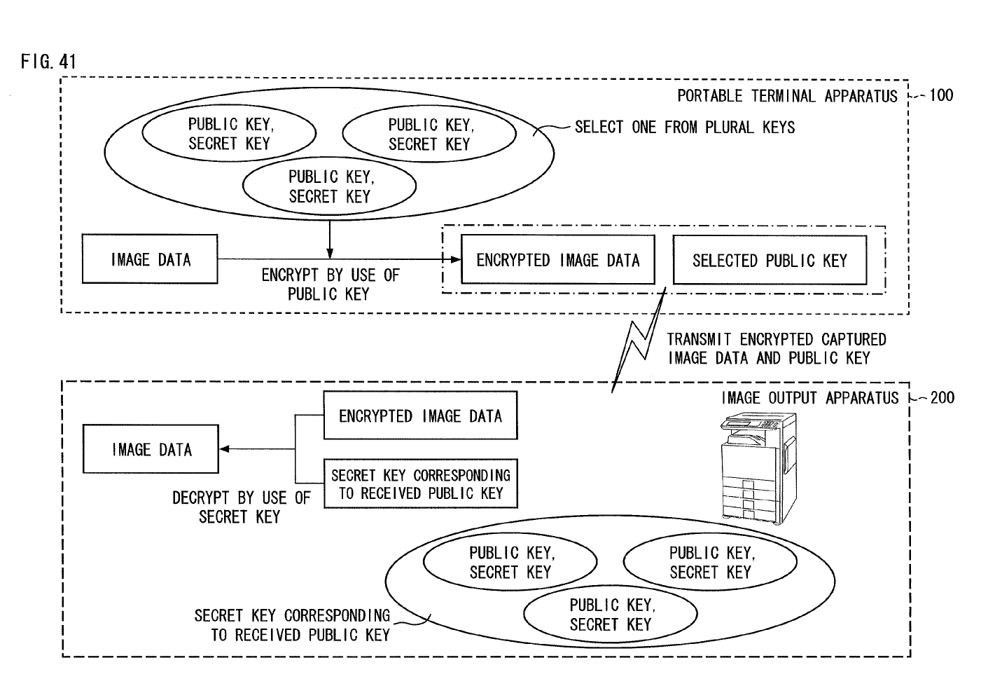

In the specific example illustrated in FIG. 40, each of the portable terminal apparatus 100 and the image output apparatus 200 stores one public key and one secret key. However, as illustrated in FIG. 41, the portable terminal apparatus 100 and the image output apparatus 200 can store a plurality of public keys and secret keys. In this case, the encoding section 103b encrypts the captured image data by use of a public key selected randomly or based on an entry of a user among the plurality of public keys stored in the storage section 108. Thereafter, the communication section 104 transmits the encrypted captured image data, the public key, and the output machine ID to the image output apparatus 200.

Meanwhile, in the image output apparatus 200 which receives the captured image data, the public key, and the output machine ID, the certifying section 203 carries out a certifying process of the output machine ID. In the case where the certification is successful, the decoding section 222 specifies a secret key that corresponds to the received public key among those stored in the storage section 210. Thereafter, the decoding section 222 carries out the decoding process of the captured image data by use of the specified secret key.

Moreover, pairs of the secret key and the public key are stored in the storage section 210 of the image output apparatus 200 in advance, when distributing the image output apparatus 200. Alternatively, the image output apparatus 200 can obtain a secret key from a server apparatus.

Moreover, as illustrated in FIG. 41, in a case where the portable terminal apparatus 100 stores a plurality of public keys, the encoding section 103b can carry out the encryption by use of a different public key per data of color components of R, G, and B of the captured image data. In this case, a common code including information associating (i) each of the color components of R, G, and B with (ii) the public keys used to encode the respective color components of R, G, and B is transmitted to the image output apparatus 200 together with the captured image data. Thereafter, the decoding section 222 of the image output apparatus 200 carries out decoding by use of a secret key corresponding to the public key used for the respective color component. This further enhances the security.

(9-7) Text Image Capture Mode

The portable terminal apparatus 100 is carried with a user, and is considered to be used to carry out image capture of an object in various scenes. Particularly, an example of a scene in which its image would preferably be outputted from the image output apparatus 200 later on is a scene in which image capture is carried out with respect to an image capture object having a rectangular shape such as (a) paper or a poster on which a text image is printed or (b) a display screen on which a text image is displayed (e.g., a display screen and a screen projected by a projector). In the embodiment, as one of an image output mode, the portable terminal apparatus 100 can have a text image capture mode which (i) carries out image capture with respect to an image capture object having a rectangular shape on which image capture object includes a text image and (ii) a captured image is outputted from the image output apparatus 200. Described below are details of the text image capture mode. The following description explains just the unique arrangements of the text image capture mode; since the text image capture mode is one type of the image output mode, the foregoing encoding/decoding processes are also carried out in the text image capture mode.

It is not always possible for the user to carry out image capture from the front with respect to the image capture object which has a rectangular shape such as (a) paper or a poster on which a text image is printed or (b) a display screen on which the text image is displayed. Namely the user may obliquely carry out image capture with respect to the image capture object, in a state where (i) a normal direction of a plane of the image capture object on which plane the text image is formed and (ii) a direction in which image capture means carries out the image capture do not coincide with each other. In this case, the image capture object undergoes a distortion (hereinafter referred to as a geometric distortion) in the captured image. Therefore, it is preferable that in the case where the text image capture mode is selected, the image output apparatus 200 outputs an image that also has such a geometric distortion corrected.

Moreover, even if the user is capable of carrying out image capture with respect to the rectangular-shaped image capture object from its front, there are cases where the image capture object skews with respect to a frame of the captured image. Hence, in a case where the text image capture mode is selected, the image output apparatus 200 preferably outputs the captured image in a state that such a skew is also corrected.

Furthermore, an image that is captured by the portable terminal apparatus 100 usually has a low resolution, and in a case where the image is outputted (e.g., printed) from the image output apparatus 200 with the resolution at the time of image capture, fine parts may not be recognized. Particularly, in a case where a paper or poster on which a text image (character or the like) is printed or a display screen on which a text image is displayed is image captured, the characters may not be distinguishable. Hence, an image is preferably outputted from the image output apparatus 200 after the captured image obtained by capturing an image by use of the portable terminal apparatus 100 is subject to the high resolution correction.

Examples of how the high resolution correction is carried out include a method disclosed in Journal of the Institute of Image Information and Television Engineers, Vol. 62, No. 3, pp. 337-342 (2008), which method uses a plurality of pieces of captured image data, and also includes a method disclosed in Journal of the Institute of Image Information and Television Engineers, Vol. 62, No. 2, pp. 181-189 (2008), which method uses one captured image data. Any of these methods are usable. First described is an embodiment of a text image capture mode which carries out high resolution correction by use of a plurality of pieces of captured image data, while also carrying out correction of geometric distortion and skew.

(9-7-1) Number of Times of Image Capture

In a case where the text image capture mode is selected by the user, a single shutter click causes the image capture section 101 to consecutively carry out, more than once (e.g., 2 to 15 times), image capture with respect to the image capture object. Images consecutively captured are generally substantially identical, but will be offset by a minutely small amount due to a camera shake or the like.

In a case where the text image capture mode is selected, the control section 109 of the portable terminal apparatus 100 causes the display section 105 to display a window which urges the user to enter a magnification of resolution conversion. Subsequently, the control section 109 determines, in accordance with the magnification (e.g., ×2 or ×4) entered from the input section 106, the number of consecutive times of image capture carried out by the image capture section 101.

In the following description, image data that indicates a respective one of the plurality of pieces of captured images obtained by the consecutive image capture by the image capture section 101 upon the single shutter click, is referred to as sub-captured image data. Moreover, a set of a plurality of the sub-captured image data, which set is obtained by the consecutive image capture with the image capture section 101 upon the single shutter click, is referred to simply as captured image data. Based on the plurality of pieces of sub-captured image data obtained by capturing an image with respect to a same object, the image output apparatus 200 is capable of carrying out a high resolution correction with use of a technique disclosed in the Journal of the Institute of Image Information and Television Engineers Vol. 62, No. 3, pp. 337 through 342 (published in 2008).

(9-7-2) Process of Captured Image Determination Section

The following description explains a unique process of the captured image determination section 102 in the case where the text image capture mode is selected. Note that the determination described in the foregoing (3) may also be carried out together with this process.

In the case where the text image capture mode is selected, the control section 109 of the portable terminal apparatus 100, as described above, causes the display section 105 to display a screen that urges the user to enter a magnification of a resolution conversion. Thereafter, in accordance with the magnification (e.g., ×2 or ×4) entered into the input section 106, the control section 109 determines one part of process execution requirements used in the captured image determination section 102. This one part of the process execution requirements is described in the following (9-7-2-3).

(9-7-2-1) Determination of Skew

As described earlier, the user selects the text image capture mode in a case where the user carries out image capture with respect to the image capture object, which has a rectangular shape, such as paper, a poster, or a display screen and desires to obtain a high resolution image. Therefore, the captured image determination section 102 assumes that the image capture object has a rectangular shape, and detects, in the captured image data, a skew of the image capture object by detecting an edge of the image capture object. Note that a conventionally known method can be employed as a method for detecting, in the captured image data, a pixel located on the edge of the image capture object which has a rectangular shape. In order to prevent a background edge from being erroneously determined to be the edge of the image capture object, it is alternatively possible to employ a method in which it is determined that an edge of the image capture object is detected only in a case where an edge having a length of not less than a given length is detected. In this case, the given length can be set, for example, to a length which is approximately 80% of a length of an end side of an image in the captured image data. Alternatively, it is also possible to cause the user to select the edge of the image capture object from the edges detected. It is possible to employ, as such an edge detection method, a technique disclosed in Japanese Patent Application Publication, Tokukai, No. 2006-237757 A.

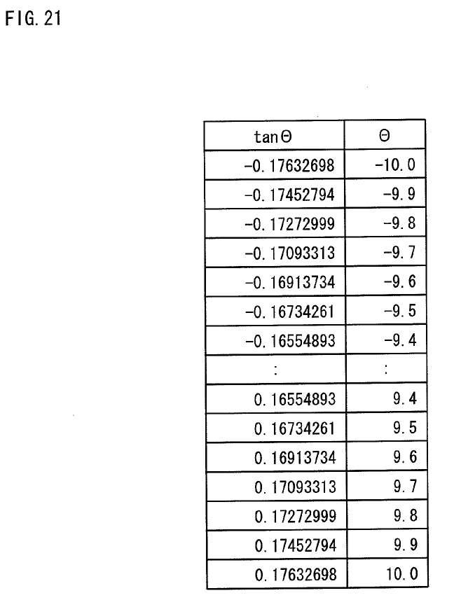

The captured image determination section 102 selects two points located on the detected edge of the image capture object. For example, the captured image determination section 102 selects two points 11 and 12 which are away from a center of the captured image data by w/2 in a transverse direction to the right and left, respectively (see FIG. 20). Next, it is possible to determine a skew of the image capture object in the captured image by determining shortest distances d₁ and d₂ between an end side of the captured image data and the respective selected two points 11 and 12. In the case of FIG. 20, when an angle of the skew is indicated as θ, tan θ=(d₂−d₁)/w. Then, the captured image determination section 102 calculates a value of (d₂−d₁)/w and reads out a corresponding angle θ, for example, from a table (refer to FIG. 21) which is prepared in advance.

Subsequently, the captured image determination section 102 determines whether or not the detected angle θ falls within a given range (e.g., −30° to)+30° and supplies a determined result to the control section 109. Note here that it is one of the process execution requirements that the angle θ falls within the given range.

As described above, a plurality of pieces of sub-captured image data is obtained by carrying out capturing of an image a plurality of times by the image capture section 101 upon a single shutter click. However, the plurality of pieces of sub-captured image data are only offset by an amount of a camera shake. Hence, the captured image determination section 102 just requires determining the skew of one sub-captured image data arbitrary selected from the plurality of pieces of sub-captured image data (e.g., sub-captured image data obtained first in the image capture).

Thereafter, in a case where a determined result that an angle of the skew θ falls outside the given range is received from the captured image determination section 102, the control section 109 controls the display section 105 to display a message which urges image capture to be carried out again so that the image capture object is not skewed.

(9-7-2-2) Determination of Geometric Distortion

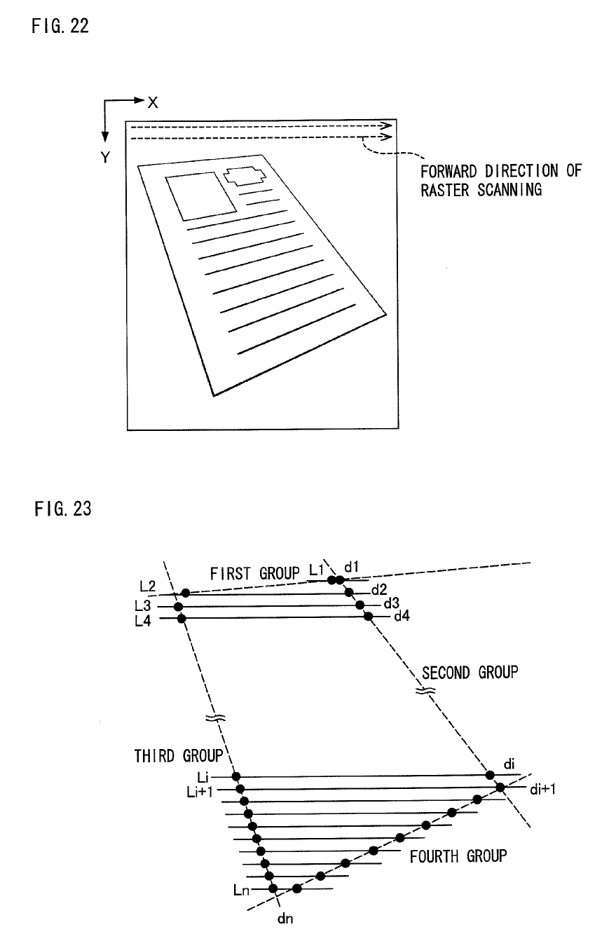

As described earlier, the geometric distortion means that in a case where image capture is obliquely carried out with respect to the image capture object from a direction different from the normal direction of the plane of the image capture object on which plane the text image is formed, the image capture object has, in the captured image, a distorted shape instead of the rectangular shape. For example, in a case where image capture is carried out with respect to the image capture object obliquely, i.e., from a lower left direction with respect to a normal direction of the paper, the image capture object has a distorted quadrangular shape (see FIG. 22).

As described later, in the text image capture mode, the image output apparatus 200 has a function of correcting such a geometric distortion. Note, however, that in a case where the geometric distortion occurs to a large degree, readability will not be so enhanced even if the geometric distortion is corrected. In view of this, the captured image determination section 102 detects features indicative of a degree of the geometric distortion so as to determine whether or not the features fall within a given range.

As described above, a plurality of pieces of sub-captured image data is obtained by carrying out capturing of an image a plurality of times by the image capture section 101 upon a single shutter click. However, the plurality of pieces of sub-captured image data are only offset by an amount of a camera shake. Hence, the captured image determination section 102 just requires determining the geometric distortion as described below of one sub-captured image data arbitrary selected from the plurality of pieces of sub-captured image data.

First, the captured image determination section 102 carries out a raster scanning with respect to the sub-captured image data. Note here that (i) a forward direction and (ii) a direction which is perpendicular to the forward direction are an X direction and a Y direction, respectively (see FIG. 22). Note also that an upper left corner is an origin in the captured image.

In a case where no edge is detected as a result of the scanning carried out with respect to one (1) line, the captured image determination section 102 carries out the scanning with respect to a subsequent line which is away from the one line by a predetermined distance in the Y direction. Note that an interval between the lines is not limited to a specific one, provided that it is a fixed one. Further, the line is not necessarily constituted by a single pixel.

Next, in the raster scanning, the captured image determination section 102 regards, as L₁ (a first line), a line on which an edge is firstly detected. The captured image determination section 102 classifies, into a first group, coordinates of a point determined to be the first edge in the forward direction, and then classifies, into a second group, coordinates of a point determined to be the second edge on the first line (see FIG. 23). The scanning is consecutively carried out with respect to a subsequent line so that an edge is detected. Then, with respect to each line Lᵢ, a difference in X-coordinate value between (a) a point firstly determined to be an edge of the image capture object in the forward direction and (b) a point secondly determined to be an edge of the image capture object in the forward direction (a distance dᵢ between X-coordinates of the two points) is calculated, and then an edge determination is carried out as below.

It is assumed that the X-coordinate of the first edge on the line Lᵢ is Xᵢ₁ (the X-coordinate belonging to the first group) and the X-coordinate of the second edge on the line Lᵢ is Xᵢ₂ (the X-coordinate belonging to the second group). The features detection method is carried out as below.

(a) Coordinates X₁₁ and X₁₂ on the first line (L₁) are invariable.

(b) As for an ith line (i is an integer of not less than 2), an intercoordinate distance dᵢ₁ (=Xᵢ₁−X₍ᵢ₋₁₎₁) and dᵢ₂ (=Xᵢ₂−X₍ᵢ₋₁₎₂) are calculated. Note that the following description discusses dᵢ₁, and so omits a suffix 1. Same applies to die.

(c) As for an ith line (i is an integer of not less than 3), ddᵢ=abs {(dᵢ)−dᵢ₋₁} is calculated. In a case where ddᵢ≦th₁ (≈ a small value close to 0 (zero)), a coordinate X₁ is classified into an identical group (the first group or the second group). Otherwise (in a case where ddᵢ>th₁), the coordinate X₁ is classified into a different group (a third group or a fourth group).

(d) Only in a case where i=4, a process for deciding a group of X₂ is carried out as an initial process. The process is carried out as below.

i) dd₃≦th₁ and dd₄≦thᵢ→X₂: identical group

ii) dd₃>th₁ and dd₄≦th₁→X₂: different group

iii) dd₃≦th₁ and dd₄>th₁→X₂: identical group

iv) dd₃>th₁ and dd₄>th₁→X₂: identical group

Once a transition of X₂ to the different group (the third group or the fourth group) occurs, it is unnecessary to check increase and decrease in ddᵢ.

Such a process is carried out with respect to an entire image so that edge points are extracted for each of the groups. Then, coordinates of the edge points which belong to each of the groups are subjected to linearization by use of a method such as a method of least squares or the like. This allows a straight line, which is approximate to the edge points which belong to each of the groups, to be estimated. The lines correspond to the sides of the image capture object.

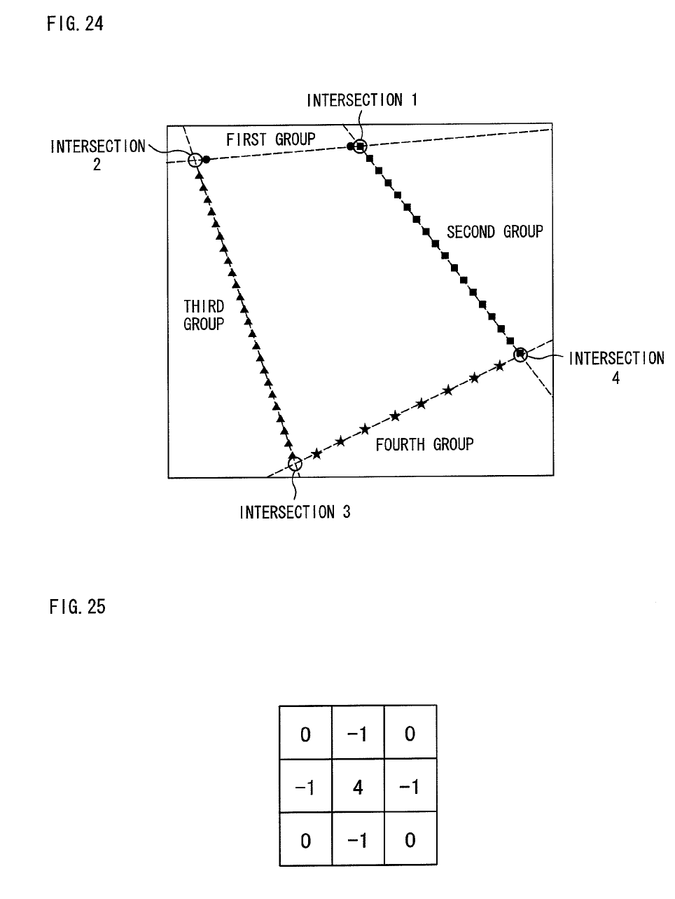

FIG. 24 is a drawing illustrating a case where edge points are extracted by the raster scanning in accordance with a process as mentioned above and classified into the four groups. Note, in FIG. 24, that a circle indicates an edge which belongs to the first group, a quadrangle indicates an edge which belongs to the second group, a triangle indicates an edge which belongs to the third group, and a star indicates an edge which belongs to the fourth group. Note also in FIG. 24 that straight lines, which have been subjected to the linearization by use of the method of least squares so as to be approximate to the edge points for each of the groups, are illustrated by respective dotted lines.

Then, intersections (intersections 1 through 4 illustrated in FIG. 24) of the straight lines for the respective four groups are found. This makes it possible to define a region surrounded by the four straight lines as a region where the image capture object is located.

Further, a classifying process as mentioned above can be carried out with respect to an image which has been subjected to a 90-degree rotation. This also allows an extraction of edges of a document which is ideally provided so as to be parallel to a horizontal direction and a vertical direction of the image. Namely, the raster scanning allows a detection of an edge in the vertical direction in the image which has not been rotated. In contrast, the raster scanning allows a detection of an edge which was in the horizontal direction before the image was rotated (which is in the vertical direction after the image is rotated) in the image which has been rotated. This also allows an extraction of edges which are parallel to the vertical direction and the horizontal direction. As long as a sufficient amount of information is obtained (for example, not less than three intersections are obtained in each of the groups) before the rotation of the image, just this information can be used. In contrast, in a case where the number of intersections obtained is less than one in any one of the groups, it is obviously impossible to formulate a straight line. In such a case, intersections obtained after the rotation of the image can be used.

Alternatively, it is also possible to formulate a straight line by (i) carrying out again a coordinate conversion with respect only to found coordinates of an intersection, (ii) obtaining a corresponding group from regions in which the respective groups are distributed, and (iii) integrating information on the intersections. Namely, the straight line can be formulated by integrating coordinates of intersections, which belong to an identical group, out of (i) coordinates of intersections which coordinates are found by the image which has not been rotated and (ii) coordinates of intersections which coordinates are found by carrying out a coordinate conversion with respect to intersections found by the image which has been rotated.

Note that it is possible to extract an edge point in accordance with the following method. Pixel values, obtained in a small window which has a width of at least one pixel, are compared as they are (a sum or an averages of the pixel values are compared in a case where the width is not less than two pixels). In a case where pixel values of adjacent windows have a difference of not less than a given value, an edge point can be determined. In order to prevent a background edge or an edge of a text included in the image capture object from being erroneously determined to be the edge of the image capture object, it is alternatively possible to employ a method in which it is determined that an edge of the image capture object is detected only in a case where an edge having a length of not less than a given length is detected. In this case, the given length can be set, for example, to a length which is approximately 80% of a length of an end side of an image in the sub-captured image data. Alternatively, it is also possible to cause the user to select the edge of the image capture object from the edges detected. It is possible to employ, as such an edge detection method, a technique disclosed in Japanese Patent Application Publication, Tokukai, No. 2006-237757 A. Alternatively, it is also possible to prevent such an erroneous detection by carrying out an evaluation of each of the coordinate groups or a process for detecting a line segment (e.g., a Hough transformation). Further, it is possible to prevent an edge of a text or a fine texture from being erroneously detected by carrying out a process employing a reduced image as preprocessing.

After finding the four straight lines and their intersections, the captured image determination section 102 calculates each ratio between lengths of opposite sides of the quadrangle defined by the four straight lines. The each ratio between the lengths can be easily calculated by use of the coordinates of the intersections. Note that the quadrangle has two pairs of the opposite sides and thus the captured image determination section 102 calculates a ratio between lengths for each of the two pairs.

Note here that the ratio between the lengths of the opposite sides is equal to 1 (one to one) in a case where image capture is carried out, from the front, with respect to the image capture object which has a rectangular shape, the image capture object included in the captured image also has a rectangular shape. In contrast, in a case where image capture is obliquely carried out with respect to the image capture object which has a rectangular shape, the ratio becomes a value different from 1. This is because the image capture object included in the captured image has a distorted quadrangular shape. As a direction in which image capture is carried out is at a greater angle to the normal direction of the plane of the image capture object on which plane the text image is formed, a difference between a value of the ratio and 1 increases. It follows that the ratio between the lengths of the opposite sides is one of the features indicative of a degree of the geometric distortion.

Then, the captured image determination section 102 determines whether or not each of the two ratios that has been calculated falls within a given range (e.g., 0.5 to 2) and supplies a determined result to the control section 109. Note here that the given range is set in advance so that a geometric distortion correction can be made by the image output apparatus 200, and is stored in the storage section 108. Note also that it is one of the process execution requirements that each of the two ratios falls within the given range (e.g., 0.5 to 2).

Note that the captured image determination section 102 can use, as alternative features indicative of the degree of the geometric distortion, an angle formed by two selected straight lines through which any two adjacent intersections of the four intersections pass, which four intersections are the intersections detected as above.

In response to a determined result that features indicative of a degree of the geometric distortion (here, a ratio between the lengths of the opposite sides of the image capture object in the captured image) falls outside the given range, the control section 109 controls the display section 105 to display a message which urges image capture to be carried out again from the normal direction of the plane of the image capture object on which plane the text image is formed.

(9-7-2-3) Determination of Offset Amount of a Plurality of Images

As described earlier, the image output apparatus 200 carries out the high resolution correction in accordance with the plurality of pieces of sub-captured image data of the identical image capture object. In order to carry out the high resolution correction, it is necessary that a given number of pieces of image data which varies depending on the magnification of resolution conversion be offset by a given amount. In view of this, the captured image determination section 102 of the present embodiment determines whether or not the plurality of pieces of sub-captured image data (data of the images captured by the image capture section 101) include a given number of pieces of the sub-captured image data which are required to carry out the high resolution correction and which are offset by a given amount.

Note that an offset, required for the high resolution correction which allows enhancement of text readability, intends an offset of less than one pixel (a decimal point) of target image data. Namely, an offset, which is below the decimal point (less than one pixel) such as that falls in a range of 0.3 to 0.7, is important. An offset corresponding to an integer part is not considered during the high resolution correction. For example, in the case of an offset corresponding to 1.3 pixel, 2.3 pixels, or the like each including an offset of less than one pixel, it is possible to carry out the high resolution correction in accordance with a plurality of images. In contrast, in the case of an offset of one pixel, two pixels, or the like each including no offset of less than one pixel, it is impossible to carry out the high resolution correction.

For example, in the case of a conversion magnification of ×2, the number of pieces of image data which is required for the high resolution correction is two (2). An offset amount of the decimal point of the two pieces of image data preferably falls in a range of 0.3 to 0.7, each of which is a result obtained when the offset is represented by a pixel. Therefore, information in which (i) a magnification of the resolution conversion “×2”, (ii) the number of times of image capture “2”, and (iii) a process execution requirement “required number of pieces of image data: 2, offset amount: 0.3 to 0.7” are associated with each other is stored beforehand in the storage section 108. In accordance with the information, the control section 109 controls (i) the image capture section 101 to carry out image capture two consecutive times and (ii) the captured image determination section 102 to carry out a determination in accordance with the process execution requirement “required number of pieces of image data: 2, offset amount: 0.3 to 0.7”.

In the case of a conversion magnification of ×4, the number of pieces of image data which is required for the high resolution correction is 4. In a case where one of the four pieces of data is assumed to be reference image data, amounts of offset of the decimal point of the other three pieces of image data with respect to the reference image data preferably fall in ranges of 0.2 to 0.3, 0.4 to 0.6, and 0.7 to 0.8, respectively, each of which is a result obtained when the offset is represented by a pixel. Therefore, information in which (i) a magnification of the resolution conversion “×4”, (ii) the number of times of image capture “4”, and (iii) a process execution requirement “required number of pieces of image data: 4, offset amount: 0.2 to 0.3, 0.4 to 0.6, and 0.7 to 0.8” are associated with each other is stored beforehand in the storage section 108.

Note that the following description discusses, for simplicity, a case in which the magnification of the resolution conversion “×2” is selected.

First, the captured image determination section 102 selects any one of the sub-captured images data. As for the selected sub-captured image data (hereinafter referred to as a first sub-captured image), the captured image determination section 102 selects an offset detecting partial region from the region which is defined during the determination of the geometric distortion and in which the image capture object is located. Note here that the offset detecting partial region is used so that offset amounts of the remaining sub-captured image data (hereinafter referred to as a second sub-captured image) with respect to the first sub-captured image are obtained. Therefore, it is preferable to select the offset detecting partial region in which there occurs a great change in pixel value (there exists a clear pattern). As such, the captured image determination section 102 extracts the offset detecting partial region in accordance with the following method.

The captured image determination section 102 specifies a pixel, serving as a target pixel, existing in a centroid of the region where the image capture object is located. Subsequently, the captured image determination section 102 selects a region where n×n pixels including the target pixel are provided. The captured image determination section 102 judges whether or not the selected region satisfies the following selection requirement. In a case where the selected region satisfies the selection requirement, the region becomes the offset detecting partial region. In contrast, in a case where the selected region does not satisfy the selection requirement, the captured image determination section 102 selects another region in accordance with a given offset and carries out an identical determination with respect to the another region. This is how the offset detecting partial region is extracted.

Note here that examples of the selection requirement include the following two requirements.

According to the first example of the selection requirement, a value which is based on a variance obtained in the region is used. A variance (x) obtained in the offset detecting partial region is expressed as the following expression (1), where P (i) is a pixel value of a region, in the vicinity of the target pixel, in which region n×n pixels are provided. The selection requirement is met when the variance (x) is not less than a given threshold. For simplicity, only a numerator of the expression (1) can be considered.

$$[ Math . 1 ]$$

$$Varience ( x ) = \frac{n \times {\sum }_{i = 0}^{n - 1} {[ P ( i ) ]}^{2} - {[ {\sum }_{i = 0}^{n - 1} P ( i ) ]}^{2}}{n \times n} \qquad expression ( 1 )$$

According to the second example of the selection requirement, binarization is carried out, by an edge extraction filter such as a first order differential filter, with respect to the region, in the vicinity of the target pixel, in which region n×n pixels are provided, and a sum total of binarized values is used. FIG. 25 shows an example of the first order differential filter. Similar to the first example of the selection requirement, the second selection requirement is met when the sum total is not less than a given threshold (e.g., not less than 5% of the number of pixels in the offset detecting partial region).

Next, in contrast to an offset detecting partial image A (n×n) of the first sub-captured image data, an offset detecting partial image B (m×m) (m>n) is cut out from the second sub-captured image data, the offset detecting partial image B having a center substantially identical to that of the offset detecting partial image A. The offset detecting partial image B is cut out so that coordinates of a central pixel of the offset detecting partial image A in the first sub-captured image data coincide with coordinates of a central pixel of the offset detecting partial image B in the second sub-captured image data.

Then, a region of the clipped offset detecting partial image B which region best matches the offset detecting partial image A is found with sub-pixel-level accuracy. This can be realized by employing a normalized correlation pattern matching in which the offset detecting partial image A serves as a template.

As an example of the normalized correlation pattern matching, a correlation is found by use of a well-known normalized correlation equation. A correlation equation of two patterns of Input (I) and Target (T) which include N pixels can be generally expressed as the following expression (2). Note here that α, β, and γ can be expressed as below.

[Math. 2]

S={α/\sqrt{β×γ}} expression (2)

[Math. 3]

α=NΣ(I×T)−(ΣI)×(ΣT)

β=NΣ(I×I)−(ΣI)×(ΣI)

γ=NΣ(T×T)−(ΣT)×(ΣT)

A correlation value map of 3×3 is obtained, in a case where, for example under the requirement of n=5 and m=7, the above correlation equation is calculated for each region (n×n) of the offset detecting partial image B (m×m), which each region has an identical size to the offset detecting partial image A. A fitting quadric surface is calculated by use of the correlation value map. The quadric surface is calculated based on an equation S (x, y)=a×x×x+b×x×y+c×y×y+d×x+e×y+f. Specifically, six points each of which has a higher correlation value are selected from nine points, and simultaneous equations are solved so that each coefficient is obtained. It is determined that the process execution requirement “required number of pieces of image data: 2, offset amount: 0.3 to 0.7” is met, in a case where values below the decimal point of coordinate values (both x and y) of an extreme value (=a maximum value) of the function S (x, y) fall within the given range (here, 0.3 to 0.7).

Note that an extreme value can be obtained by (i) carrying out partial differentiation with respect to the quadratic equation S (x, y), and then (ii) calculating coordinates of a point where a corresponding partial differential coefficient is 0 (zero). In this case, it is more efficient to directly use correlation values (S₁ to S₆) because it is actually unnecessary to obtain each of the coefficients (a to f). Expressions (3) to be solved are as follows. Note here that an origin serves as a target window standard.

$$[ Math . 4 ]$$

$$x = \frac{2 \times {S}_{3} \times {S}_{4} - {S}_{5} \times {S}_{2}}{{S}_{2}^{2} - 4 \times {S}_{1} \times {S}_{3}} \\ y = \frac{2 \times {S}_{1} \times {S}_{5} - {S}_{2} \times {S}_{4}}{{S}_{2}^{2} - 4 \times {S}_{1} \times {S}_{3}} \qquad expression ( 3 )$$

Note that such determination of positional offset by use of the sub-pixel-level accuracy is carried out in at least one region, desirably in several regions.

Then, the captured image determination section 102 supplies a determined result as to whether or not the process execution requirements are met.

In response to a determined result that the number of sub-captured image data which are offset by a given amount falls below a given number, the control section 109 controls the display section 105 to display a message, urging image capture to be carried out again, such as “This image may not be well processed. Please carry out image capture again.” so that a new image is obtained. Then, the captured image determination section 102 carries out the determination processes with respect to a combination of newly captured plurality of pieces of sub-captured image data, or alternatively, a combination of the images previously captured and images recaptured.

(9-7-3) Arrangement of Image Processing of Image Output Apparatus

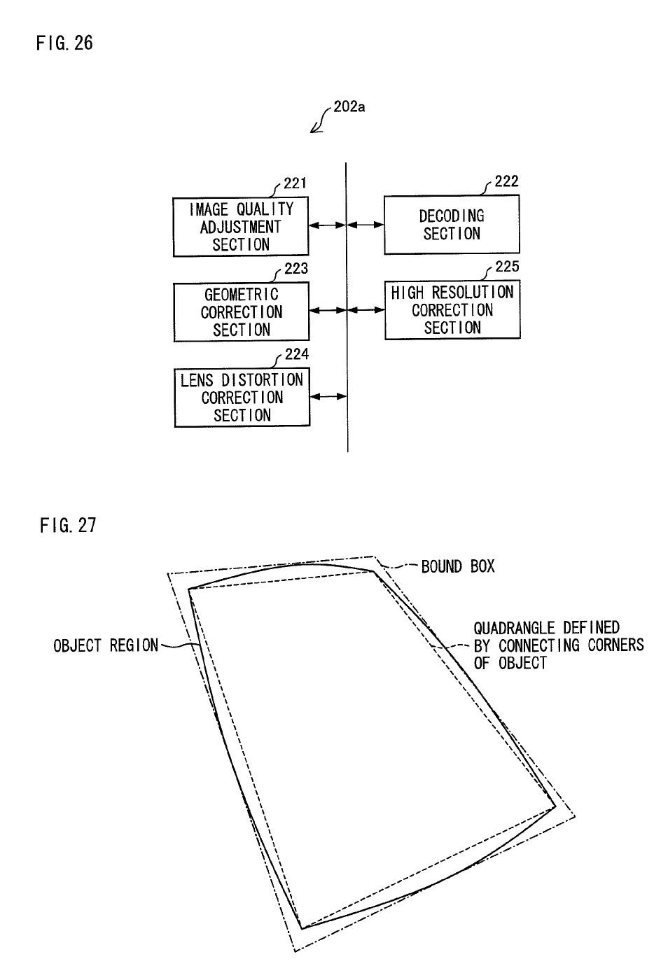

An image output apparatus which receives the captured image data that is image captured in the text image capture mode includes, instead of the image processing section 202 illustrated in FIG. 12, an image processing section 202a illustrated in FIG. 26. FIG. 26 is a view illustrating an inner arrangement of the image processing section 202a. As illustrated in FIG. 26, the image processing section 202a additionally includes, as compared to the image processing section 202, a geometric correction section 223, a lens distortion correction section 224, and a high resolution correction section 225. The following description describes specific processing details of each of these sections one by one. The geometric correction section 223, lens distortion correction section 224, and high resolution correction section 225 each carry out processes to the captured image data (a plurality of pieces of sub-captured image data) which has been decoded by the decoding section 222.

(9-7-3-1) Lens Distortion Correction Section

Like the captured image determination section 102, the lens distortion correction section 224 sequentially detects, by the raster scanning, points on an edge of the image capture object in the captured image. Then, the lens distortion correction section 224 carries out a curve fitting with respect to the points detected on the edge, and carries out the lens distortion correction based on a curvilineal expression.

In detail, the lens distortion correction section 224 detects the edge points of the detected image capture object and classifies, like the captured image determination section 102, the edge points into four groups which correspond to four sides of the image capture object. Subsequently, as illustrated by the solid lines in FIG. 27, the lens distortion correction section 224 carries out a quadratic curve approximation with respect to the edge points which belong to each of the four groups. Four quadratic curves determined with respect to the respective four groups correspond to the respective four sides of the image capture object. In addition, the lens distortion correction section 224 finds four intersections of the four quadratic curves which intersections correspond to corner sections of a region defined by the four quadratic curves. Next, the lens distortion correction section 224 finds a bound box (see one-dot chain lines in FIG. 27) in which the four quadratic curves determined for the respective four sides are circumscribed, and which is similar to a quadrangle (see dotted lines in FIG. 27) defined by connecting the four intersections. Then, the lens distortion correction section 224 carries out a transformation with respect to the location of pixels in a region where the image capture object is located in the captured image so that the edge pixels of the image capture object which has been corrected are located on the sides of the bound box. Such a transformation can be carried out by carrying out calculations in accordance with vectors from a reference point (e.g., the centroid of the region where the image capture object is located). This allows the lens distortion, due to the image capture section 101 of the portable terminal apparatus 100, to be corrected.

How the lens distortion is corrected is not limited to the foregoing method, and publicly known techniques may also be used.

(9-7-3-2) Geometric Correction Section

The geometric correction section 223 corrects distortion with respect to an image capture object in the sub-captured image data, which distortion is caused by carrying out image capture with respect to an image capture object having a rectangular shape such as a poster or document paper from a direction different from a planar normal direction from which the text image is formed (i.e., planar distortion of a rectangular shape on which a text image is formed), and corrects a skew of the image capture object in the sub-captured image data.

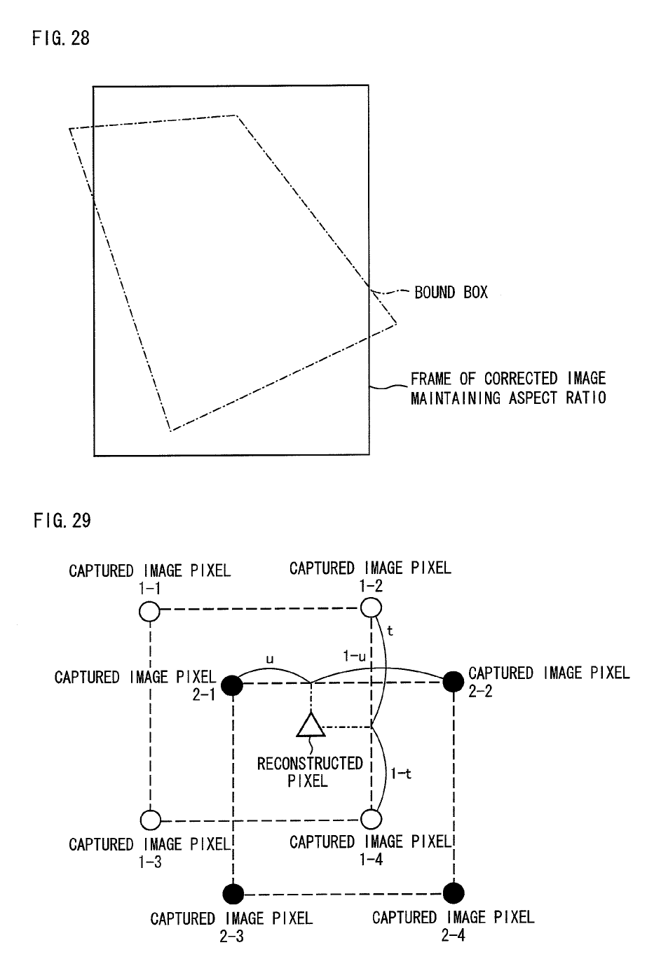

In detail, the geometric correction section 223 corrects geometric distortion and skew as described below. The geometric correction section 223, for example, can similarly carry out mapping transformation in such a manner that a bound box defined as above is set to match an aspect ratio of the object (e.g., if an A-size or B-size used in business documents, 7:10), as illustrated in FIG. 28. A publicly-known technique can be used as the mapping transformation. Note that the geometric correction section 223 can carry out the mapping transformation in accordance with an aspect ratio stored in the storage section 210 or an aspect ratio entered from the input section 206.

After the bound box is transformed to a set aspect ratio, the geometric correction section 223 detects a skew of the image capture object by the method described in (9-6-2-1), and carries out a rotation process of the sub-captured image data so that the skew becomes 0 degrees. As a result, sub-captured image data having a skew of 0 degrees is obtained, as illustrated by the solid lines in FIG. 28.

Note that methods for correction of geometric distortion is not limited to the above methods and that publicly-known techniques can be employed for the correction.

(9-7-3-3) High Resolution Correction Section

The high resolution correction section 225 carries out high resolution correction to the captured image data received from the portable terminal apparatus 100. In the present embodiment, the high resolution correction section 225 carries out the high resolution correction based on the plurality of sub-captured image data received from the portable terminal apparatus 100.

As for a method for forming a high resolution image in accordance with a plurality of pieces of image data, several methods are disclosed in the Journal of the Institute of Image Information and Television Engineers Vol. 62, No. 3, pp. 337 through 342 (published in 2008). Generally, the high resolution correction process includes a positioning process for a plurality of images and a reconstructing process. In the present embodiment, the normalized correlation pattern matching (see the description of (9-6-2-3)) is used as an example of a positioning process. Namely, it is possible to carry out the positioning for a plurality of images by displacing the plurality of images by an offset amount corresponding to an extreme value of the foregoing S (x, y).

Next, the high resolution correction section 225 carries out the reconstructing process. Namely, the high resolution correction section 225 prepares reconstructed image data whose number of pixels corresponds to a magnification obtained after the resolution conversion. Note, however, that a reconstructed image is assumed to have a size identical to that of the captured image. Then, the high resolution correction section 225 determines pixel values of respective pixels in the reconstructed image data. Namely, the high resolution correction section 225 selects, from the plurality of captured images, a plurality of pixels of the captured image (captured image pixels) located in the vicinity of each of the pixels (reconstructed pixels) in the reconstructed image data, and then carries out an interpolation with respect to the reconstructed pixel in accordance with a general interpolation method (e.g., a linear interpolation method and a bi-cubic interpolation method).

In detail, as illustrated in FIG. 29, captured image pixels located in the vicinity of a target reconstructed pixel are selected. For example, two captured image pixels, whose line segment (see the dotted lines in FIG. 29) is the closest to the target reconstructed pixel, are selected in each of transverse and longitudinal directions. Assume here that the two captured image pixels selected in the transverse direction are a captured image pixel 1-2 (pixel value: Vᵢ₁₋₂: pixel values of the following captured image pixels will be similarly indicated) of a first captured image and a captured image pixel 1-4 of the first captured image, whereas the two captured image pixels selected in the longitudinal direction are a captured image pixel 2-1 of a second captured image and a captured image pixel 2-2 of the second captured image. Note that it is assumed that the captured image pixels located in the vicinity of the reconstructed pixel are selected from the plurality of pieces of captured image data which have been subjected to the geometric distortion correction and the lens distortion correction. This makes it possible to carry out the high resolution correction in a state where the geometric distortion and the lens distortion have already been corrected.

Note that, a coordinate value obtained after the correction can be calculated by taking into consideration the geometric distortion correction and the lens distortion correction for the uncorrected plurality of pieces of captured image data. Namely, it is possible to (i) carry out the reconstruction process after only calculating correction values of the geometric distortion and the lens distortion, and then (ii) carry out the coordinate transformation by use of the correction values.

Subsequently, two intersections of (i) the line segments each of which is defined by the two points selected in the transverse and longitudinal directions and (ii) straight lines on each of which the target reconstructed pixel is located and each of which is perpendicular to a corresponding one of the line segments are found. In a case where the two intersections are internally dividing points of t:1-t and u:1-u on the respective two line segments (see FIG. 29), a pixel value Vₛ of the target reconstructed pixel is calculated in accordance with the following expression (4). It follows that the linear interpolation is carried out. Then, pixel values of all the reconstructed pixels are similarly calculated, so that it is possible to prepare reconstructed image data which has been subjected to the high resolution correction as high resolution image data.

[Math. 5]

V_{S}={(1−t)Vᵢ₁₋₂+tVᵢ₁₋₄+(1−u)Vᵢ₂₋₁+uVᵢ₂₋₂}/2 expression (4)

Note that an alternative interpolation method can be employed. Note also that a further method disclosed in the Journal of the Institute of Image Information and Television Engineers Vol. 62, No. 3, pp. 337 through 342 (published in 2008) can be employed. For example, it is possible to employ an interpolation method such as a MAP (Maximum A Posteriori) method in which an assessment function which corresponds to an assumptive posterior probability is first minimized so that the pixel values of all the reconstructed pixels are obtained.

Moreover, the embodiment in the foregoing description utilizes the offset generated between the plurality of captured images caused by the camera shake which occurs when the image capture section 101 consecutively carries out image capture a plurality of times. However, the present invention is not limited to this example, and the image capture section 101 can minutely slide an image sensor (CCD•CMOS) or lens at a time when the image capture section 101 consecutively carries out the image capture a plurality of times. As a result, offset is surely generated between the plurality of captured images.

(9-7-4) Modification of Number of Times of Image Capture

The foregoing (9-7-1) describes that in the portable terminal apparatus 100, the control section 109 causes the image capture section 101 to carry out image capture in order to obtain the number of captured images required for the high resolution correction. Namely, the control section 109 sets the number of times image capture is to be carried out to a same value as the required number of pieces of sub-captured image data in the process execution requirements. However, the control section 109 can set, as the number of times image capture is to be carried out, a value greater than the value of the required number of pieces of sub-captured image data for the high resolution correction. For example, in a case where magnification of the resolution conversion is ×2, the number of times image capture is to be carried out may be set as “3” while the required number is “2”.

In such a case where the number of times image capture is to be carried out is greater than the required number, the captured image determination section 102 determines whether or not pieces of sub-captured image data of the number of image capture include a pair of pieces of sub-captured image data that meet the process execution requirements. For example, in the case where the number of times image capture is to be carried out is “3” while the required number is “2”, there are three possible pairs of the required number of pieces of sub-captured image data that are combinable by use of the three pieces of sub-captured image data. In this case, the captured image determination section 102 successively determines whether or not the pairs meet the process execution requirements. At a point where a pair that meets the process execution requirements is detected, the captured image determination section 102 terminates the process, and the communication section 104 transmits to the image output apparatus 200 the sub-captured image data included in the determined pair. Alternatively, the captured image determination section 102 may determine whether or not the process execution requirements are met for all of the pairs. In this case, if a plurality of combinations meet the process execution requirements, the control section 109 can determine a pair having an offset amount closest to a median value of a given range as the combination to be transmitted to the image output apparatus 200. For example, in a case where the given range is 0.3 to 0.7, a pair having an offset amount closest to 0.5 is selected.

(9-7-5) Another Example of High Resolution Correction

According to the foregoing description, a high resolution reconstructed image data is prepared from a plurality of pieces of sub-captured image data. However, high resolution correction may be carried out based on not the plurality pieces of image data, but based on a single piece of image data.

As for a method for forming a high resolution image in accordance with a single piece of image data, several methods are disclosed in the Journal of the Institute of Image Information and Television Engineers Vol. 62, No. 2, pp. 181 through 189 (published in 2008).

Generally, it is possible to carry out the high resolution correction by (i) detecting a direction of an edge of an image pattern so as to carry out an interpolation in accordance with the direction of the edge and (ii) carrying out a de-noising process so as to remove at least (a) a distortion due to the interpolation and (b) an influence of a noise component existing in an inputted image. This is described below in detail.

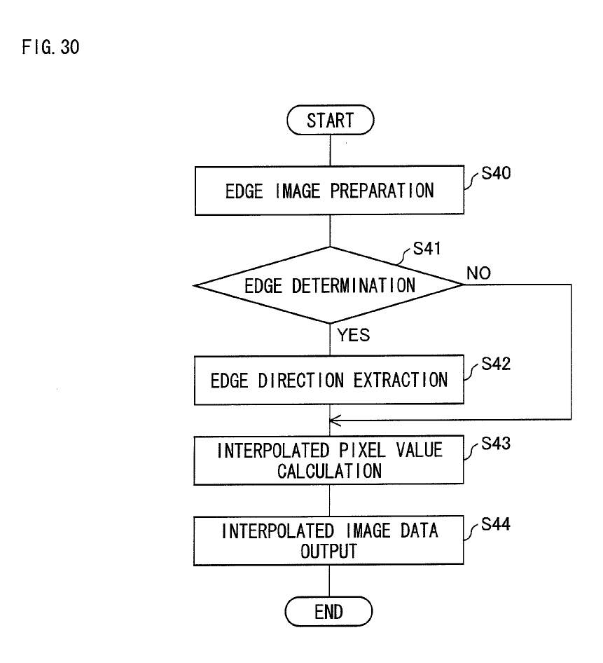

FIG. 30 is a flow chart illustrating a processing flow of the high resolution correction carried out based on a single captured image data.

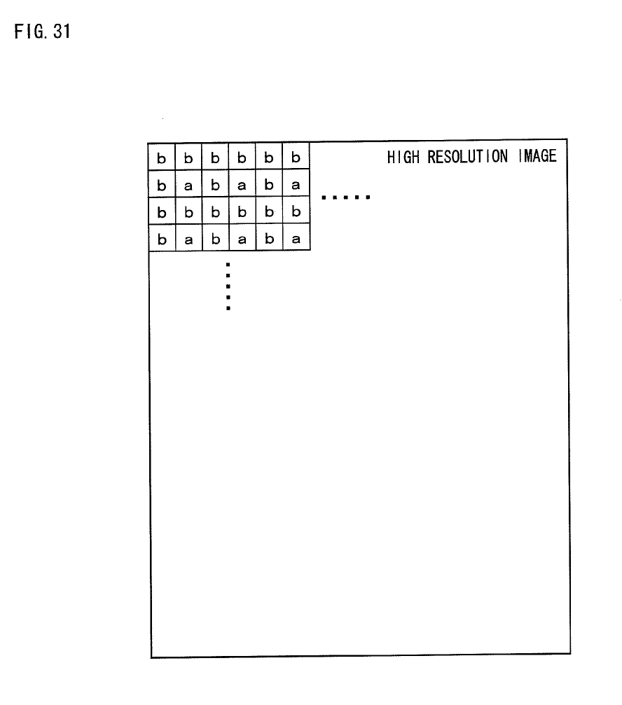

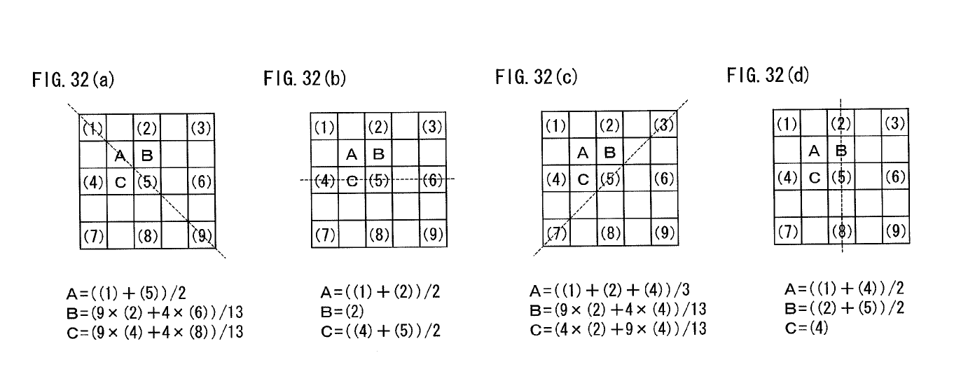

Note that an example of a resolution conversion carried out at a magnification of ×2 in each of transverse and longitudinal directions is described here. In a case where (i) the resolution conversion is carried out at the magnification of ×2 and (ii) the number of pixels included in the captured image data which is to be subjected to the high resolution correction is n×m, the number of pixels included in the captured image data which has been subjected to the high resolution correction is 2n×2m. Such a high resolution correction (the resolution conversion carried out at the magnification of ×2) is carried out by preparing, as high resolution image data, image data including both reference pixels and interpolated pixels. The reference pixels are the respective pixels included in the captured image data, and the interpolated pixels are newly prepared in the middle of the respective reference pixels. FIG. 31 shows a relationship between a reference pixel and an interpolated pixel. In FIG. 31, a pixel “a” and a pixel “b” indicate the reference pixel and the interpolated pixel, respectively.

First, the high resolution correction section 225 carries out an edge extraction with respect to the captured image data received by the first communication section 207. For example, the high resolution correction section 225 carries out the edge extraction by use of a first order differential filter as shown in FIG. 25. Then, the high resolution correction section 225 carries out a binarization process so as to prepare binary image data (S40). Note that a pixel which has a pixel value of 1 in the binary image data shows that the pixel is highly likely to be an edge.

Next, the high resolution correction section 225 determines, in accordance with the binary image data prepared in S40, whether or not a target pixel included in the captured image data is an edge (S41). Specifically, the high resolution correction section 225 determines that the target pixel is an edge when a pixel, which corresponds to the target pixel in the binary image data, has a pixel value of 1.

Note that the target pixel intends a pixel which is currently targeted in a case where the pixels in the captured image data are targeted in any order.

In a case where the target pixel is an edge (Yes in S41), the high resolution correction section 225 detects an edge direction by use of a partial image corresponding to (N×N) pixels (N>1) which includes the target pixel (S42). In detail, the high resolution correction section 225 determines whether or not each of the reference pixels in the partial image corresponding to (N×N) pixels is an edge pixel. Then, in a case where a reference pixel on the upper left of the target pixel and a reference pixel on the lower right of the target pixel are respective edge pixels, the high resolution correction section 225 determines that the edge direction of the partial image is an upper left-lower right direction. Similarly, in a case where a reference pixel on the left of the target pixel and a reference pixel on the right of the target pixel are respective edge pixels, the high resolution correction section 225 determines that the edge direction is a left-right direction. In a case where a reference pixel on the upper side of the target pixel and a reference pixel on the lower side of the target pixel are respective edge pixels, the high resolution correction section 225 determines that the edge direction of the partial image is an upper-lower direction. In a case where a reference pixel on the upper right of the target pixel and a reference pixel on the lower left of the target pixel are respective edge pixels, the high resolution correction section 225 determines that the edge direction of the partial image is an upper right-lower left direction.

In FIG. 32, a dotted line indicates a detected edge direction. Note, in FIG. 32, that pixels (1) through (9) are respective reference pixels and the pixel (5) is a target pixel. Note also that pixels A, B, and C are (i) an interpolated pixel between the reference pixels (1) and (5), (ii) an interpolated pixel between the reference pixels (2) and (5), and (iii) an interpolated pixel between the reference pixels (4) and (5), respectively.

Next, the high resolution correction section 225 calculates, in accordance with the edge direction detected in S42, pixel values of the respective interpolated pixels A, B, and C which are located (i) on the upper left, (ii) on the upper side, and (iii) on the left, respectively, of the target pixel. Note here that the pixel values of the respective interpolated pixels are calculated by use of the reference pixels located in the edge direction.

In a case where the edge direction is the upper left-lower right direction, the reference pixels (1), (5), and (9) are respective edge pixels and a straight line connecting these pixels serves as an edge line (see FIG. 32(a)). Then, a pixel value VA (note that a written expression of “V” is omitted in FIGS. 32(a) to 32 (d) and this is applied to the other pixel values) of the interpolated pixel A located on the edge line is calculated based on the equation of VA=(V(1)+V(5))/2, by use of pixel values (a pixel value V(1) and a pixel value V(5)) of the reference pixel (1) and the reference pixel (5), respectively, each being adjacent to the interpolated pixel. A located on the edge line.

In contrast, with respect to each of the interpolated pixels B and C located on no edge line, the interpolation is carried out by use of the reference pixels located on straight lines which (i) include the reference pixels which are different from those located on the edge line and the closest to the respective interpolated pixels B and C (hereinafter such a reference pixel is referred to as a closest reference pixel) and (ii) are parallel to the edge direction. For example, as for the interpolated pixel B, the straight line which (i) includes the reference pixel (2) which is the closest reference pixel and (ii) is parallel to the edge line is a straight line connecting the reference pixels (2) and (6) (see FIG. 32(a)). Then, a point, which is perpendicularly drawn from the interpolated pixel B to the straight line, causes a line segment defined by the reference pixels (2) and (6) to be internally divided. Therefore, a pixel value VB of the interpolated pixel B is calculated by use of the following equation: VB=(9×V(2)+4×V(6))/13.

Similarly, a pixel value VC of the interpolated pixel C is calculated based on the equation of VC=(9×V(4)+4×V(8))/13, by use of (i) a pixel value of the reference pixel (4) which is the closest reference pixel value and (ii) a pixel value of the reference pixel (8) which is located on a straight line which includes the reference pixel (4) and is parallel to the edge direction.

In a case where the edge direction is the left-right direction, the reference pixels (4), (5), and (6) are edge pixels and a straight line connecting these pixels serves as the edge line (see FIG. 32(b)). Then, the pixel value VC of the interpolated pixel C located on the edge line is calculated based on the equation of VC=(V(4)+V(5))/2, by use of the pixel values (pixel values V(4) and V(5)) of the reference pixel (4) and the reference pixel (5), respectively, each being adjacent to the interpolated pixel C located on the edge line. In contrast, with respect to each of the interpolated pixels A and B located on no edge line, the interpolation is carried out by use of the reference pixels located on straight lines which (i) include the reference pixels which are different from those located on the edge line and the closest to the respective interpolated pixels A and B (the closest reference pixels) and (ii) are parallel to the edge direction. For example, as for the interpolated pixel A, the straight line which (i) includes the reference pixel (1) or the reference pixel (2) which is the closest reference pixel and (ii) is parallel to the edge line is a straight line connecting the reference pixels (1) and (2) (see FIG. 32(b)). Then, a point, which is perpendicularly drawn from the interpolated pixel A to the straight line, exists in the middle of the reference pixels (1) and (2). Therefore, the pixel value VA of the interpolated pixel A is calculated by use of the following equation: VA=(V(1)+V(2))/2.

As for the interpolated pixel B, the straight line which (i) includes the reference pixel (2) which is the closest reference pixel and (ii) is parallel to the edge line is a straight line connecting the reference pixels (1), (2), and (3). Then, a point, which is perpendicularly drawn from the interpolated pixel B to the straight line, coincides with the reference pixel (2). Therefore, the interpolated pixel B is set to have the pixel value VB which is identical to the pixel value V(2) of the reference pixel (2).

In a case where the edge direction is the upper right-lower left direction, the reference pixels (3), (5), and (7) are edge pixels and a straight line connecting these pixels serves as the edge line (see FIG. 32(c)). Then, none of the interpolated pixels A, B, and C exists on the edge line.

As for the interpolated pixel A, the reference pixels (1), (2), and (4) are the closest reference pixels. Note here that the reference pixels (2) and (4) are located on a single straight line which is parallel to the edge direction, whereas the reference pixel (1) is not located on the single straight line. In view of this, the pixel value VA of the interpolated pixel A is calculated based on the equation of VA=(V(1)+V(2))+V(4)/3, by use of the pixel values of the respective reference pixels (1), (2), and (4) which are the closest reference pixels.

In contrast, with respect to each of the interpolated pixels B and C, the interpolation is carried out by use of the reference pixels located on straight lines which (i) include the reference pixels which are different from those located on the edge line and the closest to the respective interpolated pixels B and C (the closest reference pixels) and (ii) are parallel to the edge direction. For example, as for the interpolated pixel B, the straight line which (i) includes the reference pixel (2) which is the closest reference pixel and (ii) is parallel to the edge line is a straight line connecting the reference pixels (2) and (4) (see FIG. 32(c)). Then, a point, which is perpendicularly drawn from the interpolated pixel B to the straight line, causes a line segment defined by the reference pixels (2) and (4) to be internally divided. Therefore, the pixel value VB of the interpolated pixel B is calculated by use of the following equation: VB=(9×V(2)+4×V(4))/13.

Similarly, the pixel value VC of the interpolated pixel C is calculated based on the equation of VC=(4×V(2)+9×V(4))/13, by use of (i) the pixel value of the reference pixel (4) which is the closest reference pixel value and (ii) the pixel value of the reference pixel (2) which is located on the straight line which includes the reference pixel (4) and is parallel to the edge direction.

In a case where the edge direction is the upper-lower direction, the reference pixels (2), (5), and (8) are edge pixels and a straight line connecting these pixels serves as the edge line (see FIG. 32(d)). Then, the pixel value VB of the interpolated pixel B located on the edge line is calculated based on the equation of VC=(V(2)+V(5))/2, by use of the pixel values of the respective reference pixels (2) and (5) each being adjacent to the interpolated pixel B located on the edge line.

In contrast, with respect to each of the interpolated pixels A and C located on no edge line, the interpolation is carried out by use of the reference pixels located on straight lines which (i) include the reference pixels which are different from those located on the edge line and the closest to the respective interpolated pixels A and C (the closest reference pixels) and (ii) are parallel to the edge direction. For example, as for the interpolated pixel A, the straight line which (i) includes the reference pixel (1) or the reference pixel (4) which is the closest reference pixel and (ii) is parallel to the edge line is a straight line connecting the reference pixels (1) and (4) (see FIG. 32(d)). Then, a point, which is perpendicularly drawn from the interpolated pixel A to the straight line, exists in the middle of the reference pixels (1) and (4). Therefore, the pixel value VA of the interpolated pixel A is calculated by use of the following equation: VA=(V(1)+V(4))/2.

As for the interpolated pixel C, the straight line which (i) includes the reference pixel (4) which is the closest reference pixel and (ii) is parallel to the edge line is a straight line connecting the reference pixels (1), (4), and (7). Then, a point, which is perpendicularly drawn from the interpolated pixel C to the straight line, coincides with the reference pixel (4). Therefore, the interpolated pixel C is set to have the pixel value VC which is identical to the pixel value V(4) of the reference pixel (4).

Note that information, in which (i) an edge direction and (ii) equations for calculating the pixel values of the respective interpolated pixels A, B, and C are associated with each other, is preliminarily stored in the storage section 210. The high resolution correction section 225 reads out, from the storage section 210, the equations associated with the edge direction detected in S42, and then can calculate the pixel values of the respective interpolated pixels A, B, and C in accordance with the equations read out.

Note that FIGS. 32(a) to 32(d) illustrate only a case where the edges linearly extend. Note, however, that the edges can extend in a curved manner in the partial image corresponding to (N×N) pixels. Examples of the case include a case where the edge extends along the reference pixels (2)-(5)-(4) and a case where the edge extends along the reference pixels (1)-(5)-(7). Even in each of such cases, information, in which (i) edge directions and (ii) equations for calculating pixel values of respective interpolated pixels A, B, and C are associated with each other, is preliminarily stored. For example, in the case where the edge extends along the reference pixels (2)-(5)-(4), equations similar to those in the cases of FIGS. 32(c), 32(b), and 32(d) are stored with respect to the interpolated pixels A, B, and C, respectively. Similarly, in the case where the edge extends along the reference pixels (1)-(5)-(7), equations similar to those in the cases of FIGS. 32(a), 32(a), and 32(d) are stored with respect to the interpolated pixels A, B, and C, respectively. Also in a case where the edge extends differently from the above, the foregoing information is similarly stored.

As described above, the high resolution correction section 225 calculates the pixel values of the respective interpolated pixels located in the vicinities of the respective reference pixels which have been determined to be the edge pixels.

In contrast, in a case where the target pixel is not an edge (No in S41), the high resolution correction section 225 calculates, by a general interpolation calculating method (e.g., a bilinear interpolation method or a bicubic interpolation method), the pixel values of the respective interpolated pixels A, B, and C which are located (i) on the upper left side, (ii) on the upper side, and (iii) on the left side, respectively, of the target pixel so as to be adjacent to the target pixel (S43).

The high resolution correction section 225 carries out the processes S41 through S43 with respect to all the reference pixels included in one image data. This causes interpolated image data including both the reference pixels and the interpolated pixels to be prepared (S44).

Thereafter, the high resolution correction section 225 carries out an image quality enhancement process with respect to the interpolated image data prepared. For example, the interpolated image data is subjected, by the high resolution correction section 225, to a de-noising filter, a sharpening filter, and the like so that high resolution image data is prepared. Examples of the sharpening filter include a conventional unsharp mask and a filter in which a coefficient at the center of FIG. 9 is set to five (5). Note that a median filter is widely known as the de-noising filter. As for a more sophisticated method for the image quality enhancement, a Bilateral filter [Proceedings of the 1998 IEEE International Conference on Computer Vision] or the like can be used as a method having both an edge preserving property and an image quality enhancing property.

Note that a method for preparing high resolution image data is not limited to the methods described above, and the high resolution correction section 225 can prepare the high resolution image data in accordance with a single piece of captured image data by use of a variety of methods as disclosed in the Journal of the Institute of Image Information and Television Engineers Vol. 62, No. 2, pp. 181 through 189 (published in 2008).

Moreover, in a case where the high resolution image data is prepared from one image data as such, the image capture section 101 of the portable terminal apparatus 100 requires to carry out image capture just once in a single shutter click, in a text image capture mode. Moreover, in this case, it is possible to omit the process of the aforementioned (9-5-3-3). Further, the portable terminal apparatus 100 just requires transmitting, similarly to the image output mode, a set including one piece of captured image data.

(9-8) Output Process Information

The above description discusses an arrangement in which the portable terminal apparatus 100 obtains and transmits the output process information to the image output apparatus 200. However, the embodiment is not limited to this. The image output apparatus 200 can obtain the output process information (the information indicative of the kind of the output process and the setting requirement for the output process) from the input section 206 of the image output apparatus 200, at a time when the image output apparatus 200 outputs an image.

(9-9) Output Process

Before carrying out the filing process or the e-mail transmission process, the control section 212 of the image output apparatus 200 can convert, to a high-compression PDF, the captured image data decoded by the image processing sections 202 and 202a. Note that the high-compression PDF refers to PDF data in which the image data is separated into a background part and a text part and optimum compression processes are carried out with respect to the respective parts. This allows a reduction in size of an image file.

Alternatively, before carrying out the filing process or the e-mail transmission process, the control section 212 can carry out an OCR (Optical Character Recognition) process with respect to the captured image data decoded by the image processing sections 202 and 202a so as to prepare text data. The control section 212 can convert the captured image data to a PDF, and then add the text data to the PDF as a transparent text. Note that the transparent text is data for superimposing (embedding) a recognized text on (in) the image data as text information so that the recognized text is apparently invisible. For example, an image file in which a transparent text is added to image data is generally used in a PDF file. Then, the control section 212 can cause PDF data, to which the prepared transparent text is added, to be outputted. This allows an output of an electronic document easy to utilize as if it were a file in which a text search can be carried out.

(9-10) Image Processing Section of Image Output Apparatus

The above description discusses an arrangement in which the image processing sections 202 and 202a of the image output apparatus 200 carries out processes such as the decoding process and the color balance correction. Instead, the image output apparatus 200 can cause a server including the image processing sections 202 and 202a to carry out, with respect to the captured image data, the decoding process and the other image processing such as the high resolution correction, geometric distortion correction, the lens distortion correction, the contrast correction, and the color balance correction. Note, in this case, that the server will serve as an image output apparatus for carrying out the decoding process with respect to the captured image data received from the portable terminal apparatus 100, and for outputting the decoded captured image data.

(10) Program and Recording Medium

The present invention can be achieved by recording, on a computer-readable recording medium in which a program to be executed by a computer is recorded, a method in which the image captured by the portable terminal apparatus 100 is transmitted to and outputted by the image output apparatus 200.

This makes it possible to portably provide a recording medium in which program codes (an executable program, an intermediate code program, and a source program) for carrying out the above process are recorded.

Note, in the present embodiment, that the recording medium can be a memory (not illustrated) such as a ROM or the recording medium itself can be a program medium (not illustrated) because the process is carried out by a microcomputer. Alternatively, the recording medium can be a program medium from which the program codes can be read out by carrying out loading of a recording medium with respect to a program reading device provided as an external storage apparatus (not illustrated).

In any case, an arrangement can be employed in which a stored program is executed by access of a microprocessor. Alternatively, in any case, a system can be employed in which the program codes are read out and downloaded on a program storage area (not illustrated) of the microcomputer, and then the program is executed. The program for the downloading is stored in a main body in advance.

Note here that the program medium is a recording medium which is arranged to be detachable from the main body. The program media can also be a medium fixedly bearing a program code which medium includes (i) a tape such as a magnetic tape or a cassette tape, (ii) a disk including a magnetic disk such as a flexible disk or a hard disk and an optical disk such as a CD-ROM, an MO, an MD, or a DVD, (iii) a card, such as an IC card (including a memory card) or an optical card, or (iv) a semiconductor memory of a mask ROM, EPROM (Erasable Programmable Read Only Memory), EEPROM (Electrically Erasable Programmable Read Only Memory), or a flash ROM.

Further, the present embodiment has a system architecture which is connectable to a communication network including the Internet. As such, the recording medium can be a medium which bears the program codes in a flexible manner so that the program code is downloaded from the communication network. Note that, in a case where the program is downloaded from the communication network as described above, the program for the downloading can be stored beforehand in the main body or can be installed from an alternative recording medium.

The recording medium is read by a program scanning device included in the portable terminal apparatus 100 or the image output apparatus 200, whereby the image processing method is carried out.

As described above, a captured image processing system of the present invention includes (i) a portable terminal apparatus including image capture means and (ii) a plurality of image output apparatuses, the portable terminal apparatus and the image output apparatuses being communicable with each other, the portable terminal apparatus including: first storage means; an encoding section; and an image data transmission section, each of the plurality of image output apparatuses including: second storage means; an image data receiving section; a determination section; a decoding section; and an output section, the first storage means being for storing at least one piece of encoding information for encoding image data, the second storage means being for storing (a) decoding information for decoding the image data encoded by use of the encoding information and (b) first identification information for identifying the image output apparatus to which the second storage means is provided, each of the at least one piece of encoding information being associated with a corresponding piece of the decoding information so as to form a pair, the pair being identifiable by second identification information that is assigned to the pair in advance, the first storage means storing the at least one piece of encoding information in such a manner that each piece of encoding information is associated with a corresponding piece of the second identification information that identifies the pair including the piece of encoding information, and the second storage means storing the decoding information in such a manner that each piece of decoding information is associated with a corresponding piece of the second identification information that identifies the pair including the piece of decoding information, the encoding section encoding captured image data by use of a piece of encoding information among the at least one piece of encoding information stored in the first storage means, the captured image data being obtained by capturing an image by the image capture means, the image data transmission section transmitting, to an image output apparatus designated by a user, the captured image data encoded by the encoding section to which a piece of the second identification information and first identification information are attached, the piece of the second identification information corresponding to the piece of encoding information being used by the encoding section to encode the captured image data, and the first identification information being set by entry of a user, the image data receiving section receiving, from the portable terminal apparatus, the captured image data to which the first identification information set by the entry of the user and the second identification information are attached, the determination section determining whether or not the first identification information received by the image data receiving section matches the first identification information stored in the second storage means, in a case where the determination section determines that the first identification information received by the image data receiving section matches the first identification information stored in the second storage means, the decoding section reading out from the second storage means the decoding information that corresponds to the second identification information received by the image data receiving section, and decoding, by use of the decoding information read out, the captured image data received by the image data receiving section, and the output section outputting the captured image data decoded by the decoding section, or outputting an image indicated by the decoded captured image data.

Moreover, an image output method of the present invention is image output method in a captured image processing system, the captured image processing system including (i) a portable terminal apparatus including image capture means and (ii) a plurality of image output apparatuses, the portable terminal apparatus and the image output apparatuses being communicable with each other, the portable terminal apparatus including: first storage means for storing at least one piece of encoding information for encoding image data, and each of the plurality of image output apparatuses including: second storage means for storing (a) decoding information for decoding the image data encoded by use of the encoding information and (b) first identification information for identifying the image output apparatus to which the second storage means is provided, each of the at least one piece of encoding information being associated with a corresponding piece of decoding information so as to form a pair, the pair being identifiable by second identification information that is assigned to the pair in advance, the first storage means storing the at least one piece of encoding information in such a manner that the each piece of encoding information is associated with a corresponding piece of the second identification information that identifies the pair including the piece of encoding information, and the second storage means storing the decoding information in such a manner that each piece of decoding information is associated with a corresponding piece of the second identification information that identifies the pair including the piece of decoding information, the image output method including the steps of: the portable terminal apparatus encoding captured image data by use of a piece of encoding information among the at least one encoding information stored in the first storage means, the captured image data being obtained by capturing an image by the image capture means; the portable terminal apparatus transmitting, to an image output apparatus designated by a user, the captured image data encoded by the encoding section to which a piece of the second identification information and first identification information are attached, the piece of the second identification information corresponding to the piece of encoding information being used by the encoding section to encode the captured image data, and the first identification information being set by entry of a user; the image output apparatus receiving, from the portable terminal apparatus, the captured image data to which the first identification information set by the entry of the user and the second identification information are attached; the image output apparatus determining whether or not the first identification information received by the image data receiving section matches the first identification information stored in the second storage means; in a case where the determination section determines that the first identification information received by the image data receiving section matches the first identification information stored in the second storage means, the image output apparatus reading out from the second storage means the decoding information that corresponds to the second identification information received by the image data receiving section, and decoding, by use of the decoding information read out, the captured image data received by the image data receiving section; and the image output apparatus outputting the captured image data decoded by the decoding section, or outputting an image indicated by the decoded captured image data.

According to the arrangement, captured image data transmitted from the portable terminal apparatus to the image output apparatus is encoded by the encoding section. Therefore, confidentiality is ensured.

Moreover, the portable terminal apparatus transmits captured image data that has a piece of first identification information set by an entry of a user attached thereto. The image output apparatus then determines whether the received piece of first identification information matches a piece of first identification information stored in its second storage means, and in a case where the image output apparatus determines that the two pieces of first identification information match each other, the image output apparatus decodes and outputs the captured image data. Accordingly, even in a case where the user mistakenly transmits the captured image data to an image output apparatus different from the image output apparatus identified by the first identification information set by the user, no image output is carried out since the first identification information set by the user does not match with that of the image output apparatus. Therefore, even in a case where the captured image data is transmitted to an image output apparatus unintended by the user, there is no fear that the image outputted will be seen by an unknown person.

Furthermore, each of the plurality of image output apparatuses store decoding information. Hence, even in a case where the image output apparatus from which image output is preferably carried out cannot operate due to failure or the like, by transmitting the encoded captured image data to another image output apparatus and entering the first identification information that identifies the another image output apparatus, it is possible to properly decode the captured image data encoded by the encoding information, and carry out the image output.

As described above, it is therefore possible to ensure confidentiality of captured image data obtained by capturing an image by use of a portable terminal apparatus, while allowing image output by another image output apparatus in a case where a problem such as failure or the like occurs to an image output apparatus designated for the image output.

Furthermore, the captured image processing system of the present invention is preferably arranged in such a manner that the encoding of the captured image data by the encoding section and the decoding of the captured image data by the decoding section are each carried out by changing pixel locations in the image data, the encoding information being information indicative of which pixel location each pixel in the captured image data will be located to after the encoding, and the decoding information being information indicative of a normal pixel location of each pixel in the captured image data, at which normal pixel location each pixel in the encoded image data will be relocated after decoding.

According to the arrangement, it is possible to carry out encoding by use of a simple method: by changing pixel location.

Furthermore, the captured image processing system of the present invention is preferably arranged in such a manner that a plurality of types of methods are available for encoding the captured image data by use of the encoding information, the encoding section selects any one method from among the plurality types of methods for encoding the captured image data, the image data transmission section transmits, to the image output apparatus, together with the captured image data, third identification information for identifying the method used for encoding the captured image data, the method being selected by the encoding section, and the decoding section decodes the captured image data in accordance with the method identified by the third identification information received by the image data receiving section.

According to the arrangement, it is possible to change the encoding method of the captured image data transmitted from the portable terminal apparatus, per piece of captured image data. Therefore, even in a case where encoding information with respect to one piece of captured image data is deciphered, other pieces of captured image data cannot be easily decoded. Hence, confidentiality of the captured image data is further enhanced.

The encoding method includes at least two of the following (a) to (f):

(a) a method of encoding by changing pixel locations in each of a plurality of pieces of color component data included in the captured image data, by use of a same piece of encoding information;

(b) a method of encoding by (i) dividing, into a plurality of blocks having a given size, each of a plurality of pieces of color component data included in the captured image data, (ii) changing pixel locations in each of the blocks in each of the pieces of color component data by use of a same piece of encoding information, and (iii) changing location of the blocks in each of the pieces of color component data by use of the same piece of encoding information;

(c) a method of encoding by (i) dividing, into a plurality of blocks having a given size, each of a plurality of pieces of color component data included in the captured image data, (ii) separating the plurality of blocks into a plurality of groups, and (iii) changing pixel locations in each of the blocks that belong to a respective one of the plurality of groups, by use of a respective piece of encoding information being different per group, where an identical piece of encoding information is used for each of the plurality of pieces of color component data;

(d) a method of encoding by changing pixel locations in each of a plurality of pieces of color component data included in the captured image data, by use of a piece of encoding information different per piece of color component data;

(e) a method of encoding by (i) dividing, into a plurality of blocks having a given size, each of a plurality of pieces of color component data included in the captured image data, (ii) separating the plurality of blocks into a plurality of groups, and (iii) changing pixel locations in each of the blocks that belong to a respective one of the plurality of groups, by use of a respective piece of encoding information being different per group, where a different piece of encoding information is used per piece of color component data; and

(f) a method of encoding by changing density value of each of pixels of the captured image data, by use of the encoding information.

Alternatively, the captured image processing system of the present invention may be arranged in such a manner that a plurality of types of methods are available for encoding the captured image data by use of the encoding information, the encoding section selects more than one method among the plurality of types of methods for encoding the captured image data, the image data transmission section transmits, to the image output apparatus, together with the captured image data, fourth identification information for identifying the methods used for encoding the captured image data, the methods being selected by the encoding section, and the decoding section decodes the captured image data in accordance with the methods identified by the fourth identification information received by the image data receiving section.

For example, the more than one method selected by the encoding section includes methods in which pixel locations are changed and a method in which density values of pixels are changed.

According to the arrangement, encoding of the captured image data is carried out by selecting more than one method among a plurality of types of methods. Hence, as compared to a case where the captured image data is encoded by a single method, more than one method is necessarily specified for the decoding. This further ensures the security of the captured image data.

Furthermore, the captured image processing system of the present invention is preferably arranged in such a manner that the encoding section encodes at least one piece of color component data of the captured image data in an encoding method that uses a piece of encoding information different from that used for other pieces of color component data.

According to the arrangement, at least one of pieces of color component data of the captured image data is encoded by encoding information different from that of other pieces of color component data. Hence, as compared to a case where encoding is carried out by use of a single method, it is necessary to specify at the time of encoding which method to use for decoding which color component data. This further improves the security of the captured image data.

Furthermore, the captured image processing system of the present invention is preferably arranged in such a manner that the image output apparatus further includes a high resolution correction section for correcting the captured image data decoded by the decoding section, the high resolution correction section correcting the captured image data, so that the captured image data has a resolution higher than a resolution of the decoded captured image data, the output section outputting the captured image data corrected by the high resolution correction section or an image indicated by the corrected captured image data.

According to the arrangement, it is possible to improve readability of characters in the captured image and output a high quality image.

Note that the captured image processing system may be realized by a computer. In this case, a program that causes a computer to function as each of the sections of the captured image processing system, and a computer-readable recording medium in which the program is recorded is also included in the scope of the present invention.

The present invention is not limited to the description of the embodiments above, but may be altered by a skilled person within the scope of the claims. An embodiment based on a proper combination of technical means disclosed in different embodiments is encompassed in the technical scope of the present invention.

### INDUSTRIAL APPLICABILITY

The present invention is applicable to a captured image processing system for carrying out data communication between a portable terminal apparatus and an image output apparatus.

### REFERENCE SIGNS LIST

100 portable terminal apparatus
101 image capture section (image capture means)
103a table selecting section
103b encoding section
104 communication section (image data transmission section)
106 input section
108 storage section (first storage means)
109 control section (image data transmission section)
110 ID accepting section
111 table acquisition section
112 pass code setting section
200 image output apparatus
202,202a image processing section
201 certifying section (determination section)
204 image forming section (output section)
207 first communication section (image data receiving section)
208 second communication section (output section)
210 storage section (second storage means)
211 password accepting section
212 control section (output section)
222 decoding section
225 high resolution correction section

What is claimed is:

1. A captured image processing system including (i) a portable terminal apparatus including image capture means and (ii) a plurality of image output apparatuses, the portable terminal apparatus and the image output apparatuses being communicable with each other,
the portable terminal apparatus comprising:
first storage means;
an encoding section; and
an image data transmission section,
each of the plurality of image output apparatuses comprising:
second storage means;
an image data receiving section;
a determination section;
a decoding section; and
an output section,
the first storage means being for storing at least one piece of encoding information for encoding image data,
the second storage means being for storing (a) decoding information for decoding the image data encoded by use of the encoding information and (b) first identification information for identifying the image output apparatus to which the second storage means is provided,
each of the at least one piece of encoding information being associated with a corresponding piece of decoding information so as to form a pair, the pair being identifiable by second identification information that is assigned to the pair in advance,
the first storage means storing the at least one piece of encoding information in such a manner that each piece of encoding information is associated with a corresponding piece of the second identification information that identifies the pair including the piece of encoding information, and
the second storage means storing the decoding information in such a manner that each piece of decoding information is associated with a corresponding piece of the second identification information that identifies the pair including the piece of decoding information,
the encoding section encoding captured image data by use of a piece of encoding information among the at least one piece of encoding information stored in the first storage means, the captured image data being obtained by capturing an image by the image capture means,
the image data transmission section transmitting, to an image output apparatus designated by a user, the captured image data encoded by the encoding section to which a piece of the second identification information and first identification information are attached, the piece of the second identification information corresponding to the piece of encoding information being used by the encoding section to encode the captured image data, and the first identification information being set by entry of a user,
the image data receiving section receiving, from the portable terminal apparatus, the captured image data to which the first identification information set by the entry of the user and the second identification information are attached,
the determination section determining whether or not the first identification information received by the image data receiving section matches the first identification information stored in the second storage means,
in a case where the determination section determines that the first identification information received by the image data receiving section matches the first identification information stored in the second storage means, the decoding section reading out from the second storage means the decoding information that corresponds to the second identification information received by the image data receiving section, and decoding, by use of the decoding information read out, the captured image data received by the image data receiving section, and
the output section outputting the captured image data decoded by the decoding section, or outputting an image indicated by the decoded captured image data.

2. The captured image processing system according to claim 1, wherein:
the encoding of the captured image data by the encoding section and the decoding of the captured image data by the decoding section are each carried out by changing pixel locations in the image data,
the encoding information being information indicative of which pixel location each pixel in the captured image data will be located to after the encoding, and
the decoding information being information indicative of a normal pixel location of each pixel in the captured image data, at which normal pixel location each pixel in the encoded image data will be relocated to after decoding.

3. The captured image processing system according to claim 1, wherein:
a plurality of types of methods are available for encoding the captured image data by use of the encoding information,
the encoding section selects any one method from among the plurality of types of methods for encoding the captured image data,
the image data transmission section transmits, to the image output apparatus, together with the captured image data, third identification information for identifying the method used for encoding the captured image data, the method being selected by the encoding section, and
the decoding section decodes the captured image data in accordance with the method identified by the third identification information received by the image data receiving section.

4. The captured image processing system according to claim 1, wherein:
a plurality of types of methods are available for encoding the captured image data by use of the encoding information,
the encoding section selects more than one method among the plurality of types of methods for encoding the captured image data,
the image data transmission section transmits, to the image output apparatus, together with the captured image data, fourth identification information for identifying the methods used for encoding the captured image data, the methods being selected by the encoding section, and
the decoding section decodes the captured image data in accordance with the methods identified by the fourth identification information received by the image data receiving section.

5. The captured image processing system according to claim 4, wherein:
the encoding section encodes at least one piece of color component data of the captured image data in an encoding method that uses a piece of encoding information different from that used for other pieces of color component data.

6. The captured image processing system according to claim 4, wherein:
the more than one method selected by the encoding section includes a method in which pixel locations are changed and a method in which density values of pixels are changed.

7. The captured image processing system according to claim 3, wherein:
the plurality of types of methods for encoding the captured image data includes at least two of the following methods (a) to (f):
(a) a method of encoding by changing pixel locations in each of a plurality of pieces of color component data included in the captured image data, by use of a same piece of encoding information,
(b) a method of encoding by (i) dividing, into a plurality of blocks having a given size, each of a plurality of pieces of color component data included in the captured image data, (ii) changing pixel locations in each of the blocks in each of the pieces of color component data by use of a same piece of encoding information, and (iii) changing location of the blocks in each of the pieces of color component data by use of the same piece of encoding information,
(c) a method of encoding by (i) dividing, into a plurality of blocks having a given size, each of a plurality of pieces of color component data included in the captured image data, (ii) separating the plurality of blocks into a plurality of groups, and (iii) changing pixel locations in each of the blocks that belong to a respective one of the plurality of groups, by use of a respective piece of encoding information being different per group, where an identical piece of encoding information is used for each of the plurality of pieces of color component data,
(d) a method of encoding by changing pixel locations in each of a plurality of pieces of color component data included in the captured image data, by use of a piece of encoding information different per piece of color component data,
(e) a method of encoding by (i) dividing, into a plurality of blocks having a given size, each of a plurality of pieces of color component data included in the captured image data, (ii) separating the plurality of blocks into a plurality of groups, and (iii) changing pixel locations in each of the blocks that belong to a respective one of the plurality of groups, by use of a respective piece of encoding information being different per group, where a different piece of encoding information is used per piece of color component data, and
(f) a method of encoding by changing density value of each of pixels of the captured image data, by use of the encoding information.

8. The captured image processing system according to claim 4, wherein:
the plurality of types of methods for encoding the captured image data includes at least two of the following methods (a) to (f):
(a) a method of encoding by changing pixel location in each of a plurality of pieces of color component data included in the captured image data, by use of a same piece of encoding information,
(b) a method of encoding by (i) dividing, into a plurality of blocks having a given size, each of a plurality of pieces of color component data included in the captured image data, (ii) changing pixel locations in each of the blocks in each of the pieces of color component data by use of a same piece of encoding information, and (iii) changing location of the blocks in each of the pieces of color component data by use of the same piece of encoding information,
(c) a method of encoding by (i) dividing, into a plurality of blocks having a given size, each of a plurality of pieces of color component data included in the captured image data, (ii) separating the plurality of blocks into a plurality of groups, and (iii) changing pixel locations in each of the blocks that belong to a respective one of the plurality of groups, by use of a respective piece of encoding information being different per group, where an identical piece of encoding information is used for each of the plurality of pieces of color component data,
(d) a method of encoding by changing pixel locations in each of a plurality of pieces of color component data included in the captured image data, by use of a piece of encoding information different per piece of color component data,
(e) a method of encoding by (i) dividing, into a plurality of blocks having a given size, each of a plurality of pieces of color component data included in the captured image data, (ii) separating the plurality of blocks into a plurality of groups, and (iii) changing pixel locations in each of the blocks that belong to a respective one of the plurality of groups, by use of a respective piece of encoding information being different per group, where a different piece of encoding information is used per piece of color component data, and
(f) a method of encoding by changing density value of each of pixels of the captured image data, by use of the encoding information.

9. The captured image processing system according to claim 1, wherein:
the image output apparatus further comprises a high resolution correction section for correcting the captured image data decoded by the decoding section, the high resolution correction section correcting the captured image data, so that the captured image data has a resolution higher than a resolution of the decoded captured image data,
the output section outputting the captured image data corrected by the high resolution correction section or an image indicated by the corrected captured image data.

10. An image output method of a captured image processing system, the captured image processing system including (i) a portable terminal apparatus including image capture means and (ii) a plurality of image output apparatuses, the portable terminal apparatus and the image output apparatuses being communicable with each other,
the portable terminal apparatus comprising:
first storage means for storing at least one piece of encoding information for encoding image data, and
each of the plurality of image output apparatuses comprising:
second storage means for storing (a) decoding information for decoding the image data encoded by use of the encoding information and (b) first identification information for identifying the image output apparatus to which the second storage means is provided,
each of the at least one piece of encoding information being associated with a corresponding piece of decoding information so as to form a pair, the pair being identifiable by second identification information that is assigned to the pair in advance,
the first storage means storing the at least one piece of encoding information in such a manner that each piece of encoding information is associated with a corresponding piece of the second identification information that identifies the pair including the piece of encoding information, and
the second storage means storing the decoding information in such a manner that each piece of decoding information is associated with a corresponding piece of the second identification information that identifies the pair including the piece of decoding information,
said image output method comprising the steps of:
the portable terminal apparatus encoding captured image data by use of a piece of encoding information among the at least one encoding information stored in the first storage means, the captured image data being obtained by capturing an image by the image capture means;
the portable terminal apparatus transmitting, to an image output apparatus designated by a user, the captured image data encoded by the encoding section to which a piece of the second identification information and first identification information are attached, the piece of the second identification information corresponding to the piece of encoding information being used by the encoding section to encode the captured image data, and the first identification information being set by entry of a user;
the image output apparatus receiving, from the portable terminal apparatus, the captured image data to which the first identification information set by the entry of the user and the second identification information are attached;
the image output apparatus determining whether or not the first identification information received by the image data receiving section matches the first identification information stored in the second storage means;
in a case where the determination section determines that the first identification information received by the image data receiving section matches the first identification information stored in the second storage means, the image output apparatus reading out from the second storage means the decoding information that corresponds to the second identification information received by the image data receiving section, and decoding, by use of the decoding information read out, the captured image data received by the image data receiving section; and
the image output apparatus outputting the captured image data decoded by the decoding section, or outputting an image indicated by the decoded captured image data.

11. A computer-readable recording medium in which a program for causing a captured image processing system recited in claim 1 to operate is recorded, the program causing a computer to function as each section of the captured image processing system.
